(19) United States
(12) Patent Application Publication
(10) Pub. No.: US 2011/0304614 A1
(43) Pub. Date: Dec. 15, 2011

(54) STEREOSCOPIC IMAGE DISPLAY DEVICE AND STEREOSCOPIC IMAGE DISPLAY METHOD

(75) Inventor: Hiroaki Yasunaga, Tokyo (JP)

(73) Assignee: Sony Corporation, Tokyo (JP)

(21) Appl. No.: 13/152,547

(22) Filed: Jun. 3, 2011

(30) Foreign Application Priority Data
Jun. 11, 2010 (JP) 2010-134179

(51) Int. Cl. G06T 15/00

(52) U.S. Cl. 345/419

(57) ABSTRACT

A display device includes: a cylindrical rotation section having an axis of rotation therein and rotating around the axis of rotation; a light-emission element array mounted in the rotation section, and including light-emission elements arranged to formed a light-emission surface; a slit provided in a circumferential surface of the rotation section, and allowing light from the light-emission surface to pass therethrough to outside of the rotation section; a display controller performing emission control on the light-emission elements to allow an image to be formed by the light emitted through the slit and to be displayed around the rotation section; and an eyepoint detection section detecting an eyepoint position of each of one or more viewers around the rotation section. The display controller performs emission control on the light-emission elements to allow contents of a displayed image to differ depending on the viewer's eyepoint position detected by the eyepoint detection section.

### BACKGROUND OF THE INVENTION

1. Field of the Invention

The present invention relates to a stereoscopic image display device and a stereoscopic image display method, which may display a stereoscopic image over the entire circumference.

2. Description of Related Art

Many proposals have been made so far on an omnidirectional stereoscopic image display device of an integral imaging method, which reproduces a stereoscopic image over the entire circumference of an object based on two-dimensional picture data for stereoscopic image display obtained by taking images of the object over the entire circumference or creating such images by a computer. For example, “Stereoscopic Image Display Device Observable from All Directions” (URL: http://hhil.hitachi.co.jp/products/transpost.html) (non-patent document 1) discloses a stereoscopic picture display device observable from all directions. The stereoscopic picture display device has a view-angle limiter screen, a rotation mechanism, an upper mirror, a lower mirror group, a projector and a personal computer and displays a stereoscopic picture using binocular parallax. The personal computer controls the projector and the rotation mechanism.

The projector projects a picture for stereoscopic image display on the upper mirror. The picture for stereoscopic image display projected on the upper mirror is reflected on the lower mirror group, and thus projected on the view-angle limiting screen. The view-angle limiting screen rotates at high speed by the rotation mechanism. When a stereoscopic picture display device is configured in this way, a background shows through, and a stereoscopic picture may be viewed from anywhere within 360 degrees.

A document, “Cylindrical 3-D Video Display Observable from All Directions” (URL: http://www.yendo.org/seelinder/) (non-patent document 2) discloses a 3D video display observable from the entire circumference. The 3D video display has a cylindrical rotation body for stereoscopic image display and a motor. A plurality of transmissive vertical-lines is provided in a circumferential surface of the rotation body. A timing controller, ROM, an LED array, an LED driver, and an address counter are provided in the rotation body. The timing controller is connected to the address counter, the ROM and the LED driver and thus controls output of the address counter and the like. The ROM stores image data for stereoscopic image display. A slip ring is provided on an axis of rotation of the rotation body. Power is supplied to components in the rotation body via the slip ring.

The address counter generates an address based on a set/reset signal from the timing controller. The address counter is connected with the ROM. The ROM receives a read control signal from the timing controller and the address from the address counter, and reads image data for stereoscopic image display and outputs the data to the LED driver. The LED driver receives the image data from the ROM and an emission control signal from the timing controller, and thus drives the LED array. The LED array emits light under control of the LED driver. The motor rotates the rotation body. When a 3D video display is configured in this way, since a stereoscopic image may be displayed over a range of 360 degrees (the entire circumference), the stereoscopic image may be observed without binocular parallax glasses.

For this type of omnidirectional stereoscopic image display device, Japanese Unexamined Patent Application Publication No. 2004-177709 (JP-A-2004-177709) (p 8, FIG. 7) discloses a stereoscopic image display device. The stereoscopic image display device has a bundle-of-rays allocation unit and a cylindrical two-dimensional pattern display unit. The bundle-of-rays allocation unit is provided on the front or back of a display surface having a convex curved-surface as viewed from an observer. The unit has a curved surface having a plurality of openings or lenses formed in array, where a bundle-of-rays from a plurality of pixels on the display surface are allocated to the respective openings or lenses. The two-dimensional pattern display unit displays a two-dimensional pattern on the display surface.

When a stereoscopic image display device is configured in this way, image mapping of a stereoscopic image, which is easily displayed in full motion video, may be effectively performed, so that even if an eyepoint is changed, the stereoscopic image is not broken and may be displayed with high resolution.

Furthermore, Japanese Unexamined Patent Application Publication No. 2005-114771 (JP-A-2005-114771) (p 8, FIG. 3) discloses a display device of an integral imaging method. The display device has one light-emission unit and one cylindrical screen. The light-emission unit has a structure rotatable about an axis of rotation. The screen is disposed around the light-emission unit and forms a part of an axisymmetric rotation body with respect to the axis of rotation. A plurality of light-emission sections are disposed on a side of the light-emission unit opposite to the screen, and each light-emission section has two or more light emission directions different from each other to limit a light emission angle within a predetermined range.

The light-emission unit rotates about the axis of rotation, and thus the light-emission sections are rotationally scanned, and the quantity of emission light of each light-emission section is modulated according to given information, so that an image is displayed on a screen. When a display device is configured in this way, since a stereoscopic image may be displayed over a range of 360 degrees (the entire circumference), the stereoscopic image may be observed by many people without binocular parallax glasses.

Japanese Unexamined Patent Application Publication (Translation of PCT Application) No. 2002-503831 (JP-T-2002-503831) discloses an invention of a display device, which displays an image in a curved manner within a cylindrical unit, and provides the same image to all observers around the unit by rotating the unit as a whole.

Japanese Unexamined Patent Application Publication No. 10-97013 (JP-A-10-97013) discloses an invention of a stereoscopic display device, where a display unit delivers light beams with a predetermined parallax step angle from display cells, the number of the display cells being corresponding to the number of parallaxes, and the display unit emits light to observers while being rotated, so that stereoscopic display is performed.

### SUMMARY OF THE INVENTION

The stereoscopic image display devices according to the previous methods have the following difficulties.

The stereoscopic picture display device according to the non-patent document 1 needs to have the view-angle limiting screen, the rotation mechanism, the upper mirror, the lower mirror group, the projector and the personal computer, which increases system size, leading to complicated control.

In the 3D video display in the non-patent document 2, a stereoscopic image is displayed by light transmitted through the plurality of vertical lines provided in the circumferential surface of the rotation body, and therefore use efficiency of beams is reduced and consequently energy loss may be increased.

The stereoscopic image display device according to JP-A-2004-177709 has the bundle-of-rays allocation unit that is provided on the front or back of the display surface having the convex curved-surface as viewed from an observer, and has the curved surface having the plurality of openings or the lenses in array. Since beams from the plurality of pixels on the display surface are allocated to the respective openings or lenses, practical image quality is hard to be obtained.

In the display device of an integral imaging method according to JP-A-2005-114771, the light-emission unit rotates about the axis of rotation, so that the light-emission sections are rotationally scanned, and the quantity of emission light of each light-emission section is modulated according to given information, so that an image is displayed on a fixed screen. Therefore, practical image quality is hard to be obtained as in the stereoscopic image display device according to JP-A-2004-177709.

The display device according to JP-T-2002-503831 may provide the same image to all observers around the device, and may not perform stereoscopic display where an image is displayed with a parallax depending on a visual-point position.

JP-A-10-97013 describes the stereoscopic display device that may display an image with a parallax depending on a visual-point position over the entire circumference of the cylindrical unit. However, specific description is not made on a state of an image being displayed when the image is observed from an optional visual-point position around the device, and therefore the device is likely to be hardly achieved.

It is desirable to provide a stereoscopic image display device and a stereoscopic image display method, where a stereoscopic image may be reproducibly viewed from the entire circumference, and stereoscopic image display may be performed in various modes depending on a visual-point position of an observer.

A stereoscopic image display device according to an embodiment of the invention includes a cylindrical rotation section having an axis of rotation therein and rotating around the axis of rotation as a rotation center; a light-emission element array mounted in the rotation section, and including a plurality of light-emission elements arranged to formed a light-emission surface; a slit provided in a circumferential surface of the rotation section, and allowing light from the light-emission surface to pass therethrough to outside of the rotation section; a display controller performing emission control on the plurality of light emission-elements to allow an image to be formed by the light emitted through the slit and to be displayed around the rotation section; and an eyepoint detection section detecting an eyepoint position of each of one or more viewers around the rotation section. The display controller performs emission control on the plurality of light-emission elements to allow contents of a displayed image to differ depending on the viewer's eyepoint position detected by the eyepoint detection section.

A method of displaying an image with use of a display device according to an embodiment of the invention includes: providing a cylindrical rotation section having an axis of rotation therein and rotating around the axis of rotation as a rotation center; providing a light-emission element array mounted in the rotation section, and including a plurality of light-emission elements arranged to formed a light-emission surface; providing a slit in a circumferential surface of the rotation section, and allowing light from the light-emission surface to pass therethrough to outside of the rotation section; performing emission control on the plurality of light emission-elements to allow an image to be formed by the light emitted through the slit and to be displayed around the rotation section; and detecting an eyepoint position of each of one or more viewers around the rotation section, wherein the emission control on the plurality of light-emission elements is performed to allow contents of a displayed image to differ depending on the viewer's eyepoint position detected by the eyepoint detection section.

In the stereoscopic image display device or the stereoscopic image display method according to the embodiment of the invention, the rotation section rotates while the light-emission element array is attached in the inside of the rotation section. While the rotation section rotates in this way, light from the light-emission surface of the light-emission element array is emitted through the slit to the outside of the rotation section. Consequently, an observer may recognize a stereoscopic image at any position around the rotation section. The eyepoint detection section detects a visual-point position of an observer around the rotation section. The display controller performs emission control of the plurality of light-emission elements of the light-emission element array such that content of a stereoscopic image to be displayed is changed depending on the visual-point position of the observer detected by the eyepoint detection section.

The eyepoint detection section detects, for example, at least height of a visual-point position of an observer. For example, the display controller performs emission control of the plurality of light-emission elements such that content of a stereoscopic image to be displayed is changed depending on the height of the visual-point position of the observer.

The eyepoint detection section may detect a horizontal visual-point position of each of a plurality of observers around the rotation section. In addition, the display controller may perform emission control of the plurality of light-emission elements such that stereoscopic images having different content are displayed to the respective observers depending on difference in horizontal visual-point position between the plurality of observers.

According to the stereoscopic image display device or the stereoscopic image display method of the embodiment of the invention, the rotation section is rotated while the light-emission element array is attached in the inside of the rotation section, and light from the light-emission surface of the light-emission element array is emitted through the slit to the outside of the rotation section, and thus a stereoscopic image is displayed in the periphery of the rotation section, and therefore the stereoscopic image may be reproducibly viewed from the entire circumference without complicating a stereoscopic display mechanism compared with previous methods.

Moreover, since content of a stereoscopic image to be displayed is changed depending on a visual-point position of an observer detected by the eyepoint detection section, the stereoscopic image may be displayed in various modes. For example, content of a stereoscopic image to be displayed is changed depending on height of the visual-point position of the observer, and therefore, for example, stereoscopic image display with parallax in a height direction may be performed.

Moreover, when a horizontal visual-point position of each of a plurality of observers around the rotation section is detected, and stereoscopic images having different content are displayed to the respective observers, different stereoscopic images may be displayed at a time to the respective observers.

Other and further objects, features and advantages of the invention will appear more fully from the following description.

### BRIEF DESCRIPTION OF THE DRAWINGS

FIG. 1 is a partially cutaway, perspective diagram showing a configuration example of an omnidirectional stereoscopic image display device 10 according to a first embodiment of the invention.

FIG. 2 is an exploded perspective diagram showing an assembly example of the omnidirectional stereoscopic image display device 10.

FIG. 3 is an explanatory diagram showing a shape calculation example (1) of a light-emission surface of a two-dimensional light-emission element array 101.

FIG. 4 is an explanatory diagram showing a shape calculation example (2) of the light-emission surface of the two-dimensional light-emission element array 101.

FIG. 5 is a perspective diagram showing a shape example (1) of the two-dimensional light-emission element array 101.

FIG. 6 is a perspective diagram showing a shape example (2) of the two-dimensional light-emission element array 101.

FIG. 7 is a perspective diagram showing a shape example (3) of the two-dimensional light-emission element array 101.

FIG. 8 is a schematic diagram showing a function example of a lens member of the two-dimensional light-emission element array 101 as viewed from above in an axis of rotation direction.

FIG. 9 is a schematic diagram showing an operation example of the omnidirectional stereoscopic image display device 10 as viewed from above in an axis of rotation direction.

FIGS. 10A to 10D are explanatory diagrams showing a trajectory example (1) of light emitting points observed from an eyepoint p.

FIGS. 11A to 11D are explanatory diagrams showing a trajectory example (2) of the light emitting points observed from the eyepoint p.

FIGS. 12A to 12D are explanatory diagrams showing a trajectory example (3) of the light emitting points observed from the eyepoint p.

FIGS. 13A and 13B are explanatory diagrams showing an aspect (1) of outputting beams through a slit 102 to a plurality of eyepoints.

FIGS. 14A and 14B are explanatory diagrams showing an aspect (2) of outputting beams through the slit 102 to the plurality of eyepoints.

FIGS. 15A and 15B are explanatory diagrams showing an aspect (3) of outputting beams through the slit 102 to the plurality of eyepoints.

FIG. 16 is an explanatory diagram showing an aspect (4) of outputting beams through the slit 102 to the plurality of eyepoints.

FIG. 17 is a data format showing a conversion example of photographing data to emission light data.

FIG. 18 is a block diagram showing a configuration example of a control system of the omnidirectional stereoscopic image display device 10.

FIG. 19 is a block diagram showing a configuration example of a one-dimensional light-emission element board #1 or the like.

FIG. 20 is an operation flowchart showing a stereoscopic image display example of the omnidirectional stereoscopic image display device 10.

FIGS. 21A and 21B are explanatory diagrams showing a configuration example of an omnidirectional stereoscopic image display device 20 according to a second embodiment and an operation example thereof, respectively.

FIGS. 22A and 22B are explanatory diagrams showing a configuration example of an omnidirectional stereoscopic image display device 30 according to a third embodiment and an operation example thereof, respectively.

FIGS. 23A and 23B are explanatory diagrams showing a configuration example of an omnidirectional stereoscopic image display device 40 according to a fourth embodiment and an operation example thereof, respectively.

FIGS. 24A and 24B are explanatory diagrams showing a configuration example of an omnidirectional stereoscopic image display device 50 according to a fifth embodiment and an operation example thereof, respectively.

FIGS. 25A and 25B are explanatory diagrams showing a configuration example of an omnidirectional stereoscopic image display device 60 according to a sixth embodiment and an operation example thereof, respectively.

FIGS. 26A and 26B are explanatory diagrams of optimum width of a slit.

FIGS. 27A and 27B are explanatory diagrams showing an example of pixel arrangement, observed from an optional eyepoint p, on a display surface of the omnidirectional stereoscopic image display device 10.

FIG. 28 is an explanatory diagram showing a calculation example of a curved-surface shape of the two-dimensional light-emission element array 101 and of a position of a light emitting point (light-emission element).

FIG. 29 is an explanatory diagram showing a specific example of the curved-surface shape of the two-dimensional light-emission element array 101 and of positions of light emitting points (light-emission elements).

FIG. 30 is an explanatory diagram showing light emitting timing of the light-emission elements of the two-dimensional light-emission element array 101.

FIG. 31 is an explanatory diagram showing a comparative example of light emitting timing of the light-emission elements of the two-dimensional light-emission element array 101.

FIG. 32 is an explanatory diagram showing a state of beams emitted through the slit in the case that the plurality of light-emission elements are allowed to emit light simultaneously at time t=0 in a configuration of FIG. 29.

FIGS. 33A and 33B are explanatory diagrams showing a viewing example of a stereoscopic image in the omnidirectional stereoscopic image display device 10 or the like as each embodiment.

FIG. 34 is an exploded perspective diagram showing a configuration example of an omnidirectional stereoscopic image display device 70 according to a tenth embodiment.

FIG. 35 is a block diagram showing a configuration example of an object detection circuit of the omnidirectional stereoscopic image display device 70.

FIG. 36 is an explanatory diagram showing a concept of object detection of the omnidirectional stereoscopic image display device 70.

FIGS. 37A and 37B are explanatory diagrams showing an example of change in display state of a stereoscopic image in correspondence to object detection of the omnidirectional stereoscopic image display device 70.

FIG. 38 is a waveform diagram showing an example of a measurement result of reflection intensity for each rotation angle of the omnidirectional stereoscopic image display device 70.

FIG. 39 is a diagram showing a configuration example of an omnidirectional stereoscopic image display device 80 according to an eleventh embodiment.

FIG. 40A is an explanatory diagram of horizontal parallax, and FIG. 40B is an explanatory diagram of vertical parallax.

FIGS. 41A to 41C are explanatory diagrams showing an example of image display in the case that an angle of elevation or depression of a stereoscopic image is changed with an eyepoint being fixed.

FIGS. 42A to 42C are explanatory diagrams showing an example of image display of the omnidirectional stereoscopic image display device 80 according to the eleventh embodiment.

FIGS. 43A to 43E are explanatory diagrams showing an example of image display of an omnidirectional stereoscopic image display device according to a twelfth embodiment.

### DETAILED DESCRIPTION OF THE PREFERRED EMBODIMENTS

Hereinafter, the best mode for carrying out the invention (hereinafter, simply called embodiment) will be described in detail with reference to drawings. Description is made in the following sequence.

1. First embodiment (omnidirectional stereoscopic image display device 10: configuration example, assembly example, shape calculation example, formation example, operation principle, trajectory example, aspect, data generation example, and stereoscopic image display example).

2. Second embodiment (omnidirectional stereoscopic image display device 20: configuration example and operation example).

3. Third embodiment (omnidirectional stereoscopic image display device 30: configuration example and operation example).

4. Fourth embodiment (omnidirectional stereoscopic image display device 40: configuration example and operation example).

5. Fifth embodiment (omnidirectional stereoscopic image display device 50: configuration example and operation example).

6. Sixth embodiment (omnidirectional stereoscopic image display device 60: configuration example and operation example).

7. Seventh embodiment (optimization of slit width).

8. Eighth embodiment (optimization of light emitting timing).

9. Ninth embodiment (viewing example of stereoscopic image using each of display devices according to first to eighth embodiments).

10. Tenth embodiment (omnidirectional stereoscopic image display device 70: configuration example and operation example).

11. Eleventh embodiment (omnidirectional stereoscopic image display device 80: configuration example and operation example).

12. Twelfth embodiment (simultaneous viewing of multiple contents).

### First Embodiment

### Configuration Example of Omnidirectional Stereoscopic Image Display Device 10

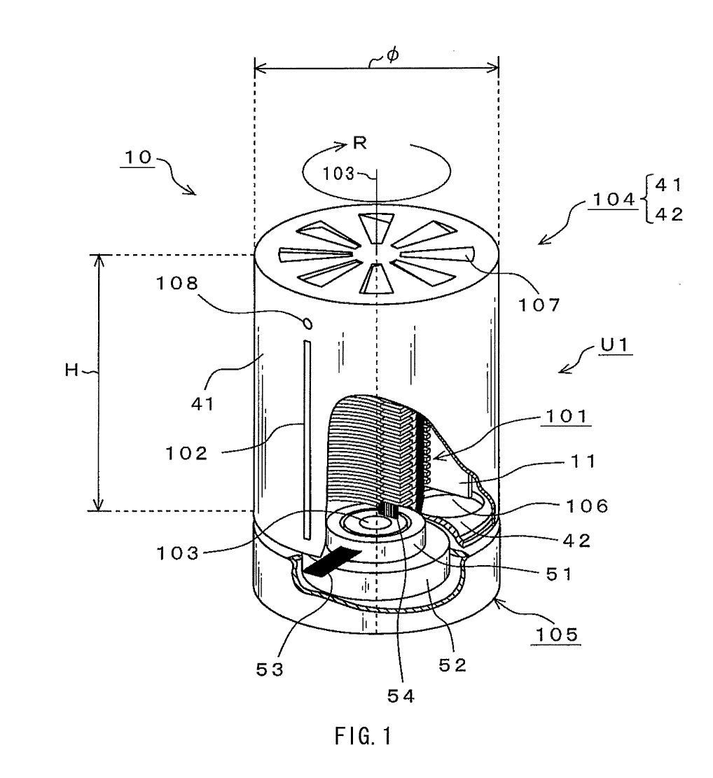

FIG. 1 is a partial cutaway perspective diagram showing a configuration example of an omnidirectional stereoscopic image display device 10 as a first embodiment. The omnidirectional stereoscopic image display device 10 shown in FIG. 1 is configured as an example of a stereoscopic image display device of an integral imaging method, and includes a two-dimensional light-emission element array 101, a rotation section with a slit 104, and a setting base with a drive mechanism 105. The omnidirectional stereoscopic image display device 10 reproduces a stereoscopic image over the entire circumference of an object based on two-dimensional picture data for displaying a stereoscopic image (hereinafter, simply called picture data Din) obtained by taking images of the object over the entire circumference or creating such images by a computer.

The rotation section 104 includes an outer casing with a slit 41 and a turntable with an inlet port 42. The outer casing 41 is mounted on the turntable 42. The turntable 42 has a disk shape, and an axis of rotation 103 is provided at the center of the turntable. The axis of rotation 103 is a rotational center of the turntable 42 as well as a rotational center of the outer casing 41, and may be called axis of rotation 103 of the rotation section 104 below. The inlet port 106 is provided at a predetermined position of the turntable 42 so as to take air into the outer casing 41.

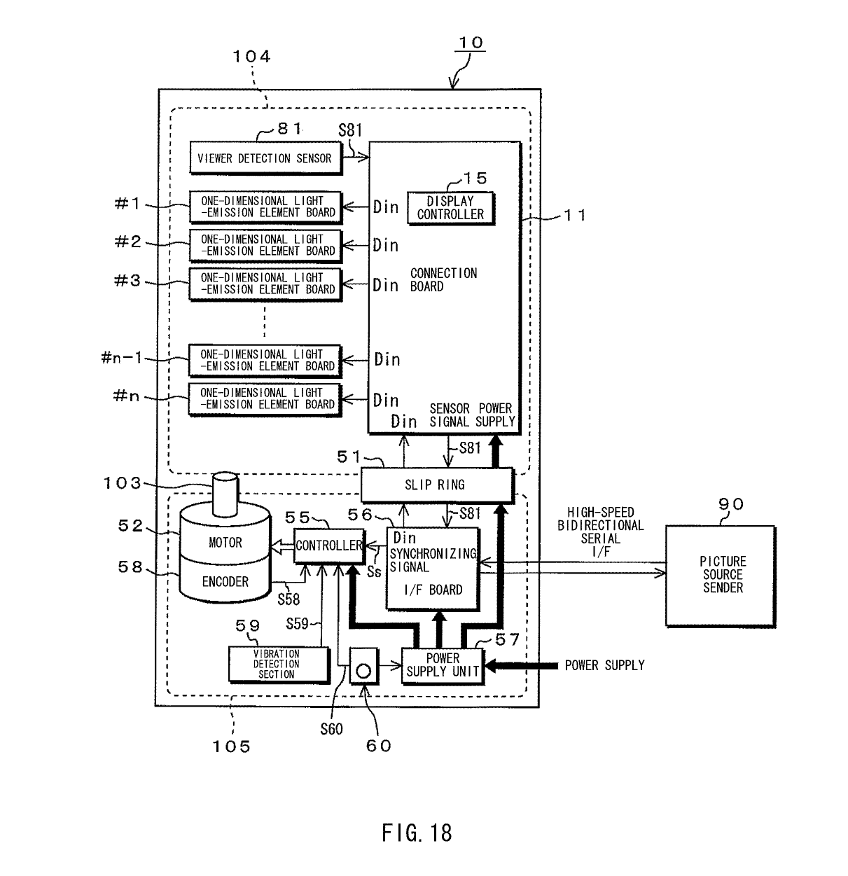

One or more two-dimensional light-emission element array 101 having a predetermined shape is provided within the outer casing 41 on the turntable 42. For example, the two-dimensional light-emission element array 101 includes light-emission elements arranged in an m (rows) by n (columns) matrix. For the light-emission elements, a self-luminous element such as a light emitting diode, a laser diode, or organic EL is used. In the two-dimensional light-emission element array 101, a plurality of light-emission elements emit light in accordance with rotation of the rotation section 104, and are controlled in light emission based on picture data Din for a stereoscopic image. Such light emission control is performed by a display controller 15 (FIG. 18) described later.

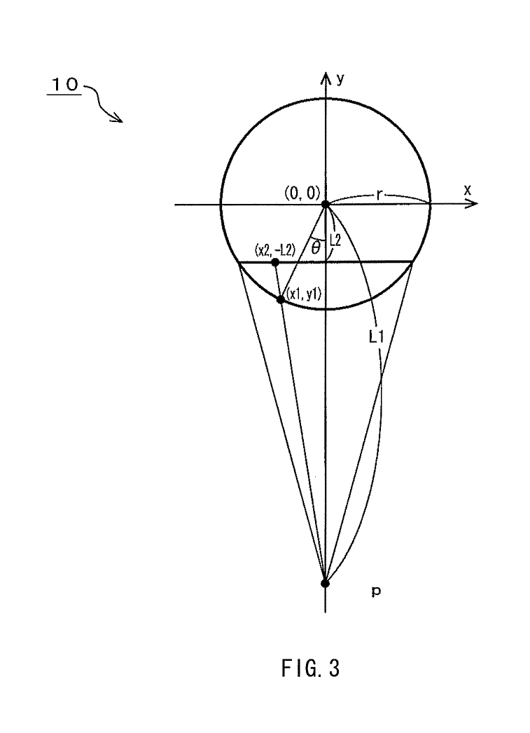

Obviously, the light-emission elements are not limited to the self-luminous element, and may be a light emitting device as a combination of a light source and a modulation element. Any form of light-emission element or light emitting device may be used as long as the element or device may follow the modulating speed of the rotation section 104 during rotational scan of the slit with respect to an eyepoint p (see FIG. 3). The two-dimensional light-emission element array 101 is mounted with the light-emission elements and besides a drive circuit (driver) for driving the light-emission element.

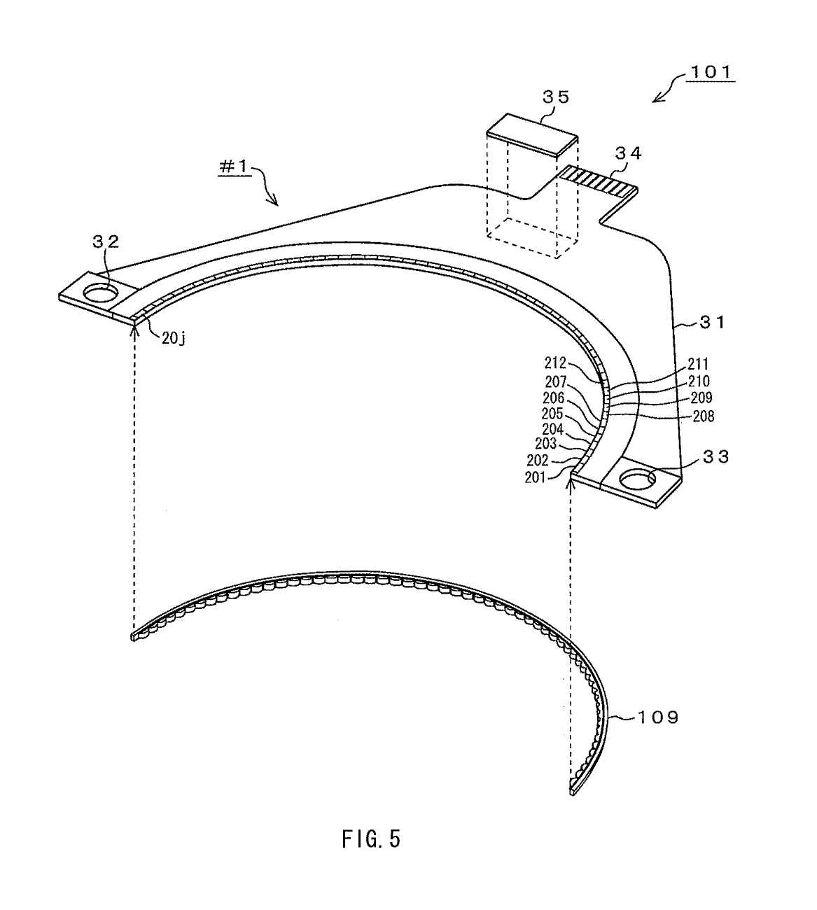

For example, the two-dimensional light-emission element array 101 has a laminated structure, where a plurality of one-dimensional light-emission element boards #1 (see FIGS. 5 to 7), each board having a plurality of light-emission elements arranged (mounted) in a line on a curved (for example, arched) cutting edge of a printed circuit board, are laminated along the axis of rotation 103. According to such a configuration, the two-dimensional light-emission element array 101 having a curved (for example, arched) light-emitting surface may be easily formed.

The outer casing 41, which is attached to cover the two-dimensional light-emission element array 101 on the turntable 42, has a cylindrical shape having a predetermined diameter φ and a predetermined height H. The diameter φ of the outer casing 41 is approximately 100 to 200 mm, and the height H is approximately 400 to 500 mm. A slit 102 is provided at a predetermined position on a circumferential surface of the outer casing 41. The slit 102 is perforated in the circumferential surface of the outer casing 41 in a direction in parallel to the axis of rotation 103, and fixed in the front of a light-emission surface of the two-dimensional light-emission element array 101 to limit a light emission angle within a predetermined range.

Obviously, the slit 102 is not limited to an opening, and may be a window formed of a light-transmissive, transparent member. In this example, a light-emission unit Ui (i=1, 2, 3 . . . ) in a set is configured by the slit 102 in the circumferential surface of the outer casing 41 and the two-dimensional light-emission element array 101 inside the outer casing.

The two-dimensional light-emission element array 101 has a curved-surface portion, and a concave side of the portion is formed to be a light-emission surface. The array 101 is disposed between the axis of rotation 103 of the rotation section 104 and the slit 102 such that the curved light-emitting surface faces the slit 102. According to such a configuration, light emitted from the curved light-emitting surface is easily guided (focused) to the slit 102 compared with a flat light-emitting surface. For the outer casing 41, a cylindrical body, formed by pressing or rolling of an iron or aluminum sheet, is used. Inner and outer sides of the outer casing 41 are preferably coated black so as to absorb light. An opening above the slit 102 of the outer casing 41 is an aperture 108 for a sensor.

A top portion of the outer casing 41 has a fan structure so that cooling air introduced from the inlet port 106 of the turntable 42 is exhausted to the outside. For example, a small fan section 107 (outlet port) such as a blade as an example of a cooling fan member is provided in the top portion (upper part) of the outer casing 41, so that an air flow is generated by using rotation of the rotation section to forcibly exhaust heat generated from the two-dimensional light-emission element array 101 or the drive circuit. The fan section 107 may be formed by cutting the upper part of the outer casing 41 to be combined with the top portion. The fan section is combined with the top portion, which strengthens the outer casing 41.

The fan section 107 is not limitedly attached to the upper side of the axis of rotation 103 of the rotation section 104, and may be attached near the axis of rotation 103 in a lower side of the outer casing 41. When the rotation section 104 rotates, an air flow from the upper side of the rotation section 104 to the lower side thereof or an air flow from the lower side of the rotation section 104 to the upper side thereof may be generated depending on a direction of a fan of the fan member. In either case, an inlet port or outlet port of air is preferably provided in the upper or lower side of the rotation section 104.

Since the fan member is attached to the axis of rotation 103 in this way, an air flow may be generated by using rotation of the rotation section 104. Therefore, heat generated from the two-dimensional light-emission element array 101 may be exhausted to the outside without adding a fan motor. Consequently, the fan motor is unnecessary, leading to reduction in cost of the omnidirectional stereoscopic image display device 10.

The setting base 105 rotatably supports the turntable 42. A not-shown bearing is provided in an upper side of the setting base 105. The bearing rotatably engages the axis of rotation 103, and supports the rotational section 104. A motor 52 (drive section) is provided within the setting base 105 so that the turntable 42 is rotated at a predetermined rotation (modulation) speed. For example, a direct-coupled-type AC motor is engaged to a lower end of the axis of rotation 103. The motor 52 transmits rotational power to the axis of rotation 103 directly and thus the axis of rotation 103 rotates, so that the rotational section 104 rotates at a predetermined modulation speed.

In the example, when power or picture data Din is transmitted to the rotational section 104, a method is used, where the power or the like is transmitted via the slip ring 51. In the method, the slip ring 51 is provided on the axis of rotation 103 to transmit power or picture data Din. The slip ring 51 is divided into a fixed-side component and a rotation-side component. The rotation-side component is attached to the axis of rotation 103. The fixed-side component is connected with a harness 53 (wiring cable).

The rotation-side component is connected with the two-dimensional light-emission element array 101 via another harness 54. A portion between the fixed-side component and the rotation-side component is structured in such a manner that a not-shown slider is electrically connected to an annular body. The slider forms the fixed-side component or the rotation-side component, while the annular body forms the rotation-side component or the fixed-side component. According to such a configuration, in the setting base 105, power or picture data Din supplied from the outside may be transmitted to the two-dimensional light-emission element array 101 via the slip ring 51.

Assembly Example of Omnidirectional Stereoscopic Image Display Device 10

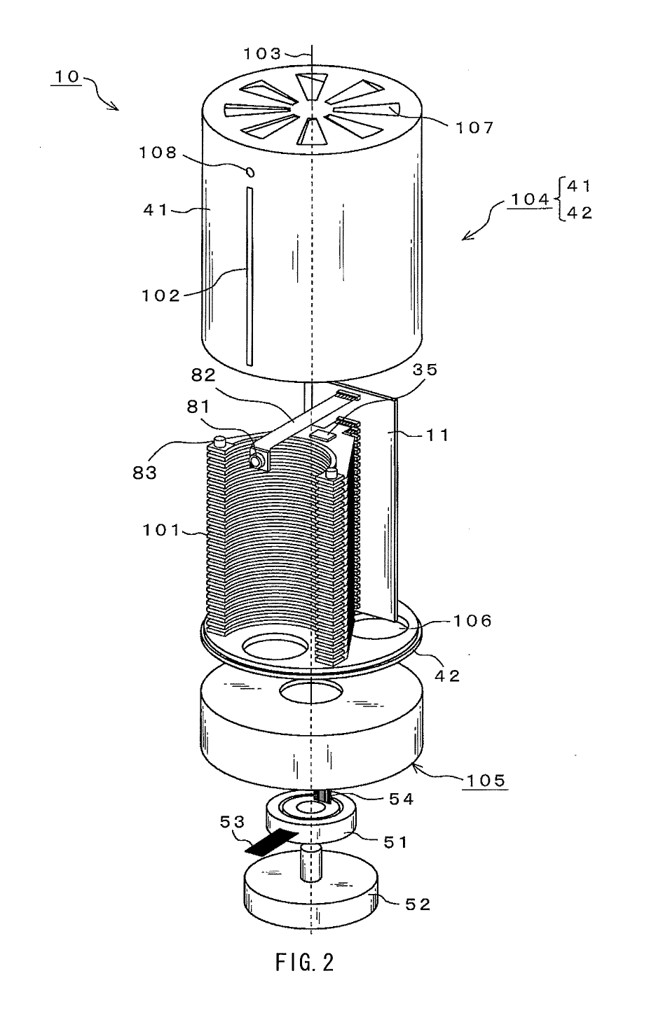

Next, a method of assembling the omnidirectional stereoscopic image display device 10 and a method of manufacturing members are described with reference to FIGS. 2 to 8. FIG. 2 is an exploded perspective diagram showing an assembly example of the omnidirectional stereoscopic image display device 10. According to the method of assembling the omnidirectional stereoscopic image display device 10, first, the outer casing with a slit 41 and the turntable with an inlet port 42 as shown in FIG. 2 are prepared to form the rotation section 104. For example, a cylinder material having a predetermined diameter is cut into a predetermined length so that a cylindrical outer casing 41 having a predetermined diameter and a predetermined length is formed. In the example, a cylindrical body formed of an iron or aluminum sheet is used for the outer casing 41.

Then, the slit 102 and the aperture 108 for a sensor are formed at predetermined positions in the circumferential surface of the outer casing 41. In the example, the slit 102 is perforated in a circumferential surface of the cylinder material in a direction parallel to the axis of rotation 103. The aperture 108 is opened above the slit 102. The outer casing 41 is used while being mounted on the turntable 42. The inner and outer portions of the outer casing 41 are preferably coated black so as to absorb light.

Next, the turntable 42 is formed by using a disc-like metal material having a predetermined thickness. The axis of rotation 103 is formed at the central position of the turntable 42. The axis of rotation 103 is the rotational center of the turntable 42 as well as the rotational center of the outer casing 41. In the example, a pair of rod-like members (hereinafter, called positioning pins 83) for positioning, which is not shown, is formed in a manner of projecting on the turntable 42. The positioning pins 83 are used for laminating the one-dimensional light-emission element boards #1 or the like.

The slip ring 51 is provided on the axis of rotation 103 to lead out the harness 54 from the rotation-side component of the ring 51. The inlet port 106 is formed at a predetermined position in the turntable 42. The inlet port 106 is an air intake port for taking air into the outer casing 41. The turntable 42 is also preferably coated black so as to absorb light.

On the other hand, the two-dimensional light-emission element array 101, having a predetermined shape for forming a stereoscopic image, is formed. In the example, the two-dimensional light-emission element array 101 is formed to have a curved light-emitting surface. FIG. 3 is an explanatory diagram showing a shape calculation example (1) of a light-emission surface of the two-dimensional light-emission element array 101.

In the example, a shape of the light-emitting surface of the two-dimensional light-emission element array 101 correspond to a curve drawn by a point (x(θ), y(θ)) expressed by the following expression in a plane of x-y coordinates (plane perpendicular to the axis of rotation 103) shown in FIG. 3. When the two-dimensional light-emission element array 101 is formed, a distance of a line from the axis of rotation 103 of the rotation section 104 to an optional eyepoint p is assumed as L1. A minimum distance from the axis of rotation 103 to the two-dimensional light-emission element array 101 is assumed as L2. In the omnidirectional stereoscopic image display device 10, image display is performed such that when the device is observed from an optional eyepoint p, a trajectory of light emitting points given by the two-dimensional light-emission element array 101, namely, an image display surface to be observed is, for example, a flat surface. In this case, L2 is equal to a distance from the axis of rotation 103 to a plane formed by the trajectory of light emitting points of a plurality of light-emission elements.

Furthermore, a distance of a line from the axis of rotation 103 of the rotation section 104 to the slit 102 is assumed as r, and an angle formed by the line of the distance L1 and the line of the distance r, indicating a position of the slit 102 to the line of the distance L1 is assumed as angle θ. An x-axis coordinate value forming the curved shape of the light-emission surface of the two-dimensional light-emission element array 101 is assumed as x(θ), and a y-axis coordinate value forming the curved shape of the light-emission surface of the two-dimensional light-emission element array 101 is assumed as y(θ). The x-axis coordinate value x(θ) is expressed by expression (1), namely, expressed by

x(θ)=r(L2−L1)sin θcos θ/(L1−r cos θ)+L2 sin θ (1).

The y-axis coordinate value y(θ) is expressed by expression (2), namely, expressed by

y(θ)=r(L2−L1)sin² θ/(L1−r cos θ)−L2 cos θ (2).

The shape of the light-emitting surface of the two-dimensional light-emission element array 101 is determined by the x-axis coordinate value x(θ) and the y-axis coordinate value y(θ). In the figure, (x1, y1) denotes coordinates of the slit 102. In addition, (x2, −L2) denotes coordinates of a light emitting point being actually observed from the eyepoint p through the slit 102.

This enables determination of a shape of a light-emitting surface of the two dimensions light-emission element array 101, where a trajectory of a light emitting point observed through the slit 102 from the eyepoint p is seen to be a plane. When the shape of the light-emitting surface is determined, the shape can be formed by cutting a printed circuit board in a curved shape.

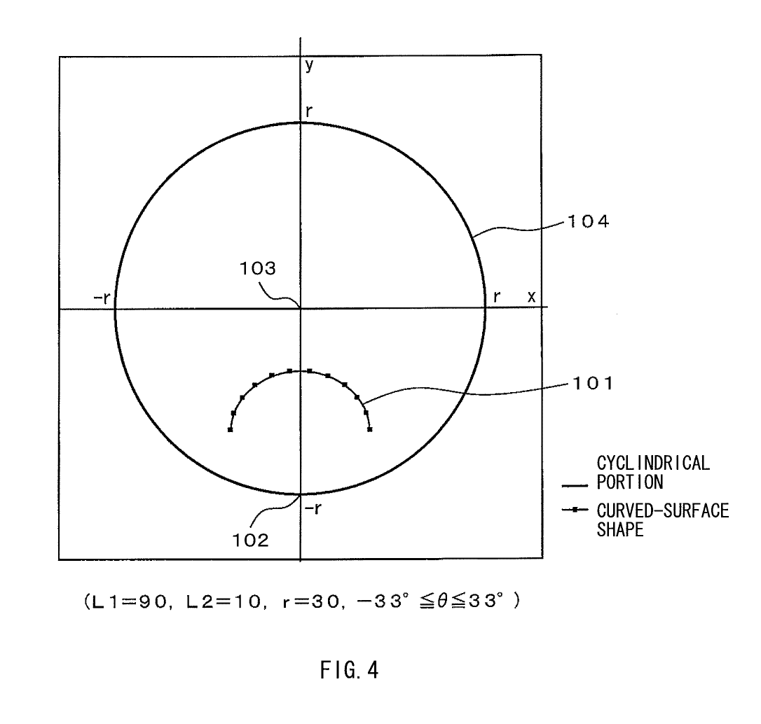

FIG. 4 is an explanatory diagram showing a calculation example of the shape of the light-emission surface of the two-dimensional light-emission element array 101 obtained by the expressions (1) and (2). According to the calculation example of the light-emitting surface shape shown in FIG. 4, the distance L1 of the line from the axis of rotation 103 of the rotation section 104 to the optional eyepoint p shown in FIG. 3 is 90 mm. The distance L2 from the axis of rotation 103 of the rotation section 104 to a virtual straight-line is 10 mm. The distance r of the line from the axis of rotation 103 of the rotation section 104 to the slit 102 is 30 mm. FIG. 4 shows a case where the angle θ formed by the line of the distance L1 and the line of the distance r, indicating a position of the slit 102 to the line of the distance L1, is −33≦θ≦33 degrees.

FIGS. 5 to 7 are perspective diagrams showing formation examples (examples 1 to 3) of the two-dimensional light-emission element array 101. FIG. 5 is an exploded perspective diagram showing a formation example of the one-dimensional light-emission element board #1. In the example, when the two-dimensional light-emission element array 101 is formed, first, the one-dimensional light-emission element board #1 is formed. The one-dimensional light-emission element board #1 is formed as follows: a not-shown copper foil board is patterned to form a wiring pattern, and then an outline of the printed circuit board 31 having the wiring pattern is cut into a Y shape, and then the inside of the board 31 is cut into a curved shape (for example, arched shape) according the expressions (1) and (2). In the example, a connector 34 of a wiring structure is formed in a side opposite to a side of the curved shape portion.

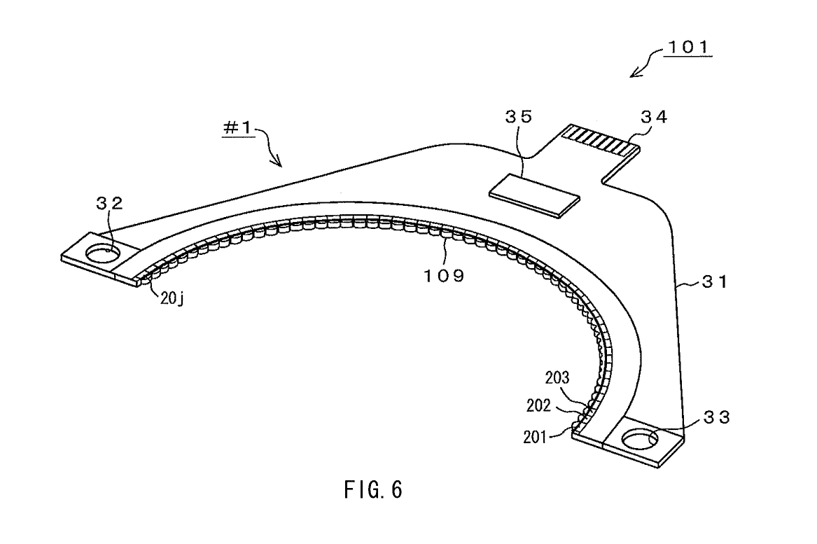

Furthermore, apertures 32 and 33 for positioning are formed on both sides of the printed circuit board 31 of the one-dimensional light-emission element board #1. IC35 (a semiconductor integrated circuit device) for serial-to-parallel conversion and for a driver is mounted on the printed circuit board 31 having an outline cut into Y shape and an inner side cut into a curved shape. Next, light-emission elements 20j in j rows are arranged in line on a curved edge or an end face of the printed circuit board 31 having the IC35 mounted thereon. Furthermore, lens members 109 in line are arranged on the front of the light-emission elements 20j so that the one-dimensional light-emission element board #1 (board) is formed (see FIG. 6).

FIG. 6 is a perspective diagram showing a configuration example of the one-dimensional light-emission element board #1. In the example, n pieces of one-dimensional light-emission element boards #1, each board being as shown in FIG. 6, are prepared. The n pieces of one-dimensional light-emission element boards #1 are laminated to form an m (rows) by n (columns) two-dimensional light-emission element array 101.

For the two-dimensional light-emission element array 101 having a curved-surface shape, a product, which is formed by folding a flexible flat panel display into a U shape so that a light-emission surface has a curved-surface shape, may be used, or a flat panel display, which is beforehand formed into a curved-surface shape, may be used. A flat panel display having a typical structure is hard to be directly used for the two-dimensional light-emission element array 101 of an embodiment of the invention. In a general flat panel display, wiring lines are arranged in a matrix, and a dynamic lighting method is used so that light-emission elements are sequentially scanned and lit in m rows or n columns.

Therefore, update of an image takes time, and update rate is approximately 240 to 1000 Hz at a maximum. Thus, an image needs to be updated at a rate sufficiently higher than 1000 Hz. In the example, fast-response light-emission elements 20j are innovatively used to significantly speed up a drive circuit of the light-emission elements 20j, or the number of light-emission element 20j to be driven at a time is innovatively significantly increased, so that the number of scan lines for dynamic lighting is decreased.

To significantly increase the number of light-emission element 20j to be driven at a time, a matrix wiring pattern can be finely divided so that small matrices corresponding to the number of divided wiring patterns are individually driven in parallel, or static lighting can be performed so that all the light-emission elements 20j are driven at a time.

FIG. 7 is a perspective diagram showing a lamination example of k pieces of one-dimensional light-emission element boards #k (k=1 to n). In the example, only a necessary number of one-dimensional light-emission element boards #k are laminated so as to produce a two-dimensional light-emission element array 101 having a curved-surface shape, in which light-emission elements 20j in j rows are arranged in line.

According to the two-dimensional light-emission element array 101 having a laminated structure as shown in FIG. 7, first, the positioning apertures 32 and 33 of the printed circuit boards of the one-dimensional light-emission element boards #k are laminated while being aligned to one another. The boards #k are laminated in this way, thereby the apertures are easily fitted on the rod-like positioning pins 83 projecting on the turntable 42. As a result, k pieces of one-dimensional light-emission element boards #1 to #k may be laminated in a self-aligning manner. According to such a formation sequence, the two-dimensional light-emission element array 101 with a light-emitting surface having a curved-surface shape may be easily produced.

In the example, if picture data Din are transmitted to the one-dimensional light-emission element board #k in parallel from the beginning, the number of lines of the wiring pattern is extremely increased. Therefore, the one-dimensional light-emission element board #k is mounted with the IC35 including IC (ASIC circuit) for serial-to-parallel conversion in addition to driver IC (drive circuit) for driving the light-emission elements 20j. The IC for serial-to-parallel conversion operates to convert serially-transmitted picture data Din into parallel data.

The one-dimensional light-emission element boards #k are structured to be laminated and an information transmission method is devised in the above way, thereby picture data Din may be transmitted close to the light-emission elements 20j through a serial wiring pattern. As a result, the number of lines of the wiring pattern may be extremely reduced compared with a case where picture data Din are transmitted in parallel to the one-dimensional light-emission element board #k. In addition, a two-dimensional light-emission element array 101 with high assembling performance and high maintenance performance may be formed with a high yield. Consequently, a two-dimensional light-emission element array 101 having a curved-surface shape may be produced.

When the two-dimensional light-emission element array 101 is prepared as shown in FIGS. 3 to 7, the array 101 is attached at a predetermined position in the rotation section 104 shown in FIG. 2, or attached on the turntable 42 in the example. At that time, when the apertures of the printed circuit boards of the k pieces of one-dimensional light-emission element boards #k are inserted with the rod-like positioning pins 83 projecting on the turntable 42, each one-dimensional light-emission element board #k is positioned in a self-aligning manner. The k pieces of one-dimensional light-emission element boards #1 to #n are attached in a manner of being laminated along the axis of rotation 103 so as to maintain the above state.

In the example, a connection board 11 mounted on a predetermined substrate is vertically provided on the turntable 42. The connection board 11 has a plug-in structure connector for connecting the board 11 to a connector of a wiring structure of each of the one-dimensional light-emission element boards #1 to #n. The connector of the wiring structure of each of the one-dimensional light-emission element boards #1 to #n is fitted in the plug-in structure connector of the connection board 11, so that the k pieces of one-dimensional light-emission element boards #1 to #n are connected to the connection board 11.

In addition, the two-dimensional light-emission element array 101 is disposed between the axis of rotation 103 of the rotation section 104 and the slit 102 of the outer casing 41 such that the curved light-emitting surface (a concave side) faces a position of the slit 102. For example, the two-dimensional light-emission element array 101 is attached at a position where the axis of rotation 103 of the rotation section 104, the center of the array 101 and the slit 102 are aligned in a line. The two-dimensional light-emission element array 101 is connected to the harness 54 led out from the rotation-side component of the slip ring 51.

In the example, a viewer detection sensor 81 as an example of the observer detection section is attached at a position through which the outside may be viewed from the inside of the outer casing 41. The viewer detection sensor 81 is attached to the connection board 11 via an arm member 82. The viewer detection sensor 81 is attached to one end of the arm member 82, and used for determination of presence of a viewer by detecting a viewer viewing a relevant stereoscopic image outside the rotation section 104 rotated by the motor 52. For the viewer detection sensor 81, a position sensitive detector (PSD), a ultrasonic wave sensor, an infrared sensor, or a face-recognition camera is used.

The viewer detection sensor 81 is desirably able to detect the entire circumference with fine angular resolution. In the example, since the viewer detection sensor 81 detects a viewer while being rotated with the rotation section 104, the entire circumference may be detected by only one viewer detection sensor 81, and a system with high angular resolution may be formed. As a result, the number of sensors may be remarkably reduced, and consequently cost reduction may be achieved despite high resolution.

When a high-speed camera is used as the viewer detection sensor 81, the camera is attached on the axis of rotation 103 of the rotation section 104. Such a high-speed camera is attached on the axis of rotation 103 of the rotation section 104 and rotated with the rotation section, enabling detection of presence of an observer over the full range of 360 degrees.

When the two-dimensional light-emission element array 101 is mounted on the turntable 42, the outer casing 41 is attached in a manner of covering the array 101 on the turntable 42. The slit 102 is fixed in front of the light-emitting surface of the two-dimensional light-emission element array 101, thereby an emission angle of light may be limited within a predetermined range. Consequently, the light-emission unit U1 may be configured by the slit 102 in the circumferential surface of the outer casing 41 and the two-dimensional light-emission element array 101 inside the casing 41.

On the other hand, the setting base 105 is prepared to support the turntable 42 rotatably. In the example, the slip ring 51 is provided in the upper side of the setting base 105 and a not-shown bearing is mounted therein. The bearing rotatably engages the axis of rotation 103 and supports the rotation section 104. A motor 52, a controller 55, an I/F board 56, a power supply unit 57 and the like are mounted in the setting base 105 in addition to the slip ring 51 (see FIG. 18). The motor 52 is directly connected to the axis of rotation 103.

The controller 55 and the power supply unit 57 are connected to the fixed-side component of the slip ring 51 via the harness 53. Consequently, in the setting base 105, power or picture data Din supplied from the outside may be transmitted to the two-dimensional light-emission element array 101 via the slip ring 51. When the setting base 105 is prepared, the rotation section 104 attached with the two-dimensional light-emission element array 101 is mounted on the setting base 105. Consequently, the omnidirectional stereoscopic image display device 10 is completed.

Function Example of Lens Member 109 of Two-Dimensional Light-Emission Element Array 101

FIG. 8 is a schematic diagram showing a function example of a lens member 109 of the two-dimensional light-emission element array 101 as viewed from above in an axis of rotation direction. In the example, the two-dimensional light-emission element array 101 shown in FIG. 8 includes a plurality of one-dimensional light-emission element boards #1 being laminated. For example, 12 (m=12) light-emission elements 20j (j=1 to m) are assumed to be arranged in the first row for convenience. In the example shown in FIGS. 5 to 7, the number of light-emission elements is 59 (m=59).

Most of light emitted from light-emission elements 201 to 212 are scattered within the outer casing 41 and changed into heat rather than arriving at the neighborhood of the slit 102. Thus, in the two-dimensional light-emission element array 101, a lens member 109 having a predetermined shape is attached to a light-emitting surface of each of the light-emission elements 201 to 212. In the example, the lens member 109 is attached for each of the light-emission elements 20j, so that beams radially emitted from each of the light-emission elements 201 to 212 are parallel beams. Consequently, light beams from the light-emission elements 201 to 212 may be condensed near the slit 102.

A microlens or a SELFOC lens is used for the lens member 109. It will be appreciated that a sheet lens or plate lens such as a microlens array or a SELFOC lens array may be attached to the two-dimensional light-emission element array 101 to reduce production cost instead of attaching the lens member 109 for each of the light-emission elements 201 to 212.

If light is condensed only in a horizontal direction, a lenticular lens may be used. Such a lens member 109 is attached, thereby scattered light may be reduced as much as possible, and thus light may be efficiently used, and besides certain luminance and certain contrast for the omnidirectional stereoscopic image display device 10 are advantageously obtained, and consequently improvement in power efficiency may be expected.

Operation Principle of Omnidirectional Stereoscopic Image Display Device 10

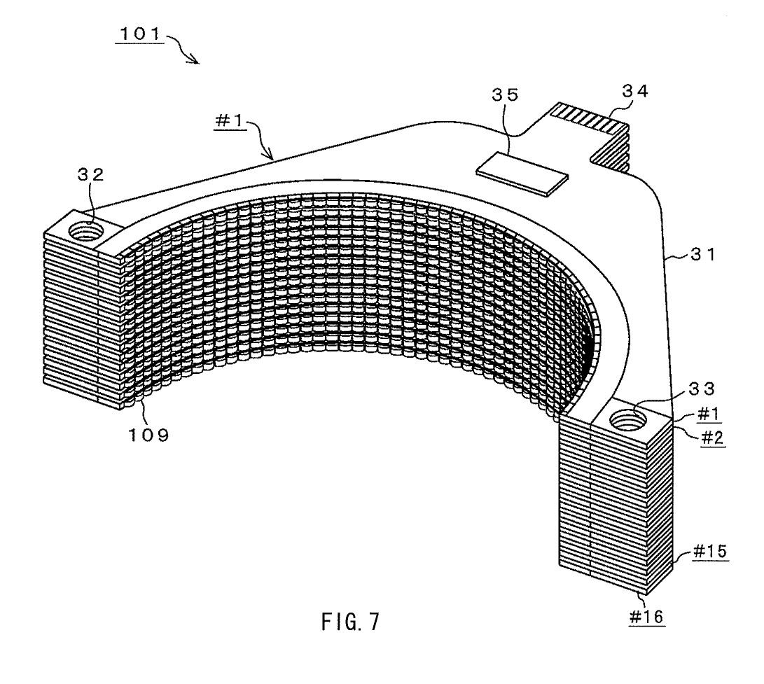

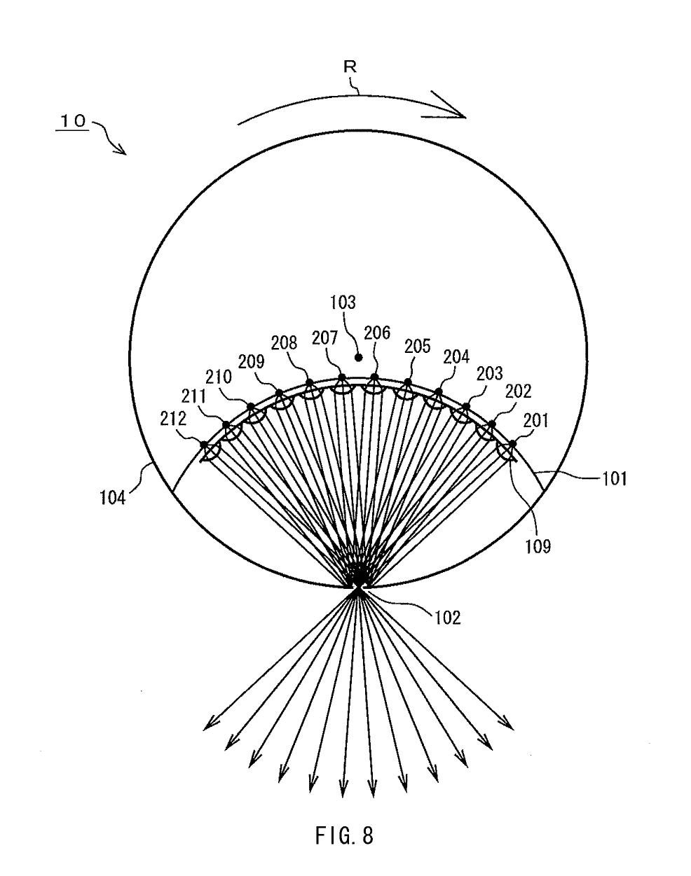

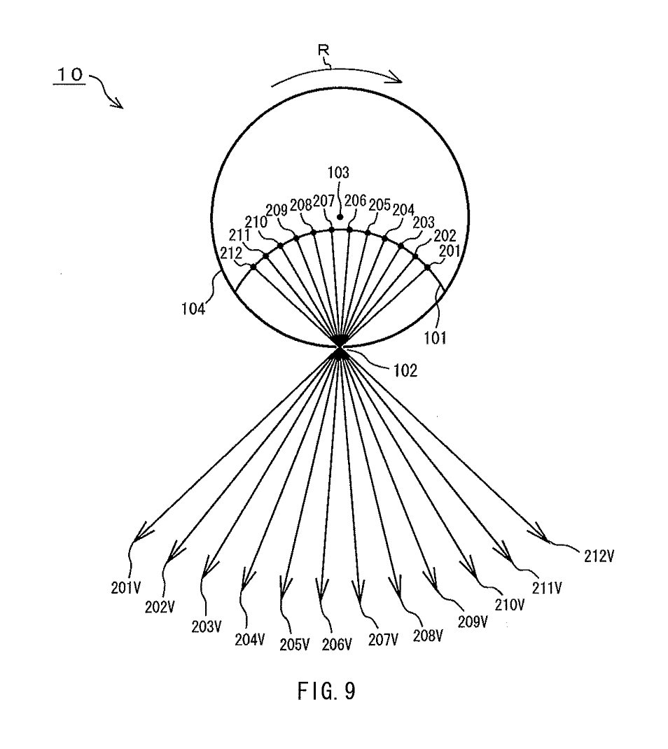

Next, an operation principle of the omnidirectional stereoscopic image display device 10 is described with reference to FIGS. 9 to 17. FIG. 9 is a schematic diagram showing an operation example of the omnidirectional stereoscopic image display device 10 as viewed from above in the axis of rotation direction. In the figure, the lens member 109 is omitted.

The omnidirectional stereoscopic image display device 10 shown in FIG. 9 uses the integral imaging method, and has a structure where the rotation section 104 rotates in a direction of an arrow R (see FIG. 1) or a direction opposite to the arrow R direction with the axis of rotation 103 as a rotational center.

The omnidirectional stereoscopic image display device 10 is structured such that the slit 102 is provided parallel to the axis of rotation 103 in the outer casing 41 in front of the light-emission surface of the two-dimensional light-emission element array 101, and light emitted from the array 101 does not leak from any portion other than the slit portion. According to such a slit structure, light emitted from each of the light-emission elements 201 to 212 of the two-dimensional light-emission element array 101 is greatly limited in horizontal emission angle by the slit 102.

While the number of the light-emission elements 201 to 212 is assumed as 12 (m=12) in the example, any other number of the light-emission elements may be used. Light of a stereoscopic image, formed with respect to the axis of rotation 103 by the 12 light-emission elements 201 to 212, leaks to the outside from the inside of the rotation section 104 through the slit 102. Here, a direction of a line connecting between each of the 12 light-emission elements 201 to 212 and the slit 102 is shown by a vector.

A direction of a line connecting between the light-emission element 201 and the slit 102 is assumed as a direction of light leaking from the light-emission element 201 through the slit 102. Hereinafter, the direction is described as “vector 201V direction”. Similarly, a direction of a line connecting between the light-emission element 202 and the slit 102 is assumed as a direction of light leaking from the light-emission element 202 through the slit 102. The direction is described as “vector 202V direction”. Similarly, a direction of a line connecting between the light-emission element 212 and the slit 102 is assumed as a direction of light leaking from the light-emission element 212 through the slit 102. The direction is described as “vector 212V direction”.

For example, light outputted from the light-emission element 201 is emitted in the vector 201V direction through the slit 102. Light outputted from the light-emission element 202 is emitted in the vector 202V direction through the slit 102. Similarly, light outputted from each of the light-emission elements 203 to 212 is emitted through the slit 102 in each of directions of a vector 203V direction to a vector 212V direction. In this way, light from the light-emission elements 201 to 212 are emitted in different directions, which enables integral imaging for one vertical line restricted by the slit 102.

The rotation section 104 having such a slit structure is rotationally scanned with respect to the eyepoint p, thereby a cylindrical integral imaging surface may be formed. Furthermore, picture data Din from the outside or picture data Din from a storage device such as ROM within the rotation section are reflected on the light-emission unit U1 of the two-dimensional light-emission element array 101 depending on an angle of the rotational scan with respect to the eyepoint p, thereby any optional reproducing beam may be outputted.

Trajectory Example of Light Emitting Points

Next, description is made on a trajectory example of light emitting points observed from an eyepoint p.

In the omnidirectional stereoscopic image display device 10, for example, 12 (m=12) light-emission elements 201 to 212 are disposed at different positions as described above in a plane perpendicular to the axis of rotation 103 in the two-dimensional light-emission element array 101. Each of the m pieces of light-emission elements emits light to the outside through the slit 102 for each of different visual-point positions in accordance with rotation of the rotation section 104. Here, it is assumed that while the rotation section 104 rotates, observation is made in a direction toward the axis of rotation 103 from an optional visual-point position in the periphery of the rotation section 104. A display controller 15 (FIG. 18) described later performs emission control of a plurality of light-emission elements such that a trajectory of light emitting points of the light-emission elements forms, for example, a planar image within the rotation section 104 in correspondence to an optional visual-point position. At each visual-point position, for example, a planar image, having a small parallax in correspondence to the relevant visual-point position, is observed. Therefore, when observation is made from optional, two visual-point positions corresponding to positions of two eyes of an observer, for example, planar images, having parallaxes to each other in correspondence to the visual-point positions, are observed. Consequently, an observer may recognize a stereoscopic image at any position around the rotation section.

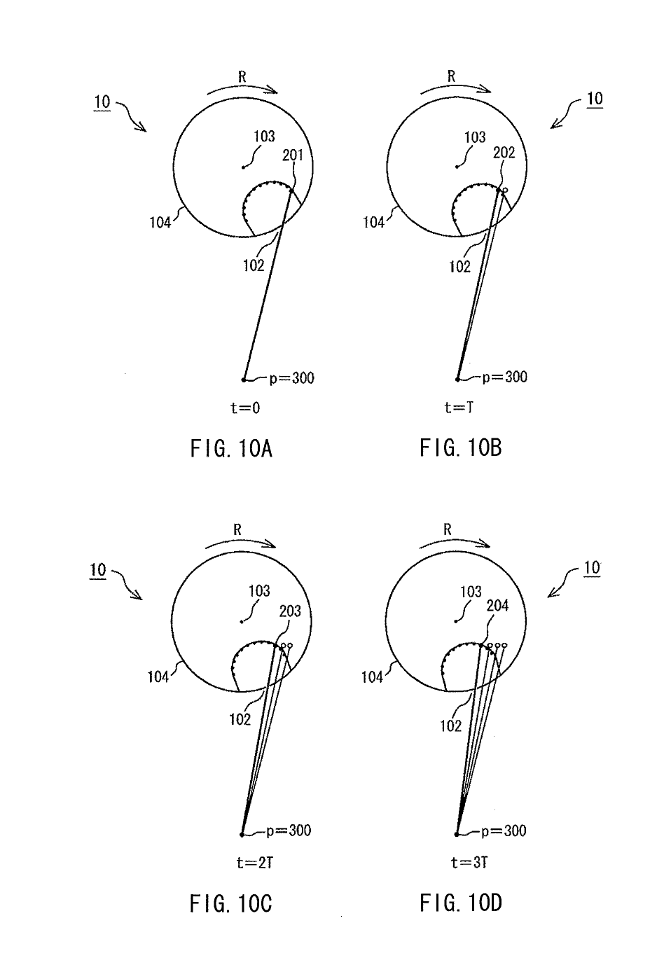

FIGS. 10A to 12D are explanatory diagrams showing a trajectory example of light emitting points observed from an eyepoint p. As shown in FIGS. 10A to 10D, when the rotation section 104 having the light-emission unit U1 is rotated at uniform velocity and thus rotationally scanned with respect to an eyepoint p=300, a light-emission element observed from the eyepoint 300 is sequentially shifted in order of 201, 202, 203, . . . and 212 at an interval of time T.

A structure, where a trajectory of light emitting points (black small circles in the figure) is seen to be, for example, a plane, is achieved by adjusting a shape of the light-emission surface of the two-dimensional light-emission element array 101 and a position of the slit 102. For example, when the two-dimensional light-emission element array 101 is observed through the slit 102 at the eyepoint 300 at time t=0 shown in FIG. 10A, light leaking from the light-emission element 201 is observed.

When the two-dimensional light-emission element array 101 is observed through the slit 102 at the eyepoint 300 at time t=T shown in FIG. 10B, light leaking from the light-emission element 202 is observed. A first white small-circle from the right in the figure shows a light emitting point of the light-emission element 201. When the two-dimensional light-emission element array 101 is observed through the slit 102 at the eyepoint 300 at time t=2T shown in FIG. 10C, light leaking from the light-emission element 203 is observed. A second small-circle in FIG. 10C shows a light-emission point of the light-emission element 202.

When the two-dimensional light-emission element array 101 is observed through the slit 102 at the eyepoint 300 at time t=3T shown in FIG. 10D, light leaking from the light-emission element 204 is observed. A third small-circle in FIG. 10D shows a light emitting point of the light-emission element 203.

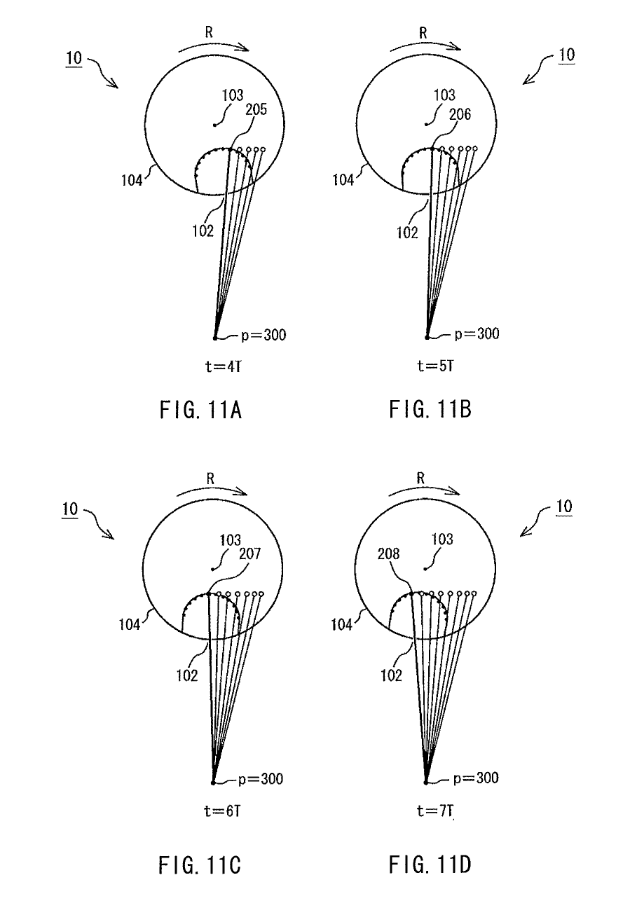

When the two-dimensional light-emission element array 101 is observed through the slit 102 at the eyepoint 300 at time t=4T shown in FIG. 11A, light leaking from the light-emission element 205 is observed. A fourth small-circle in FIG. 11A shows a light-emission point of the light-emission element 204. When the two-dimensional light-emission element array 101 is observed through the slit 102 at the eyepoint 300 at time t=5T shown in FIG. 11B, light leaking from the light-emission element 206 is observed. A fifth small-circle in FIG. 11B shows a light-emission point of the light-emission element 205.

When the two-dimensional light-emission element array 101 is observed through the slit 102 at the eyepoint 300 at time t=6T shown in FIG. 11C, light leaking from the light-emission element 207 is observed. A sixth small-circle in FIG. 11C shows a light-emission point of the light-emission element 206. When the two-dimensional light-emission element array 101 is observed through the slit 102 at the eyepoint 300 at time t=7T shown in FIG. 11D, light leaking from the light-emission element 208 is observed. A seventh small-circle in FIG. 11D shows a light emitting point of the light-emission element 207.

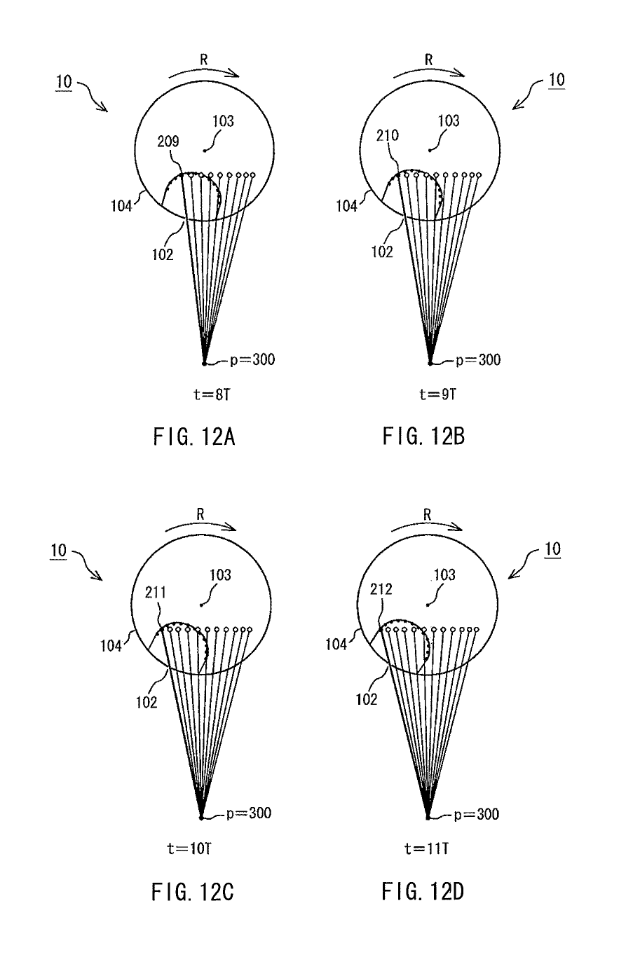

When the two-dimensional light-emission element array 101 is observed through the slit 102 at the eyepoint 300 at time t=8T shown in FIG. 12A, light leaking from the light-emission element 209 is observed. An eighth small-circle in FIG. 12A shows a light-emission point of the light-emission element 208. When the two-dimensional light-emission element array 101 is observed through the slit 102 at the eyepoint 300 at time t=9T shown in FIG. 12B, light leaking from the light-emission element 210 is observed. A ninth small-circle in FIG. 12B shows a light-emission point of the light-emission element 209.

When the two-dimensional light-emission element array 101 is observed through the slit 102 at the eyepoint 300 at time t=10T shown in FIG. 12C, light leaking from the light-emission element 211 is observed. A tenth small-circle in FIG. 12C shows a light-emission point of the light-emission element 210. When the two-dimensional light-emission element array 101 is observed through the slit 102 at the eyepoint 300 at time t=11T shown in FIG. 12D, light leaking from the light-emission element 212 is observed. At eleventh small-circle in FIG. 12D shows a light emitting point of the light-emission element 211. A twelfth small-circle in FIG. 12D shows a light emitting point of the light-emission element 212.

Aspect of Beam Output

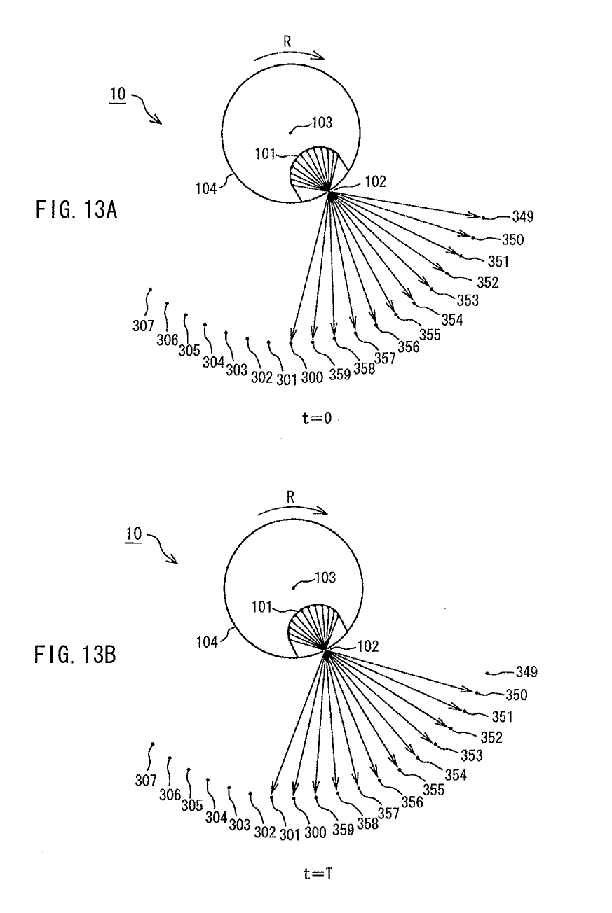

Next, description is made on an aspect of outputting beams through the slit 102 to a plurality of eyepoints. FIG. 13A to FIG. 16 are explanatory diagrams showing an aspect (aspect 1 to aspect 4) of outputting beams through the slit 102 to a plurality of eyepoints p. The example shows an aspect of a section from time t=0 to t=5T ( 1/12 circumference), in which the rotation section 104 rotates 30 degrees from an optional reference position, in the case that 60 eyepoints p=300 to 359 are set every 6 degrees over the entire circumference (360 degrees) of the light-emission unit U1.

According to such a light-emission unit U1, beams are outputted to a plurality of (twelve) eyepoints p at a time by the number of the light-emission elements 201 to 212 as shown in FIGS. 13A and 13B, FIGS. 14A and 14B and FIGS. 15A and 15B. Beams are outputted in this way, thereby a trajectory of light emitting points is observed to be a plane not only from the eyepoint p=300 but also from other eyepoints p=349 to 359.

For example, when the two-dimensional light-emission element array 101 is observed through the slit 102 at the eyepoint 300 (p is omitted) at time t=0 shown in FIG. 13A, light leaking from the light-emission element 201 is observed. The example shows a case where the rotation section 104 is rotated clockwise, and an eyepoint is shifted 6 degrees at a time with the eyepoint 300 as a reference. When the two-dimensional light-emission element array 101 is observed through the slit 102 at another eyepoint 359 located by 6 degrees counterclockwise from the eyepoint 300 shown in FIG. 13A, light leaking from the light-emission element 202 is observed.

When the two-dimensional light-emission element array 101 is observed through the slit 102 at an eyepoint 358 located by 12 degrees counterclockwise from the eyepoint 300 shown in FIG. 13A, light leaking from the light-emission element 203 is observed. When the two-dimensional light-emission element array 101 is observed through the slit 102 at an eyepoint 357 located by 18 degrees counterclockwise from the eyepoint 300 shown in FIG. 13A, light leaking from the light-emission element 204 is observed.

When the two-dimensional light-emission element array 101 is observed through the slit 102 at an eyepoint 356 located by 24 degrees counterclockwise from the eyepoint 300 shown in FIG. 13A, light leaking from the light-emission element 205 is observed. When the two-dimensional light-emission element array 101 is observed through the slit 102 at an eyepoint 355 located by 30 degrees counterclockwise from the eyepoint 300 shown in FIG. 13A, light leaking from the light-emission element 206 is observed.

When the two-dimensional light-emission element array 101 is observed through the slit 102 at an eyepoint 354 located by 36 degrees counterclockwise from the eyepoint 300 shown in FIG. 13A, light leaking from the light-emission element 207 is observed. When the two-dimensional light-emission element array 101 is observed through the slit 102 at an eyepoint 353 located by 42 degrees counterclockwise from the eyepoint 300 shown in FIG. 13A, light leaking from the light-emission element 208 is observed.

When the two-dimensional light-emission element array 101 is observed through the slit 102 at an eyepoint 352 located by 48 degrees counterclockwise from the eyepoint 300 shown in FIG. 13A, light leaking from the light-emission element 209 is observed. When the two-dimensional light-emission element array 101 is observed through the slit 102 at an eyepoint 351 located by 54 degrees counterclockwise from the eyepoint 300 shown in FIG. 13A, light leaking from the light-emission element 210 is observed.

When the two-dimensional light-emission element array 101 is observed through the slit 102 at an eyepoint 350 located by 60 degrees counterclockwise from the eyepoint 300 shown in FIG. 13A, light leaking from the light-emission element 211 is observed. When the two-dimensional light-emission element array 101 is observed through the slit 102 at an eyepoint 349 located by 66 degrees counterclockwise from the eyepoint 300 shown in FIG. 13A, light leaking from the light-emission element 212 is observed.

When the two-dimensional light-emission element array 101 is observed through the slit 102 at an eyepoint 300 at time t=T shown in FIG. 13B, light leaking from the light-emission element 202 is observed. When the two-dimensional light-emission element array 101 is observed through the slit 102 at another eyepoint 301 located by 6 degrees clockwise from the eyepoint 300 shown in FIG. 13B, light leaking from the light-emission element 201 is observed.

When the two-dimensional light-emission element array 101 is observed through the slit 102 at another eyepoint 359 located by 6 degrees counterclockwise from the eyepoint 300 shown in FIG. 13B, light leaking from the light-emission element 203 is observed. When the two-dimensional light-emission element array 101 is observed through the slit 102 at an eyepoint 358 located by 12 degrees counterclockwise from the eyepoint 300 shown in FIG. 13B, light leaking from the light-emission element 204 is observed.

When the two-dimensional light-emission element array 101 is observed through the slit 102 at an eyepoint 357 located by 18 degrees counterclockwise from the eyepoint 300 shown in FIG. 13B, light leaking from the light-emission element 205 is observed. When the two-dimensional light-emission element array 101 is observed through the slit 102 at an eyepoint 356 located by 24 degrees counterclockwise from the eyepoint 300 shown in FIG. 13B, light leaking from the light-emission element 206 is observed.

When the two-dimensional light-emission element array 101 is observed through the slit 102 at an eyepoint 355 located by 30 degrees counterclockwise from the eyepoint 300 shown in FIG. 13B, light leaking from the light-emission element 207 is observed. When the two-dimensional light-emission element array 101 is observed through the slit 102 at an eyepoint 354 located by 36 degrees counterclockwise from the eyepoint 300 shown in FIG. 13B, light leaking from the light-emission element 208 is observed.

When the two-dimensional light-emission element array 101 is observed through the slit 102 at an eyepoint 353 located by 42 degrees counterclockwise from the eyepoint 300 shown in FIG. 13B, light leaking from the light-emission element 209 is observed. When the two-dimensional light-emission element array 101 is observed through the slit 102 at an eyepoint 352 located by 48 degrees counterclockwise from the eyepoint 300 shown in FIG. 13B, light leaking from the light-emission element 210 is observed.

When the two-dimensional light-emission element array 101 is observed through the slit 102 at an eyepoint 351 located by 54 degrees counterclockwise from the eyepoint 300 shown in FIG. 13B, light leaking from the light-emission element 211 is observed. When the two-dimensional light-emission element array 101 is observed through the slit 102 at an eyepoint 350 located by 60 degrees counterclockwise from the eyepoint 300 shown in FIG. 13B, light leaking from the light-emission element 212 is observed.

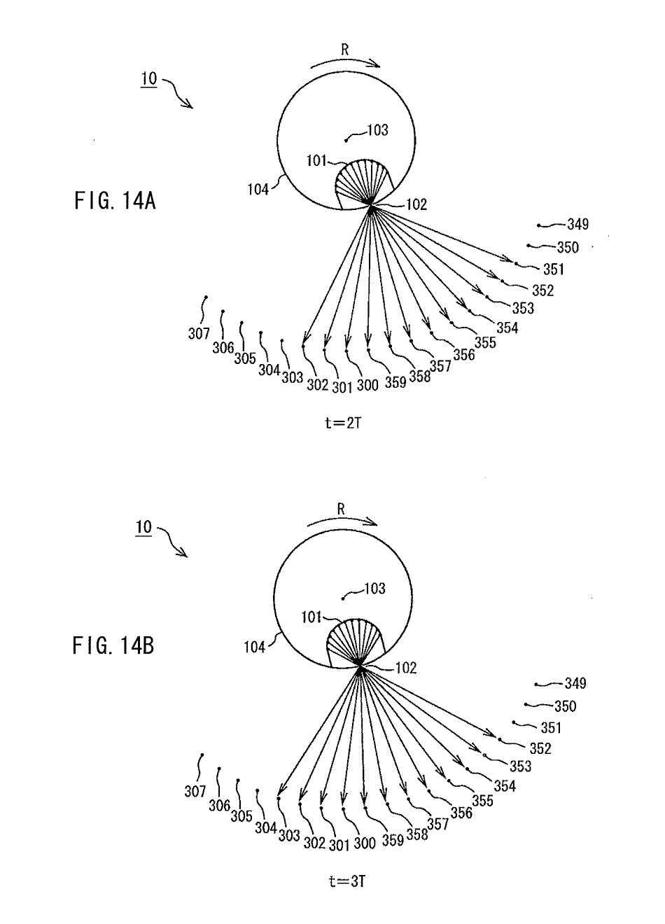

When the two-dimensional light-emission element array 101 is observed through the slit 102 at an eyepoint 300 at time t=2T shown in FIG. 14A, light leaking from the light-emission element 203 is observed. When the two-dimensional light-emission element array 101 is observed through the slit 102 at another eyepoint 301 located by 6 degrees clockwise from the eyepoint 300 shown in FIG. 14A, light leaking from the light-emission element 202 is observed.

When the two-dimensional light-emission element array 101 is observed through the slit 102 at another eyepoint 302 located by 12 degrees clockwise from the eyepoint 300 shown in FIG. 14A, light leaking from the light-emission element 201 is observed. When the two-dimensional light-emission element array 101 is observed through the slit 102 at another eyepoint 359 located by 6 degrees counterclockwise from the eyepoint 300 shown in FIG. 14A, light leaking from the light-emission element 204 is observed.

When the two-dimensional light-emission element array 101 is observed through the slit 102 at an eyepoint 358 located by 12 degrees counterclockwise from the eyepoint 300 shown in FIG. 14A, light leaking from the light-emission element 205 is observed. When the two-dimensional light-emission element array 101 is observed through the slit 102 at an eyepoint 357 located by 18 degrees counterclockwise from the eyepoint 300 shown in FIG. 14A, light leaking from the light-emission element 206 is observed.

When the two-dimensional light-emission element array 101 is observed through the slit 102 at an eyepoint 356 located by 24 degrees counterclockwise from the eyepoint 300 shown in FIG. 14A, light leaking from the light-emission element 207 is observed. When the two-dimensional light-emission element array 101 is observed through the slit 102 at an eyepoint 355 located by 30 degrees counterclockwise from the eyepoint 300 shown in FIG. 14A, light leaking from the light-emission element 208 is observed.

When the two-dimensional light-emission element array 101 is observed through the slit 102 at an eyepoint 354 located by 36 degrees counterclockwise from the eyepoint 300 shown in FIG. 14A, light leaking from the light-emission element 209 is observed. When the two-dimensional light-emission element array 101 is observed through the slit 102 at an eyepoint 353 located by 42 degrees counterclockwise from the eyepoint 300 shown in FIG. 14A, light leaking from the light-emission element 210 is observed.

When the two-dimensional light-emission element array 101 is observed through the slit 102 at an eyepoint 352 located by 48 degrees counterclockwise from the eyepoint 300 shown in FIG. 14A, light leaking from the light-emission element 211 is observed. When the two-dimensional light-emission element array 101 is observed through the slit 102 from an eyepoint 351 located by 54 degrees counterclockwise from the eyepoint 300 shown in FIG. 14A, light leaking from the light-emission element 212 is observed.

When the two-dimensional light-emission element array 101 is observed through the slit 102 at an eyepoint 300 at time t=3T shown in FIG. 14B, light leaking from the light-emission element 204 is observed. When the two-dimensional light-emission element array 101 is observed through the slit 102 at another eyepoint 301 located by 6 degrees clockwise from the eyepoint 300 shown in FIG. 14B, light leaking from the light-emission element 203 is observed.

When the two-dimensional light-emission element array 101 is observed through the slit 102 at another eyepoint 302 located by 12 degrees clockwise from the eyepoint 300 shown in FIG. 14B, light leaking from the light-emission element 202 is observed. When the two-dimensional light-emission element array 101 is observed through the slit 102 at another eyepoint 303 located by 18 degrees clockwise from the eyepoint 300 shown in FIG. 14B, light leaking from the light-emission element 201 is observed.

When the two-dimensional light-emission element array 101 is observed through the slit 102 at another eyepoint 359 located by 6 degrees counterclockwise from the eyepoint 300 shown in FIG. 14B, light leaking from the light-emission element 205 is observed. When the two-dimensional light-emission element array 101 is observed through the slit 102 at an eyepoint 358 located by 12 degrees counterclockwise from the eyepoint 300 shown in FIG. 14B, light leaking from the light-emission element 206 is observed.

When the two-dimensional light-emission element array 101 is observed through the slit 102 at an eyepoint 357 located by 18 degrees counterclockwise from the eyepoint 300 shown in FIG. 14B, light leaking from the light-emission element 207 is observed. When the two-dimensional light-emission element array 101 is observed through the slit 102 at an eyepoint 356 located by 24 degrees counterclockwise from the eyepoint 300 shown in FIG. 14B, light leaking from the light-emission element 208 is observed.

When the two-dimensional light-emission element array 101 is observed through the slit 102 at an eyepoint 355 located by 30 degrees counterclockwise from the eyepoint 300 shown in FIG. 14B, light leaking from the light-emission element 209 is observed. When the two-dimensional light-emission element array 101 is observed through the slit 102 at an eyepoint 354 located by 36 degrees counterclockwise from the eyepoint 300 shown in FIG. 14B, light leaking from the light-emission element 210 is observed.

When the two-dimensional light-emission element array 101 is observed through the slit 102 at an eyepoint 353 located by 42 degrees counterclockwise from the eyepoint 300 shown in FIG. 14B, light leaking from the light-emission element 211 is observed. When the two-dimensional light-emission element array 101 is observed through the slit 102 at an eyepoint 352 located by 48 degrees counterclockwise from the eyepoint 300 shown in FIG. 14B, light leaking from the light-emission element 212 is observed.

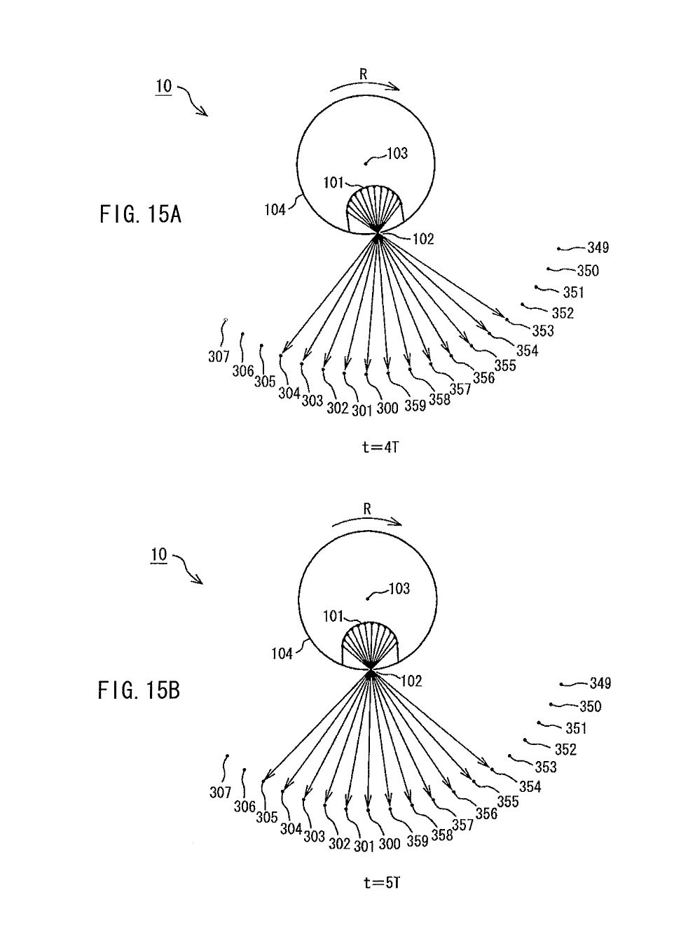

Furthermore, when the two-dimensional light-emission element array 101 is observed through the slit 102 at an eyepoint 300 at time t=4T shown in FIG. 15A, light leaking from the light-emission element 205 is observed. When the two-dimensional light-emission element array 101 is observed through the slit 102 at another eyepoint 301 located by 6 degrees clockwise from the eyepoint 300 shown in FIG. 15A, light leaking from the light-emission element 204 is observed.

When the two-dimensional light-emission element array 101 is observed through the slit 102 at another eyepoint 302 located by 12 degrees clockwise from the eyepoint 300 shown in FIG. 15A, light leaking from the light-emission element 203 is observed. When the two-dimensional light-emission element array 101 is observed through the slit 102 at another eyepoint 303 located by 18 degrees clockwise from the eyepoint 300 shown in FIG. 15A, light leaking from the light-emission element 202 is observed.

When the two-dimensional light-emission element array 101 is observed through the slit 102 at another eyepoint 304 located by 24 degrees clockwise from the eyepoint 300 shown in FIG. 15A, light leaking from the light-emission element 201 is observed. When the two-dimensional light-emission element array 101 is observed through the slit 102 at another eyepoint 359 located by 6 degrees counterclockwise from the eyepoint 300 shown in FIG. 15A, light leaking from the light-emission element 206 is observed.

When the two-dimensional light-emission element array 101 is observed through the slit 102 at an eyepoint 358 located by 12 degrees counterclockwise from the eyepoint 300 shown in FIG. 15A, light leaking from the light-emission element 207 is observed. When the two-dimensional light-emission element array 101 is observed through the slit 102 at an eyepoint 357 located by 18 degrees counterclockwise from the eyepoint 300 shown in FIG. 15A, light leaking from the light-emission element 208 is observed.

When the two-dimensional light-emission element array 101 is observed through the slit 102 at an eyepoint 356 located by 24 degrees counterclockwise from the eyepoint 300 shown in FIG. 15A, light leaking from the light-emission element 209 is observed. When the two-dimensional light-emission element array 101 is observed through the slit 102 at an eyepoint 355 located by 30 degrees counterclockwise from the eyepoint 300 shown in FIG. 15A, light leaking from the light-emission element 210 is observed.

When the two-dimensional light-emission element array 101 is observed through the slit 102 at an eyepoint 354 located by 36 degrees counterclockwise from the eyepoint 300 shown in FIG. 15A, light leaking from the light-emission element 211 is observed. When the two-dimensional light-emission element array 101 is observed through the slit 102 at an eyepoint 353 located by 42 degrees counterclockwise from the eyepoint 300 shown in FIG. 15A, light leaking from the light-emission element 212 is observed.

Furthermore, when the two-dimensional light-emission element array 101 is observed through the slit 102 at an eyepoint 300 at time t=5T shown in FIG. 15B, light leaking from the light-emission element 206 is observed. When the two-dimensional light-emission element array 101 is observed through the slit 102 at another eyepoint 301 located by 6 degrees clockwise from the eyepoint 300 shown in FIG. 15B, light leaking from the light-emission element 205 is observed.

When the two-dimensional light-emission element array 101 is observed through the slit 102 at another eyepoint 302 located by 12 degrees clockwise from the eyepoint 300 shown in FIG. 15B, light leaking from the light-emission element 204 is observed. When the two-dimensional light-emission element array 101 is observed through the slit 102 at another eyepoint 303 located by 18 degrees clockwise from the eyepoint 300 shown in FIG. 15B, light leaking from the light-emission element 203 is observed.

When the two-dimensional light-emission element array 101 is observed through the slit 102 at another eyepoint 304 located by 24 degrees clockwise from the eyepoint 300 shown in FIG. 15B, light leaking from the light-emission element 202 is observed. When the two-dimensional light-emission element array 101 is observed through the slit 102 at another eyepoint 305 located by 30 degrees clockwise from the eyepoint 300 shown in FIG. 15B, light leaking from the light-emission element 201 is observed.

When the two-dimensional light-emission element array 101 is observed through the slit 102 at another eyepoint 359 located by 6 degrees counterclockwise from the eyepoint 300 shown in FIG. 15B, light leaking from the light-emission element 207 is observed. When the two-dimensional light-emission element array 101 is observed through the slit 102 at an eyepoint 358 located by 12 degrees counterclockwise from the eyepoint 300 shown in FIG. 15B, light leaking from the light-emission element 208 is observed.

When the two-dimensional light-emission element array 101 is observed through the slit 102 at an eyepoint 357 located by 18 degrees counterclockwise from the eyepoint 300 shown in FIG. 15B, light leaking from the light-emission element 209 is observed. When the two-dimensional light-emission element array 101 is observed through the slit 102 at an eyepoint 356 located by 24 degrees counterclockwise from the eyepoint 300 shown in FIG. 15B, light leaking from the light-emission element 210 is observed.

When the two-dimensional light-emission element array 101 is observed through the slit 102 at an eyepoint 355 located by 30 degrees counterclockwise from the eyepoint 300 shown in FIG. 15B, light leaking from the light-emission element 211 is observed. When the two-dimensional light-emission element array 101 is observed through the slit 102 from an eyepoint 354 located by 36 degrees counterclockwise from the eyepoint 300 shown in FIG. 15B, light leaking from the light-emission element 212 is observed.

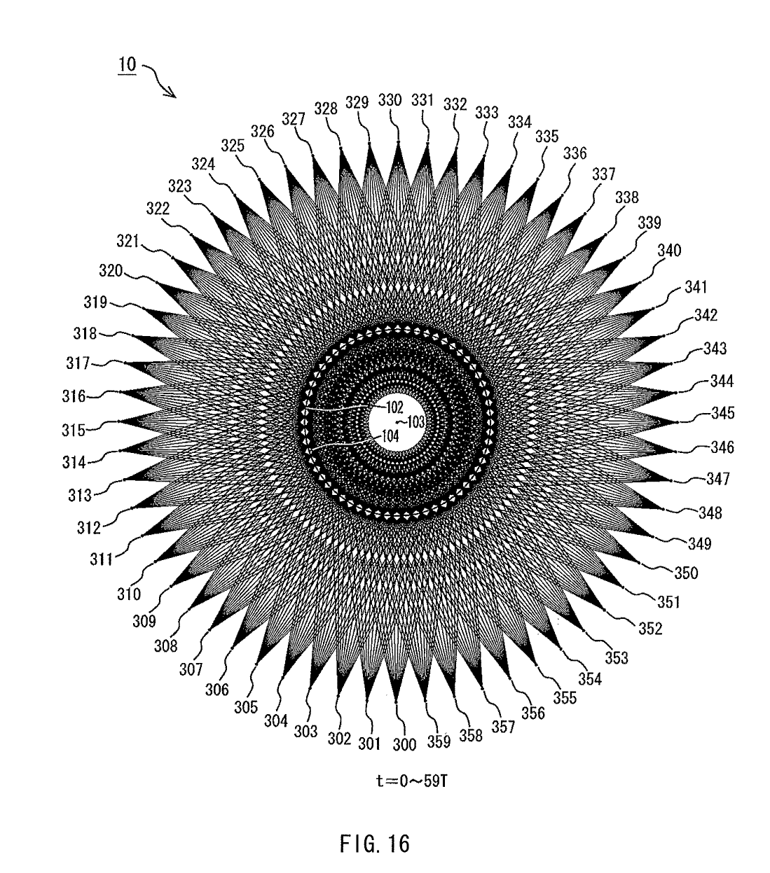

Similarly, for time t=6T to 11T, light leaking from the light-emission elements 201 to 212 are observed while being shifted by one element. During this, the rotation section 104 rotates from 30 degrees to 60 degrees. Therefore, when the rotation section 104 rotates around the entire circumference (one round), namely, rotates 360 degrees, light emission of the 12 light-emission elements 201 to 212 are observed in time t=0 to 59T. In this way, the two-dimensional light-emission element array 101 is observed through the slit 102 from a different eyepoint located clockwise or counterclockwise with an angle of 6 degrees from the eyepoint 300 as a reference. As a result, light leaking from the 12 light-emission elements 201 to 212 are observed while being shifted by one element (see FIG. 16).

FIG. 16 is a diagram showing all trajectory examples of the light emitting points produced by the two-dimensional light-emission element array 101. According to the trajectory examples of the light emitting points produced by the two-dimensional light-emission element array 101 as shown in FIG. 16, a trajectory of light emitting points in time t=0 to 59T is observed to be a plane at all (60) eyepoints 300 to 359. In the example, 60 observation eyepoints are provided (arrangement pitch of six degrees). According to the above structure of the light-emission unit U1, a reproduction image observed from each of the 60 eyepoints 300 to 359 is a planar image, and therefore conversion processing of photographing data into emission light data in certain order is reduced, which is extremely advantageous for generating image data for integral imaging.

Generation Example of Image Data for Stereoscopic Image Display

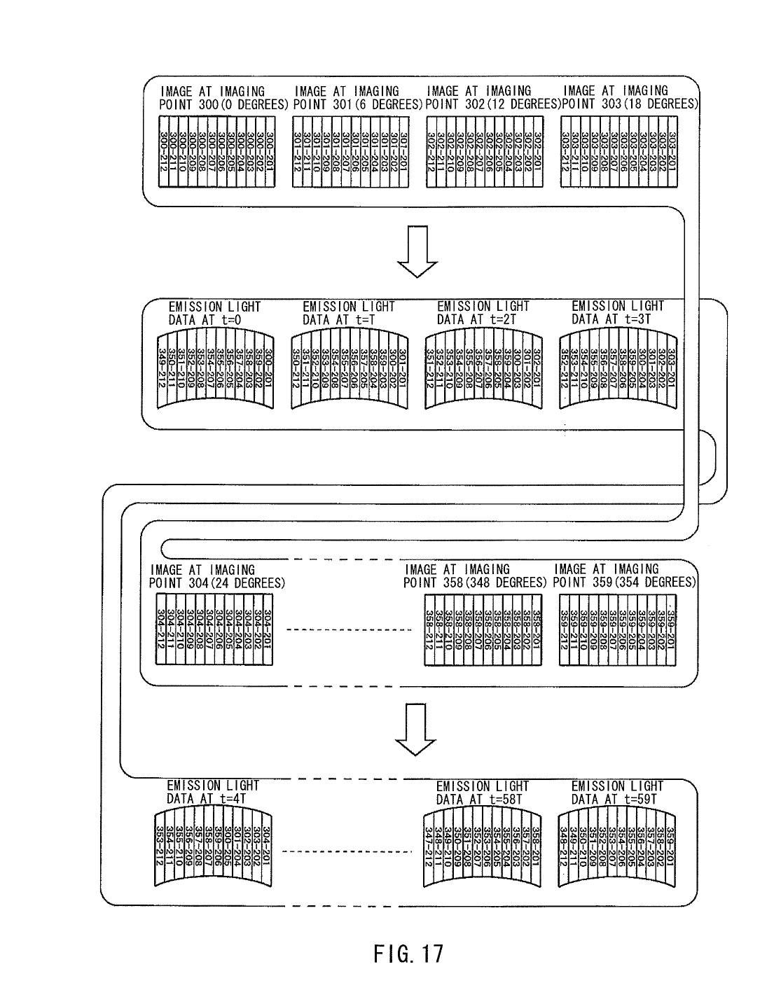

Next, description is made on a generation example of image data for stereoscopic image display applicable to the omnidirectional stereoscopic image display device 10. FIG. 17 is a data format showing a conversion example of photographing data to emission light data.

In the example, an object, which is desired to be displayed by the omnidirectional stereoscopic image display device 10 shown in FIG. 16, is photographed from the entire circumference. For example, the object is disposed at a photographing center, and 60 photographing points (corresponding to the eyepoints 300 to 359) are set every six degrees over the entire circumference with an arrangement center portion of the object as a rotational center.

Next, a camera is actually used to photograph an image of an object from each of the eyepoints 300 to 359 to an object photographing center position (corresponding to the axis of rotation 103). According to such photographing, photographing data over the entire circumference necessary for integral imaging of the object may be collected.

Then, as shown in FIG. 17, arrangement operation processing is performed in line data in a slit direction (vertical direction) such that the collected photographing data are converted into emission light data every light emitting timing of the 12 rows of light-emission elements 210 to 212 of the two-dimensional light-emission element array 101.

An image photographed at a photographing point 300 (0 degrees) is shown as follows. An image at the photographing point 300 corresponds to photographing data (300-201, 300-202, 300-203, 300-204, 300-205, 300-206, 300-207, 300-208, 300-209, 300-210, 300-211 and 300-212).

An image photographed at a photographing point 301 (6 degrees) is shown as follows. An image at the photographing point 301 corresponds to photographing data (301-201, 301-202, 301-203, 301-204, 301-205, 301-206, 301-207, 301-208, 301-209, 301-210, 301-211 and 301-212).

An image photographed at a photographing point 302 (12 degrees) is shown as follows. An image at the photographing point 302 corresponds to photographing data (302-201, 302-202, 302-203, 302-204, 302-205, 302-206, 302-207, 302-208, 302-209, 302-210, 302-211 and 302-212).

An image photographed at a photographing point 303 (18 degrees) is shown as follows. An image at the photographing point 303 corresponds to photographing data (303-201, 303-202, 303-203, 303-204, 303-205, 303-206, 303-207, 303-208, 303-209, 303-210, 303-211 and 303-212).

An image photographed at a photographing point 304 (24 degrees) is shown as follows. An image at the photographing point 304 corresponds to photographing data (304-201, 304-202, 304-203, 304-204, 304-205, 304-206, 304-207, 304-208, 304-209, 304-210, 304-211 and 304-212). Similarly, an image photographed at a photographing point 358 (348 degrees) is shown as follows. An image at the photographing point 358 corresponds to photographing data (358-201, 358-202, 358-203, 358-204, 358-205, 358-206, 358-207, 358-208, 358-209, 358-210, 358-211 and 358-212).

An image photographed at a photographing point 359 (354 degrees) is shown as follows. An image at the photographing point 359 corresponds to photographing data (359-201, 359-202, 359-203, 359-204, 359-205, 359-206, 359-207, 359-208, 359-209, 359-210, 359-211 and 359-212).

The obtained photographing data are converted into emission light data in time t=0 to time t=59T by performing the following arrangement operation. First, photographing data (300-201) of an object image (0 degrees) are arranged for emission light data of the light-emission element 201 at time t=0. Photographing data (359-202) of an object image (354 degrees) are arranged for emission light data of the light-emission element 202 at time t=0. Photographing data (358-203) of an object image (348 degrees) are arranged for emission light data of the light-emission element 203 at time t=0.

Photographing data (357-204) of an object image (342 degrees) are arranged for emission light data of the light-emission element 204 at time t=0. Photographing data (356-205) of an object image (336 degrees) are arranged for emission light data of the light-emission element 205 at time t=0. Photographing data (355-206) of an object image (330 degrees) are arranged for emission light data of the light-emission element 206 at time t=0.

Photographing data (354-207) of an object image (324 degrees) are arranged for emission light data of the light-emission element 207 at time t=0. Photographing data (353-208) of an object image (318 degrees) are arranged for emission light data of the light-emission element 208 at time t=0. Photographing data (352-209) of an object image (312 degrees) are arranged for emission light data of the light-emission element 209 at time t=0.

Photographing data (351-210) of an object image (306 degrees) are arranged for emission light data of the light-emission element 210 at time t=0. Photographing data (350-211) of an object image (300 degrees) are arranged for emission light data of the light-emission element 211 at time t=0. Photographing data (349-212) of an object image (294 degrees) are arranged for emission light data of the light-emission element 212 at time t=0.

According to such arrangement operation, emission light data of the light-emission elements 201 to 212 at time t=0 may be generated. The generated data correspond to emission light data (300-201, 359-202, 358-203, 357-204, 356-205, 355-206, 354-207, 353-208, 352-209, 351-210, 350-211 and 349-212).

Next, photographing data (301-201) of an object image (6 degrees) are arranged for emission light data of the light-emission element 201 at time t=T. Photographing data (300-202) of an object image (0 degrees) are arranged for emission light data of the light-emission element 202 at time t=T. Photographing data (359-203) of an object image (354 degrees) are arranged for emission light data of the light-emission element 203 at time t=T. Photographing data (358-204) of an object image (348 degrees) are arranged for emission light data of the light-emission element 204 at time t=T.

Photographing data (357-205) of an object image (342 degrees) are arranged for emission light data of the light-emission element 205 at time t=T. Photographing data (356-206) of an object image (336 degrees) are arranged for emission light data of the light-emission element 206 at time t=T. Photographing data (355-207) of an object image (330 degrees) are arranged for emission light data of the light-emission element 207 at time t=T. Photographing data (354-208) of an object image (324 degrees) are arranged for emission light data of the light-emission element 208 at time t=T.

Photographing data (353-209) of an object image (318 degrees) are arranged for emission light data of the light-emission element 209 at time t=T. Photographing data (352-210) of an object image (312 degrees) are arranged for emission light data of the light-emission element 210 at time t=T. Photographing data (351-211) of an object image (306 degrees) are arranged for emission light data of the light-emission element 211 at time t=T. Photographing data (350-212) of an object image (300 degrees) are arranged for emission light data of the light-emission element 212 at time t=T.

According to such arrangement operation, emission light data of the light-emission elements 201 to 212 at time t=T may be generated. The generated data correspond to emission light data (301-201, 300-202, 359-203, 358-204, 357-205, 356-206, 355-207, 354-208, 353-209, 352-210, 351-211 and 350-212).

Next, photographing data (302-201) of an object image (12 degrees) are arranged for emission light data of the light-emission element 201 at time t=2T. Photographing data (301-202) of an object image (6 degrees) are arranged for emission light data of the light-emission element 202 at time t=2T. Photographing data (300-203) of an object image (0 degrees) are arranged for emission light data of the light-emission element 203 at time t=2T. Photographing data (359-204) of an object image (354 degrees) are arranged for emission light data of the light-emission element 204 at time t=2T.

Photographing data (358-205) of an object image (348 degrees) are arranged for emission light data of the light-emission element 205 at time t=2T. Photographing data (357-206) of an object image (342 degrees) are arranged for emission light data of the light-emission element 206 at time t=2T. Photographing data (356-207) of an object image (336 degrees) are arranged for emission light data of the light-emission element 207 at time t=2T. Photographing data (355-208) of an object image (330 degrees) are arranged for emission light data of the light-emission element 208 at time t=2T.

Photographing data (354-209) of an object image (324 degrees) are arranged for emission light data of the light-emission element 209 at time t=2T. Photographing data (353-210) of an object image (318 degrees) are arranged for emission light data of the light-emission element 210 at time t=2T. Photographing data (352-211) of an object image (312 degrees) are arranged for emission light data of the light-emission element 211 at time t=2T. Photographing data (351-212) of an object image (306 degrees) are arranged for emission light data of the light-emission element 212 at time t=2T.

According to such arrangement operation, emission light data of the light-emission elements 201 to 212 at time t=2T may be generated. The generated data correspond to emission light data (302-201, 301-202, 300-203, 359-204, 358-205, 357-206, 356-207, 355-208, 354-209, 353-210, 352-211 and 351-212).

Next, photographing data (303-201) of an object image (18 degrees) are arranged for emission light data of the light-emission element 201 at time t=3T. Photographing data (302-202) of an object image (12 degrees) are arranged for emission light data of the light-emission element 202 at time t=3T. Photographing data (301-203) of an object image (6 degrees) are arranged for emission light data of the light-emission element 203 at time t=3T. Photographing data (300-204) of an object image (0 degrees) are arranged for emission light data of the light-emission element 204 at time t=3T.

Photographing data (359-205) of an object image (354 degrees) are arranged for emission light data of the light-emission element 205 at time t=3T. Photographing data (358-206) of an object image (348 degrees) are arranged for emission light data of the light-emission element 206 at time t=3T. Photographing data (357-207) of an object image (342 degrees) are arranged for emission light data of the light-emission element 207 at time t=3T.

Photographing data (356-208) of an object image (336 degrees) are arranged for emission light data of the light-emission element 208 at time t=3T. Photographing data (355-209) of an object image (330 degrees) are arranged for emission light data of the light-emission element 209 at time t=3T. Photographing data (354-210) of an object image (324 degrees) are arranged for emission light data of the light-emission element 210 at time t=3T.

Photographing data (353-211) of an object image (318 degrees) are arranged for emission light data of the light-emission element 211 at time t=3T. Photographing data (352-212) of the object image (312 degrees) are arranged for emission light data of the light-emission element 212 at time t=3T.

According to such arrangement operation, emission light data of the light-emission elements 201 to 212 at time t=3T may be generated. The generated data correspond to emission light data (303-201, 302-202, 301-203, 300-204, 359-205, 358-206, 357-207, 356-208, 355-209, 354-210, 353-211 and 352-212).

Next, photographing data (304-201) of an object image (24 degrees) are arranged for emission light data of the light-emission element 201 at time t=4T. Photographing data (303-202) of an object image (18 degrees) are arranged for emission light data of the light-emission element 202 at time t=4T. Photographing data (302-203) of an object image (12 degrees) are arranged for emission light data of the light-emission element 203 at time t=4T. Photographing data (301-204) of an object image (6 degrees) are arranged for emission light data of the light-emission element 204 at time t=4T.

Photographing data (300-205) of an object image (0 degrees) are arranged for emission light data of the light-emission element 205 at time t=4T. Photographing data (359-206) of an object image (354 degrees) are arranged for emission light data of the light-emission element 206 at time t=4T. Photographing data (358-207) of an object image (348 degrees) are arranged for emission light data of the light-emission element 207 at time t=4T. Photographing data (357-208) of an object image (342 degrees) are arranged for emission light data of the light-emission element 208 at time t=4T.

Photographing data (356-209) of an object image (336 degrees) are arranged for emission light data of the light-emission element 209 at time t=4T. Photographing data (355-210) of an object image (330 degrees) are arranged for emission light data of the light-emission element 210 at time t=4T. Photographing data (354-211) of an object image (324 degrees) are arranged for emission light data of the light-emission element 211 at time t=4T. Photographing data (353-212) of an object image (318 degrees) are arranged for emission light data of the light-emission element 212 at time t=4T.

According to such arrangement operation, emission light data of the light-emission elements 201 to 212 at time t=4T may be generated. The generated data correspond to emission light data (304-201, 303-202, 302-203, 301-204, 300-205, 359-206, 358-207, 357-208, 356-209, 355-210, 354-211 and 353-212).

Similarly, photographing data (358-201) of an object image (348 degrees) are arranged for emission light data of the light-emission element 201 at time t=58T. Photographing data (357-202) of an object image (342 degrees) are arranged for emission light data of the light-emission element 202 at time t=58T. Photographing data (356-203) of an object image (336 degrees) are arranged for emission light data of the light-emission element 203 at time t=58T. Photographing data (355-204) of an object image (330 degrees) are arranged for emission light data of the light-emission element 204 at time t=58T.

Photographing data (354-205) of an object image (324 degrees) are arranged for emission light data of the light-emission element 205 at time t=58T. Photographing data (353-206) of an object image (318 degrees) are arranged for emission light data of the light-emission element 206 at time t=58T. Photographing data (352-207) of an object image (312 degrees) are arranged for emission light data of the light-emission element 207 at time t=58T. Photographing data (351-208) of an object image (306 degrees) are arranged for emission light data of the light-emission element 208 at time t=58T.

Photographing data (350-209) of an object image (300 degrees) are arranged for emission light data of the light-emission element 209 at time t=58T. Photographing data (349-210) of an object image (294 degrees) are arranged for emission light data of the light-emission element 210 at time t=58T. Photographing data (348-211) of an object image (288 degrees) are arranged for emission light data of the light-emission element 211 at time t=58T. Photographing data (347-212) of an object image (282 degrees) are arranged for emission light data of the light-emission element 212 at time t=58T.

According to such arrangement operation, emission light data of the light-emission elements 201 to 212 at time t=58T may be generated. The generated data correspond to emission light data (358-201, 357-202, 356-203, 355-204, 354-205, 353-206, 352-207, 351-208, 350-209, 349-210, 348-211 and 347-212).

Photographing data (359-201) of an object image (354 degrees) are arranged for emission light data of the light-emission element 201 at time t=59T. Photographing data (358-202) of an object image (348 degrees) are arranged for emission light data of the light-emission element 202 at time t=59T. Photographing data (357-203) of an object image (342 degrees) are arranged for emission light data of the light-emission element 203 at time t=59T. Photographing data (356-204) of an object image (336 degrees) are arranged for emission light data of the light-emission element 204 at time t=59T.

Photographing data (355-205) of an object image (330 degrees) are arranged for emission light data of the light-emission element 205 at time t=59T. Photographing data (354-206) of an object image (324 degrees) are arranged for emission light data of the light-emission element 206 at time t=59T. Photographing data (353-207) of an object image (318 degrees) are arranged for emission light data of the light-emission element 207 at time t=59T. Photographing data (352-208) of an object image (312 degrees) are arranged for emission light data of the light-emission element 208 at time t=59T.

Photographing data (351-209) of an object image (306 degrees) are arranged for emission light data of the light-emission element 209 at time t=59T. Photographing data (350-210) of an object image (300 degrees) are arranged for emission light data of the light-emission element 210 at time t=59T. Photographing data (349-211) of an object image (294 degrees) are arranged for emission light data of the light-emission element 211 at time t=59T. Photographing data (348-212) of an object image (288 degrees) are arranged for emission light data of the light-emission element 212 at time t=59T.

According to such arrangement operation, emission light data (359-201, 358-202, 357-203, 356-204, 355-205, 354-206, 353-207, 352-208, 351-209, 350-210, 349-211 and 348-212) of the light-emission elements 201 to 212 at time t=59T may be generated.

Only by such arrangement operation processing, emission light data (hereinafter, sometimes called picture data Din) for stereoscopic image display, which may be used for the omnidirectional stereoscopic image display device 10, may be easily generated. In addition, the light emission unit U1 is made to have an inner structure in consideration of generation of the picture data Din, thereby the picture data Din for stereoscopic image display may be generated in a short time by a small signal processing circuit.

While a method of photographing a real object with a camera has been described in the above example, this is not limitative, and the picture data Din for stereoscopic image display may be generated by computer graphics. Even in display of a virtual object by computer graphics, images are produced by rendering in directions from the 60 eyepoints 300 to 359 to the axis of rotation 103, and similar processing is performed to the images, thereby the picture data Din may be easily generated.

Here, rendering means imaging by calculation of data on an object or a figure given as numerical data. In rendering of 3D-Graphics, hidden surface removal or shading is performed for producing images in consideration of visual-point positions, the number, positions and types of light sources, a shape of the object, coordinates of an apex of the object, and material of the object. A rendering method includes a ray tracing method and a radiosity method.

Configuration Example of Control System

Next, a configuration example of a control system of the omnidirectional stereoscopic image display device 10 is described. FIG. 18 is a block diagram showing a configuration example of the control system of the omnidirectional stereoscopic image display device 10. The stereoscopic image display device viewable from the entire circumference in this example has a structure where beams are outputted even to a number of regions where no viewer exists, and therefore useless is concernedly increased in power efficiency. Thus, improvement in power efficiency and reduction in amount of information are achieved by viewer detection.

The omnidirectional stereoscopic image display device 10 shown in FIG. 18 is connected with a picture source sender 90, and thus receives serial picture data Din for stereoscopic image display. A control system of the omnidirectional stereoscopic image display device 10 is divided into a system in the rotation section 104 and a system in the setting base 105, and the two control systems are electrically connected to each other via the slip ring 51.

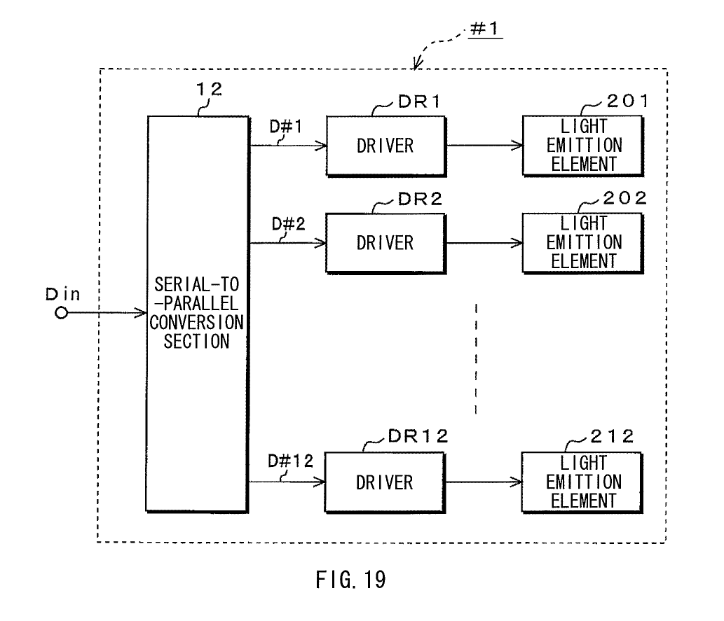

The control system in the rotation section 104 has a connection board 11. The connection board 11 is connected with k pieces of one-dimensional light-emission element boards #k (k=1 to n) configuring n lines and with one viewer detection sensor 81. The one-dimensional light-emission element boards #1 to #n allow light-emission elements in m rows to emit light in order based on serial n-line picture data Din for stereoscopic image display (see FIG. 19).

A display controller 15 is mounted on the connection board 11. The display controller 15 receives picture data Din for a stereoscopic image for each pixel, and controls emission intensity of the light-emission elements for each pixel based on the picture data Din. Serial picture data Din, which is adjusted in emission intensity for each pixel, are transmitted to the IC35 for serial-to-parallel conversion and for a driver on the one-dimensional light-emission element board #1 shown in FIG. 5. According to such control, emission intensity of the two-dimensional light-emission element array 101 may be controlled for each pixel.

In the example, since the omnidirectional stereoscopic image display device 10 is a display device of an integral imaging method, a mass of picture data Din are transmitted to the IC35 on the one-dimensional light-emission element board #1 for display over the entire circumference. However, transmission of picture data Din being not viewed is useless in the light of transmission band or image formation. Thus, beams are outputted to only a region where a viewer exists.

A viewer detection sensor 81 is connected to the connection board 11, which detects a viewer (for example, pupil of the viewer) viewing a relevant stereoscopic image outside the rotation section 104 rotated by the motor 52 shown in FIG. 1, and thus generates a viewer detection signal S81. The viewer detection signal S81 is outputted to the display controller 15 and used for determination of presence of a viewer.

The display controller 15 receives a viewer detection signal S81 from the viewer detection sensor 81 and acquires an observer detection value, and compares the observer detection value with a predetermined observer distinction value, and controls emission intensity of a light-emission element depending on a result of such comparison. Specifically, the display controller allows the two-dimensional light-emission element array 101 to operate in a section where an observer detection value equal to or larger than the observer distinction value is detected. The display controller 15 controls emission intensity of each of the one-dimensional light-emission element boards #1 to #n such that the two-dimensional light-emission element array 101 is stopped to operate in a section where an observer detection value smaller than the observer distinction value is detected.

In this way, a structure, where beams are outputted only to a region where a viewer exists, is used, so that presence of an observer is detected by the viewer detection sensor 81, and emission intensity of each of the one-dimensional light-emission element boards #1 to #n may be controlled in a region where the observer exists. Since the one-dimensional light-emission element boards #1 to #n may be stopped to operate in other regions, power consumption may be reduced. Therefore, a stereoscopic image may be displayed with extremely high power efficiency compared with a previous flat display. In addition, since the amount of information to be transmitted may be significantly reduced, a transmission circuit or an image formation circuit is reduced in size, leading to reduction in cost.

On the other hand, a drive control system within the setting base 105, and the system includes a controller 55, an I/F board 56, a power supply unit 57 and an encoder 58. The I/F board 56 is connected to the external picture source sender 90 via a high-speed bidirectional serial interface (I/F). The picture source sender 90 outputs serial picture data Din for stereoscopic image display based on a high-speed bidirectional serial interface I/F standard to the connection board 11 via the I/F board 56 and the slip ring 51.

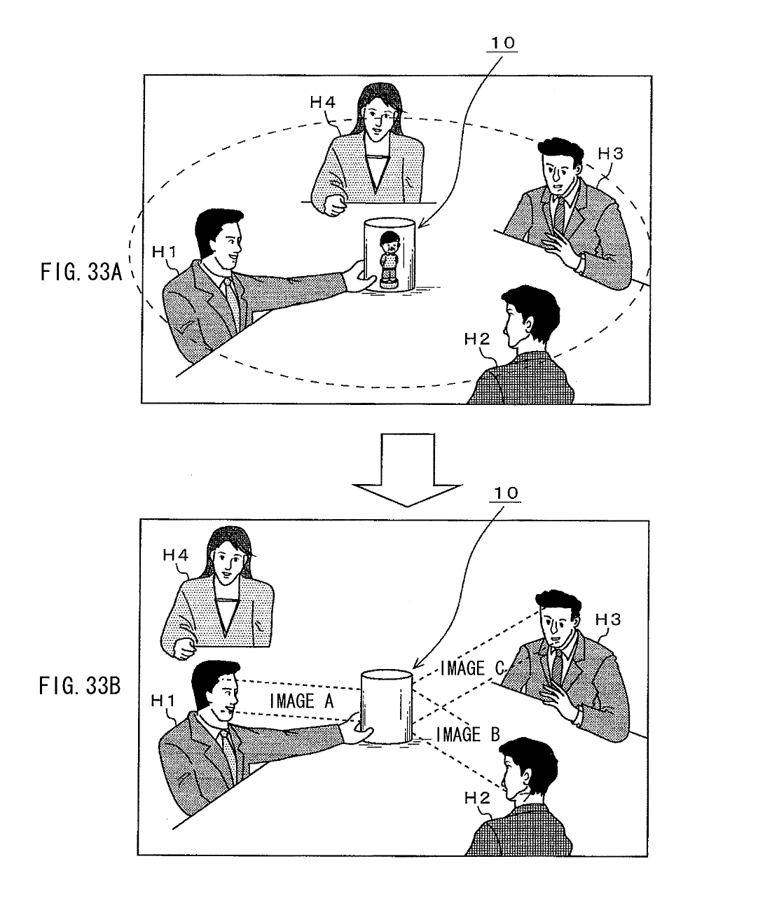

For example, the omnidirectional stereoscopic image display device 10 sequentially transmits information of a region of a viewer, detected by the viewer detection sensor 81, to the picture source sender 90. The picture source sender 90 sends only a picture corresponding to the detected region to the omnidirectional stereoscopic image display device 10. In the example, when a plurality of viewers view a stereoscopic picture around the omnidirectional stereoscopic image display device 10, different picture sources may be reproduced for each viewing region. In this case, a picture source, which is reproduced by each viewer itself, may be selected, or a viewer may be specified by facial recognition with a camera so that a beforehand set picture source is reproduced (see FIG. 33B). When this is used for digital signage, different kinds of information may be sent by one omnidirectional stereoscopic image display device 10.

Digital signage refers to various kinds of information display using electronic data, which is suitable for display for customer attraction, advertisement, and sales promotion set as a public display in stores or commercial facilities, and in traffic facilities. For example, when a display region of one round (360 degrees) around the omnidirectional stereoscopic image display device 10 is divided into three 120-degree regions for three viewing regions, and different picture data are reproduced for each of the divided display regions, different kinds of display information may be viewed between the three viewing regions.

For example, when a stereoscopic image on a front side of a first character is displayed in a display region (0 to 120 degrees) in the front of the omnidirectional stereoscopic image display device 10, a viewer located in the front may view the stereoscopic image on the front side of the first character. Similarly, when a stereoscopic image on a front side of a second character is displayed in a display region (121 to 240 degrees) on a right side of the display device 10, a viewer located on the right side may view the stereoscopic image on the front side of the second character. Similarly, when a stereoscopic image on a front side of a third character is displayed in a display region (241 to 360 degrees) on a left side of the display device 10, a viewer located on the left side may view the stereoscopic image on the front side of the third character. According to this, a plurality of display data different from one another may be sent by one omnidirectional stereoscopic image display device 10.

A controller 55 is connected to the I/F board 56. The picture source sender 90 outputs a synchronizing signal Ss to the controller 55 via the I/F board 56. A motor 52, an encoder 58 and a switcher 60 are connected to the controller 55. The encoder 58 (rotation detection section) is attached to the motor 52, and detects rotation speed of the motor 52 and outputs a speed detection signal S58 indicating rotation speed of the rotation section 104 to the controller 55. When power is turned on, the switcher 60 outputs a switch signal S60 to the controller 55. The switch signal S60 indicates power-off or power-on information. The switcher 60 is operated to be on or off by a user.

The controller 55 controls the motor 52 to be rotated at a predetermined rotation (modulation) speed based on the synchronizing signal Ss and the speed detection signal S58. The power supply unit 57 is connected to the slip ring 51, the controller 55 and the I/F board 56, and thus supplies power for driving each board or the like to the connection board 11, the controller 55 and the I/F board 56.

In the example, when error amount of a servo control system for rotation control of the rotation section 104 exceeds a certain value and thus unevenness occurs in rotation, the controller 55 controls the rotation section 104 to stop rotation immediately. The encoder 58 detects rotation of the rotation section 104 rotated by the motor 52.

The controller 55 compares a rotation detection value obtained by the encoder 58 with a predetermined rotation reference value, and controls the motor 52 depending on a result of the comparison. Specifically, when a rotation detection value equal to or larger than the rotation reference value is detected, the controller 55 controls the motor 52 to stop rotation of the rotation section 104. In this way, according to the omnidirectional stereoscopic image display device 10, if error amount of the servo control system for rotation control of the rotation section 104 exceeds a certain value, rotation may be stopped immediately. Therefore, runaway rotation of the rotation section 104 may be prevented and consequently security may be ensured. Consequently, breakage of the omnidirectional stereoscopic image display device 10 may be prevented.

FIG. 19 is a block diagram showing a configuration example of a single one-dimensional light-emission element board #1 or the like. The one-dimensional light-emission element board #1 or the like shown in FIG. 19 includes one serial-to-parallel conversion section 12, m drivers DRj (j=1 to m) and m light-emission elements 20j (j=1 to m). In this example, a case of m=12 (12 rows) is described. The serial-to-parallel conversion section 12 is connected to the connection board 11, and converts serial picture data Din for stereoscopic image display of a first line into parallel picture data D #j (j=1 to m) for stereoscopic image display for first to twelfth rows.

The serial-to-parallel conversion section 12 is connected with 12 drivers DR1 to DR12 (drive circuits). The driver DR1 is connected with a light-emission element 201 in a first row. The light-emission element 201 emits light based on picture data D #1 for the first row for stereoscopic image display. The driver DR2 is connected with a light-emission element 202 in a second row. The light-emission element 202 emits light based on picture data D #2 for the second row for stereoscopic image display.

Similarly, the drivers DR3 to DR12 are connected with light-emission elements 203 to 212 in third to twelfth rows, respectively. The light-emission elements 203 to 212 emit light based on picture data D #3 to D #12 for third to twelfth rows for stereoscopic image display, respectively. Consequently, 12 light-emission elements 201 to 212 emit light in order based on the serial picture data Din for the stereoscopic image display for the first line. In the example, the one serial-to-parallel conversion section 12 and the m drivers DRj configure the IC35 for serial-to-parallel conversion and for a driver as shown in FIG. 5. Other one-dimensional light-emission element boards #2 to #n have the same configuration and function as those of the one-dimensional light-emission element board #1, and description of them is omitted.

Stereoscopic Image Display Example

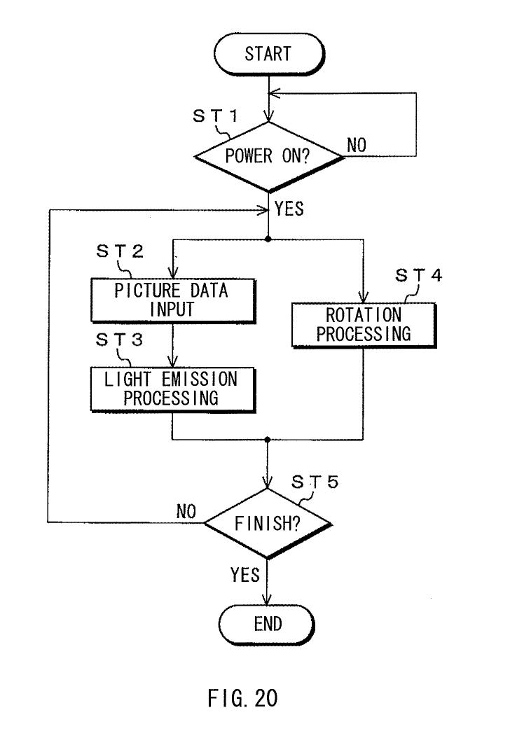

Next, for a stereoscopic image display method according to the invention, an operation example of the omnidirectional stereoscopic image display device 10 is described. FIG. 20 is an operation flowchart showing a stereoscopic image display example of the omnidirectional stereoscopic image display device 10. In the omnidirectional stereoscopic image display device 10, the rotation section 104 has a certain diameter and a certain length, and has the slit 102 in a direction of a circumferential surface parallel to the axis of rotation 103, as shown in FIG. 1. In the example, it is assumed that the two-dimensional light-emission element array 101 is mounted in the rotation section 104, and the rotation section 104 is rotated to display a stereoscopic image.

In this case, picture data Din to be used for stereoscopic image are obtained, for example, by photographing an optional object at N points with even intervals over the entire circumference by a single imaging system having m (rows) by n (columns) of imaging elements. The two-dimensional picture data Din for N (points) by m (rows) obtained by such imaging are inputted. In addition, a stereoscopic image over the entire circumference of the object is reproduced by one light-emission unit U1 including the two-dimensional light-emission element array 101 and the slit 102. When observation is made in a direction toward the axis of rotation 103 from any one visual-point position corresponding to one of the N imaging points, the display controller 15 performs emission control of a plurality of light-emission elements such that a trajectory of light emitting points of a plurality of light-emission elements forms, for example, a planar image within the rotation section 104 based on the two-dimensional picture data Din.

At the above operation condition, in the omnidirectional stereoscopic image display device 10, first, the controller 55 detects whether power is on in step ST1. When a user views a stereoscopic image, the user turns on the switcher 60. When power is turned on, the switcher 60 outputs a switch signal S60 indicating power-on information to the controller 55. When the controller 55 detects the power-on information from the switch signal S60, the controller 55 performs stereoscopic image display processing.

Next, in step ST2, the connection board 11 receives picture data Din for a stereoscopic image to be supplied to the two-dimensional light-emission element array 101 attached to the rotation section 104. The picture data Din are arranged in order in which the 12 (m=12) rows of light-emission elements 201 to 212 sequentially reproduce data at 60 (N=60) imaging positions, and correspondingly arranged in order in which the 60 imaging positions are continued, as shown in FIG. 16. The picture source sender 90 extracts corresponding picture data Din for stereoscopic image display from the 60 (points) by 12 (rows) of two-dimensional picture data Din.

The picture source sender 90 performs arrangement operation processing to rearrange data arrangement in line data in a slit direction (longitudinal direction) shown in FIG. 17. The picture source sender 90 converts collected photographing data into emission light data every light emitting timing of the 12 rows of light-emission elements 201 to 212 of the two-dimensional light-emission element array 101. Emission light data to be reproduced in time t=0 to t=59T, obtained in this way, correspond to picture data Din for a stereoscopic image. The picture data Din are supplied from the picture source sender 90 into the setting base 105. In the setting base 105, the picture data Din are transmitted together with power via the slip ling 51 to the two-dimensional light-emission element array 101 in the rotation section 104.

Next, the light-emission elements 201 to 212 emit light based on the picture data Din in step ST3. In the example, since the two-dimensional light-emission element array 101 has an arched light-emitting surface, light emitted from the light-emission surface is condensed in a direction of the slit 102 (see FIG. 16). Light outputted from the light-emission elements 201 to 212 are condensed near the slit 102 of the rotation section 104.

Concurrently, the rotation section 104 attached with the two-dimensional light-emission element array 101 is rotated at a certain speed in step ST4. The motor 52 in the setting base 105 rotates the turntable 42 at a certain rotation (modulation) speed. The turntable 42 is rotated and thus the rotation section 104 is rotated.

The encoder 58 attached to the motor 52 detects rotation speed of the motor 52, and outputs a speed detection signal S58 indicating rotation speed of the rotation section 104 to the controller 55. The controller 55 controls the motor 52 based on the speed detection signal S58 so that the motor 52 rotates at a certain rotation (modulation) speed. Consequently, the rotation section 104 may be rotated at a certain modulation speed. For the omnidirectional stereoscopic image display device 10, light of a stereoscopic image imaged with the axis of rotation 103 of the rotation section 104 as a reference leaks to the outside from the inside of the rotation section 104 through the slit 102. The light leaked to the outside provides a stereoscopic image to each of eyepoints.

In step ST5, the controller 55 determines whether the stereoscopic image display processing is finished. For example, the controller 55 detects power-off information based on the switch signal S60 from the switcher 60 and thus finishes the stereoscopic image display processing. When the power-off information from the switcher 60 is not detected, the process returns to the steps ST2 and ST4 and the stereoscopic image display processing is continued.

In this way, according to the omnidirectional stereoscopic image display device 10 as the first embodiment, light outputted from the light-emission elements 201 to 212 are condensed near the slit 102 of the rotation section 104. The light are condensed in this way, thereby light of a stereoscopic image to be imaged with the axis of rotation 103 of the rotation section 104 as a reference leaks to the outside from the inside of the rotation section 104 through the slit 102.

Therefore, since the light-emission surface of the two-dimensional light-emission element array 101 may be rotationally scanned with an eyepoint of an observer as a reference, the stereoscopic image imaged with the axis of rotation as a reference may be viewed outside the rotation section 104. Consequently, an omnidirectional stereoscopic image display device 10 may be easily achieved, which has a simple structure compared with a previous type of stereoscopic image display mechanism and is high in power efficiency. In addition, since various 3D polygons, which have not been able to be displayed by previous flat displays, may be displayed, stereoscopic character trademark services may be provided.

While the embodiment has been described with a case where picture data Din are transmitted along with power via the slip ring 51 to the two-dimensional light-emission element array 101, this is not limitative. The picture data Din may be transmitted along with power from the setting base 105 to the rotation section 104 by using a radio communication system.

For example, a power receiving coil and a radio receiver for an image signal are provided in the rotation section 104. A power transmission coil and a radio transmitter for an image signal are provided in the setting base 105. A receiver and a transmitter, having an antenna each, are used as the radio receiver and the radio transmitter, respectively. The power receiving coil is connected with a power supply line, and the power supply line is connected to the two-dimensional light-emission element array 101. The radio receiver is connected with a signal line, and the signal line is connected to the two-dimensional light-emission element array 101.

In the setting base 105, the power transmission coil is disposed at a position where the coil is interlinked with the power receiving coil in the rotation section 104. A power supply cable is connected to the power transmission coil to supply power from the outside. Similarly, the radio transmitter is disposed at a position where the transmitter may communicate with the radio receiver in the rotation section 104. An image signal cable is connected to the radio transmitter to supply picture data Din from the picture source sender 90 or the like.

Consequently, externally supplied power may be introduced by electromagnetic induction and transmitted to the two-dimensional light-emission element array 101. In addition, picture data Din supplied from the picture source sender 90 may be transmitted to the two-dimensional light-emission element array 101 via an electromagnetic wave. In addition, the antenna of the radio receiver may be used even as the power receiving coil, and the antenna of the radio transmitter may be used even as the power transmission coil. In this case, a frequency of voltage (current) for electromagnetic induction may be set as a carrier frequency of the electromagnetic wave. Obviously, a battery or picture data may be incorporated in the rotation section 104. The picture data Din can be written into a storage device so that the data are read into the two-dimensional light-emission element array 101 within the rotation section 104.

In the case of one light-emission unit U1, since a phenomenon that the unit vibrates by itself may occur due to eccentricity, a balancer is preferably provided so that the axis of rotation 103 corresponds to the center of gravity. The balancer has approximately the same weight as that of the two-dimensional light-emission element array 101, and is preferably disposed at a position displaced by 180 degrees from a position of the array. Obviously, the number of balancers is not limited to one, and a balancer may be disposed every 120 degrees. According to such a configuration, the rotation section 104 may be smoothly rotated.

Supposedly, while the omnidirectional stereoscopic image display device 10 is rotated, for example, the balancer may be removed, leading to vibration of the device itself due to eccentricity, or large vibration may be applied from the outside. In such a case, the rotation section 104 rotates while the axis of rotation 103 does not correspond to the center of gravity, which concernedly leads to a situation (breakage) that the rotation section 104 or the two-dimensional light-emission element array 101 may not be kept to a predetermined shape.

Thus, a vibration detection section 59 such as an acceleration sensor or a vibration sensor is attached to the setting base 105, and the controller 55 controls the rotation section 104 such that when the controller detects vibration having a certain value or larger, rotation of the rotation section 104 is stopped immediately.

The omnidirectional stereoscopic image display device 10 shown in FIG. 18 has the controller 55 and the vibration detection section 59. The vibration detection section 59 detects vibration of the rotation section 104 rotated by the motor 52 in the setting base 105, and outputs a vibration detection signal S59. The controller 55 compares a vibration detection value based on the vibration detection signal S59 obtained by the vibration detection section 59 with a certain vibration reference value, and controls the motor 52 depending on a result of the comparison. Specifically, when a vibration detection value equal to or larger than the vibration reference value is detected, the controller 55 controls the motor 52 such that rotation of the rotation section 104 is stopped.

Vibration of the setting base 105 is detected in this way by the vibration detection section 59 such as an acceleration sensor, so that if the amount of vibration exceeds a certain value, rotation may be stopped immediately. Therefore, runaway rotation of the rotation section 104 may be prevented and consequently safety may be ensured. Consequently, breakage of the omnidirectional stereoscopic image display device 10 may be prevented.

### Second Embodiment

### Configuration Example of Omnidirectional Stereoscopic Image Display Device 20

FIGS. 21A and 21B are a section diagram showing a configuration example of an omnidirectional stereoscopic image display device 20 as a second embodiment and an explanatory diagram showing an operation example of the device 20, respectively. The number of light-emission units U1, each unit including a two-dimensional light-emission element array 101 and a slit 102, may be varied depending on various configurations other than the aforementioned configuration. For example, a configuration with two sets of light-emission units U1, each unit using cylindrical, two-dimensional light-emission element array 101, is likely to be used.

The omnidirectional stereoscopic image display device 20 shown in FIG. 21A, which uses an integral imaging method, has two light-emission units U1 and U2 and has a structure where a rotation section 104 rotates in an arrow R direction or in a direction opposite to the arrow direction with an axis of rotation 103 as a rotation center.

In the omnidirectional stereoscopic image display device 20, two slits 102 are provided in an outer casing 41 at equal angles (180 degrees) with the axis of rotation 103 of the rotation section 104 as an origin. The light-emission unit U1 has one slit 102, and the light-emission unit U2 has the other slit 102. A two-dimensional light-emission element array 101 of the light-emission unit U1 is disposed between the outer casing 41 and the axis of rotation 103 such that a light-emission surface of the array faces the one slit 102 of the rotation section 104. A two-dimensional light-emission element array 101 of the light-emission unit U2 is disposed between the outer casing 41 and the axis of rotation 103 such that a light-emission surface of the array faces the other slit 102 of the rotation section 104.

In the omnidirectional stereoscopic image display device 20, a slit 102 parallel to the axis of rotation 103 is provided in the outer casing 41 in front of the light-emission surface of the two-dimensional light-emission element array 101 of the light-emission unit U1. Even in the example, a structure is used, where light emitted from the two-dimensional light-emission element array 101 does not leak from any portion other than the slit. The other light-emission unit U2 is configured in the same way.

Operation Example

According to the two-slit structure, light emitted from the two-dimensional light-emission element array 101 of the light-emission unit U1 shown in FIG. 21B is greatly limited in horizontal emission angle by the slit 102. Similarly, light emitted from the two-dimensional light-emission element array 101 of the light-emission unit U2 is greatly limited in horizontal emission angle by the slit 102. The rotation section 104 having such a two-slit structure is rotationally scanned with respect to an eyepoint, thereby a cylindrical integral imaging surface may be formed. Light of a stereoscopic image imaged with the axis of rotation 103 as a reference leaks from the inside of the rotation section 104 to the outside through the two slits 102.

In this way, according to the omnidirectional stereoscopic image display device 20 as the second embodiment, light from the two two-dimensional light-emission element arrays 101 are emitted in different directions, enabling integral imaging for two vertical lines restricted by the two slits 102. Therefore, a high-resolution stereoscopic image, which is imaged by light emitted from the two two-dimensional light-emission element arrays 101, may be viewed.

### Third Embodiment

### Configuration Example of Omnidirectional Stereoscopic Image Display Device 30

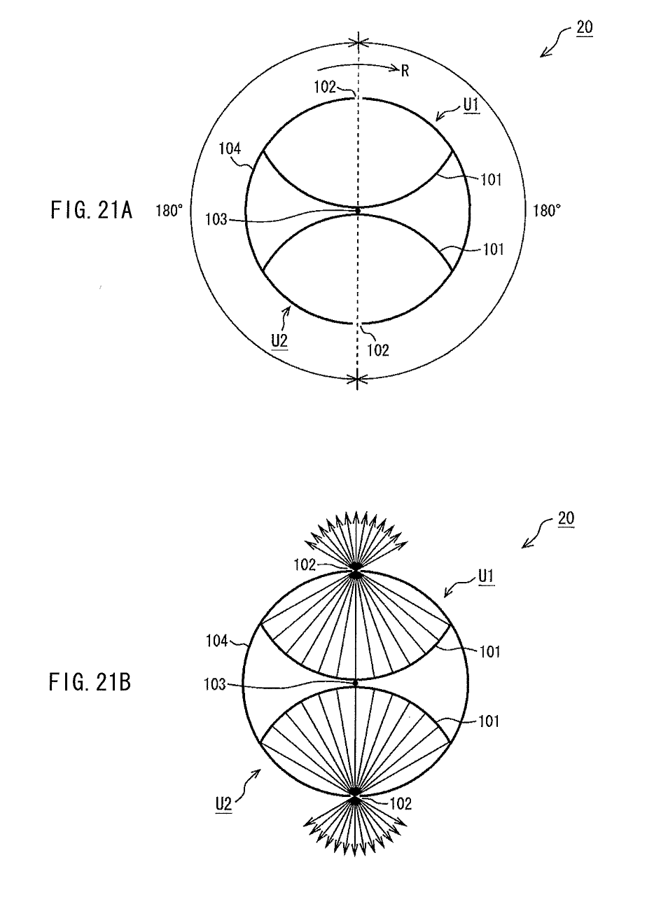

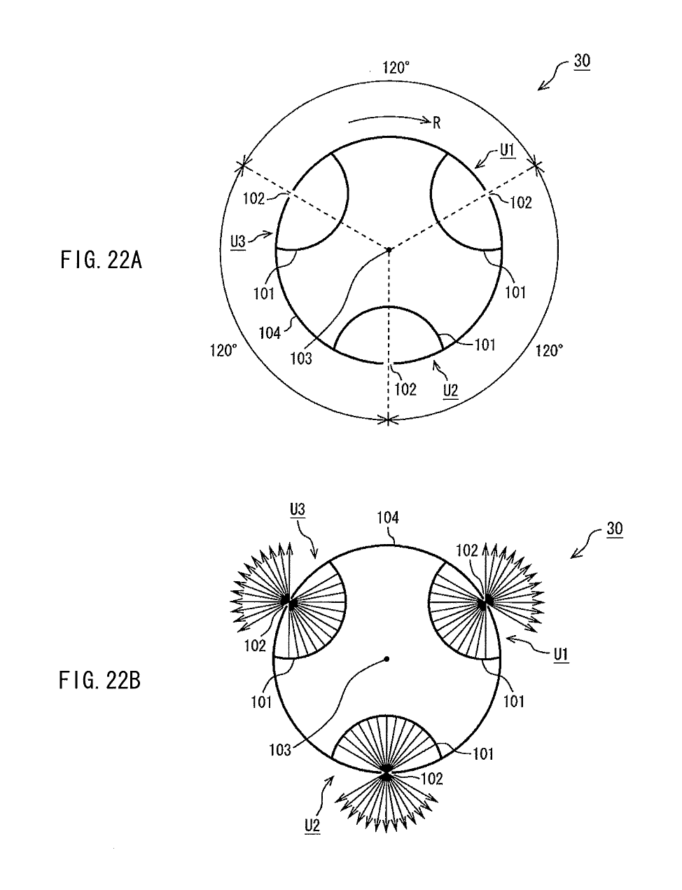

FIGS. 22A and 22B are a section diagram showing a configuration example of an omnidirectional stereoscopic image display device 30 as a third embodiment and an explanatory diagram showing an operation example of the device 30, respectively. In the embodiment, several two-dimensional light-emission element arrays 101, emitting single-color light having different wavelengths, are mounted, and therefore color display may be achieved without complicating a structure of each two-dimensional light-emission element array 101.

The omnidirectional stereoscopic image display device 30 shown in FIG. 22A, which uses an integral imaging method, has three light-emission units U1, U2 and U3 and has a structure where a rotation section 104 rotates in an arrow R direction or in a direction opposite to the arrow direction with an axis of rotation 103 as a rotation center. In the omnidirectional stereoscopic image display device 30, three slits 102 are provided in an outer casing 41 at equal angles (120 degrees) with the axis of rotation 103 of the rotation section 104 as an origin. The light-emission unit U1 has a first slit 102, the light-emission unit U2 has a second slit 102, and the light-emission unit U3 has a third slit 102.

In the example, each two-dimensional light-emission element array 101 is disposed between the axis of rotation 103 of the rotation section 104 and a slit 102 thereof such that a light-emission surface of the array faces the slit 102. For example, a two-dimensional light-emission element array 101 of the light-emission unit U1 is disposed between the outer casing 41 and the axis of rotation 103 such that a light-emission surface of the array faces the first slit 102 of the rotation section 104.

A two-dimensional light-emission element array 101 of the light-emission unit U2 is disposed between the outer casing 41 and the axis of rotation 103 such that a light-emission surface of the array faces the second slit 102 of the rotation section 104. A two-dimensional light-emission element array 101 of the light-emission unit U3 is disposed between the outer casing 41 and the axis of rotation 103 such that a light-emission surface of the array faces the third slit 102 of the rotation section 104. Light-emission elements, being different in wavelength, are mounted in each of the three two-dimensional light-emission element arrays 101. Light having different wavelengths emitted from the three two-dimensional light-emission element arrays 101 are combined, so that color display of a stereoscopic image is performed.

In the omnidirectional stereoscopic image display device 30, a slit 102 parallel to the axis of rotation 103 is provided in the outer casing 41 in front of the light-emission surface of the two-dimensional light-emission element array 101 of the light-emission unit U1. Even in the example, a structure is used, where light emitted from the two-dimensional light-emission element array 101 does not leak from any portion other than the slit. The other light-emission units U2 and U3 are configured in the same way.

Operation Example

According to the three-slit structure, light emitted from the two-dimensional light-emission element array 101 of the light-emission unit U1 shown in FIG. 22B is greatly limited in horizontal emission angle by the slit 102. Light emitted from the two-dimensional light-emission element array 101 of the light-emission unit U2 is greatly limited in horizontal emission angle by the slit 102. Similarly, light emitted from the two-dimensional light-emission element array 101 of the light-emission unit U3 is greatly limited in horizontal emission angle by the slit 102.

The rotation section 104 having such a three-slit structure is rotationally scanned with respect to an eyepoint, and therefore a cylindrical integral imaging surface may be formed. Light of a stereoscopic image imaged with the axis of rotation 103 as a reference leaks from the inside of the rotation section 104 to the outside through the three slits 102.

In this way, according to the omnidirectional stereoscopic image display device 30 as the third embodiment, light from the three stereoscopic light-emission element arrays 101 are emitted in different directions, enabling integral imaging for three vertical lines restricted by the three slits 102. Therefore, a high-resolution color stereoscopic image, which is imaged by, for example, light of colors of R, G and B emitted from the three two-dimensional light-emission element arrays 101 being different in wavelength, may be viewed.

### Fourth Embodiment

### Configuration Example of Omnidirectional Stereoscopic Image Display Device 40

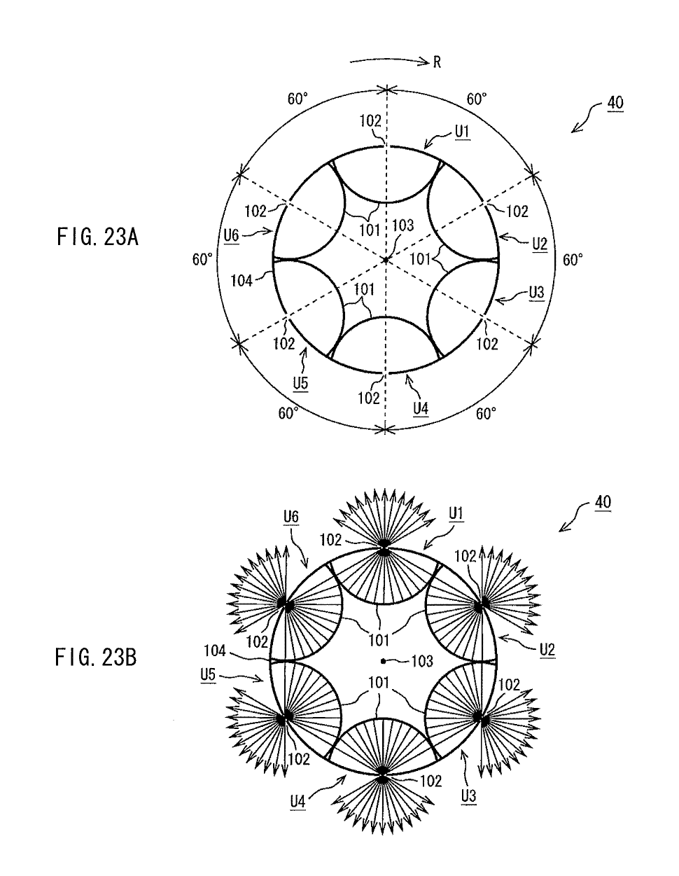

FIGS. 23A and 23B are a section diagram showing a configuration example of an omnidirectional stereoscopic image display device 40 as a fourth embodiment and an explanatory diagram showing an operation example of the device 40, respectively. The omnidirectional stereoscopic image display device 40 shown in FIG. 23A, which uses an integral imaging method, has six light-emission units U1 to U6 and has a structure where a rotation section 104 rotates in an arrow R direction or in a direction opposite to the arrow direction with an axis of rotation 103 as a rotation center.

In the omnidirectional stereoscopic image display device 40, six slits 102 are provided in an outer casing 41 at equal angles (60 degrees) with the axis of rotation 103 of the rotation section 104 as an origin. The light-emission unit U1 has a first slit 102, the light-emission unit U2 has a second slit 102, and the light-emission unit U3 has a third slit 102. The light-emission unit U4 has a fourth slit 102, the light-emission unit U5 has a fifth slit 102, and the light-emission unit U6 has a sixth slit 102.

In the example, each two-dimensional light-emission element array 101 is disposed between the axis of rotation 103 of the rotation section 104 and a slit 102 thereof such that a light-emission surface of the array faces the slit 102. For example, a two-dimensional light-emission element array 101 of the light-emission unit U1 is disposed between the outer casing 41 and the axis of rotation 103 such that a light-emission surface of the array faces the first slit 102 of the rotation section 104.

A two-dimensional light-emission element array 101 of the light-emission unit U2 is disposed between the outer casing 41 and the axis of rotation 103 such that a light-emission surface of the array faces the second slit 102 of the rotation section 104. A two-dimensional light-emission element array 101 of the light-emission unit U3 is disposed between the outer casing 41 and the axis of rotation 103 such that a light-emission surface of the array faces the third slit 102 of the rotation section 104.

A two-dimensional light-emission element array 101 of the light-emission unit U4 is disposed between the outer casing 41 and the axis of rotation 103 such that a light-emission surface of the array faces the fourth slit 102 of the rotation section 104. A two-dimensional light-emission element array 101 of the light-emission unit U5 is disposed between the outer casing 41 and the axis of rotation 103 such that a light-emission surface of the array faces the fifth slit 102 of the rotation section 104. A two-dimensional light-emission element array 101 of the light-emission unit U6 is disposed between the outer casing 41 and the axis of rotation 103 such that a light-emission surface of the array faces the sixth slit 102 of the rotation section 104.

In the omnidirectional stereoscopic image display device 40, a slit 102 parallel to the axis of rotation 103 is provided in the outer casing 41 in front of the light-emission surface of the two-dimensional light-emission element array 101 of the light-emission unit U1. Even in the example, a structure is used, where light emitted from the two-dimensional light-emission element array 101 does not leak from any portion other than the slit. The other light-emission units U2 to U6 are configured in the same way.

Operation Example

According to the six-slit structure, light emitted from the two-dimensional light-emission element array 101 of the light-emission unit U1 shown in FIG. 23B is greatly limited in horizontal emission angle by the slit 102. Light emitted from the two-dimensional light-emission element array 101 of the light-emission unit U2 is greatly limited in horizontal emission angle by the slit 102. Light emitted from the two-dimensional light-emission element array 101 of the light-emission unit U3 is greatly limited in horizontal emission angle by the slit 102.

Light emitted from the two-dimensional light-emission element array 101 of the light-emission unit U4 is greatly limited in horizontal emission angle by the slit 102. Light emitted from the two-dimensional light-emission element array 101 of the light-emission unit U5 is greatly limited in horizontal emission angle by the slit 102. Similarly, light emitted from the two-dimensional light-emission element array 101 of the light-emission unit U6 is greatly limited in horizontal emission angle by the slit 102.

The rotation section 104 having such a six-slit structure is rotationally scanned with respect to an eyepoint, thereby a cylindrical integral imaging surface may be formed. Light of a stereoscopic image imaged with the axis of rotation 103 as a reference leaks from the inside of the rotation section 104 to the outside through the six slits 102.

In this way, according to the omnidirectional stereoscopic image display device 40 as the fourth embodiment, light from the six stereoscopic light-emission element arrays 101 are emitted in different directions, enabling integral imaging for six vertical lines restricted by the six slits 102.

### Fifth Embodiment

### Configuration Example of Omnidirectional Stereoscopic Image Display Device 50

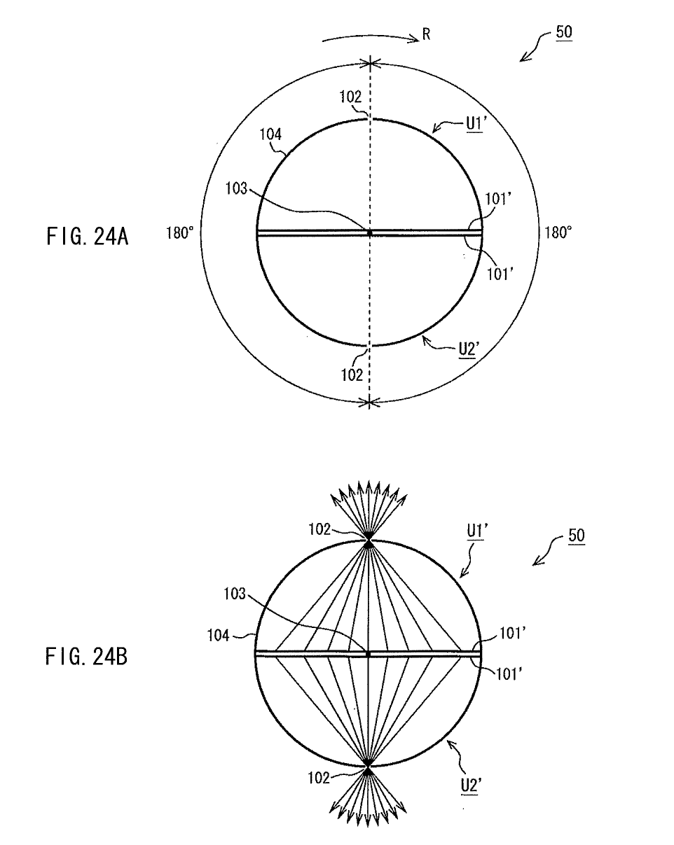

FIGS. 24A and 24B are a section diagram showing a configuration example of an omnidirectional stereoscopic image display device 50 as a fifth embodiment and an explanatory diagram showing an operation example of the device 50, respectively. A shape of a light-emission unit U1, including a two-dimensional light-emission element array 101 and a slit 102, may be varied depending on various configurations other than the aforementioned configurations. For example, a configuration, using two sets of light-emission units U1′ using planar, two-dimensional light-emission element arrays 101′, is likely to be used.

The omnidirectional stereoscopic image display device 50 shown in FIG. 24A, which uses an integral imaging method, has two light-emission units U1′ and U2′ and has a structure where a rotation section 104 rotates in an arrow R direction or in a direction opposite to the arrow direction with an axis of rotation 103 as a rotation center.

In the omnidirectional stereoscopic image display device 50, two slits 102 are provided in an outer casing 41 at equal angles (180 degrees) with the axis of rotation 103 of the rotation section 104 as an origin. The light-emission unit U1′ has one slit 102, and the light-emission unit U2′ has the other slit 102. A two-dimensional light-emission element array 101′ of the light-emission unit U1 has a planar (flat) light-emission surface, and is disposed between the outer casing 41 and the axis of rotation 103 such that the light-emission surface faces the one slit 102 of the rotation section 104. A two-dimensional light-emission element array 101′ of the light-emission unit U2′ is disposed between the outer casing 41 and the axis of rotation 103 such that a light-emission surface of the array faces the other slit 102 of the rotation section 104.

In the omnidirectional stereoscopic image display device 50, a slit 102 parallel to the axis of rotation 103 is provided in the outer casing 41 in front of the light-emission surface of the two-dimensional light-emission element array 101′ of the light-emission unit U1′. Even in the example, a structure is used, where light emitted from the two-dimensional light-emission element array 101′ does not leak from any portion other than the slit. The other light-emission unit U2′ is configured in the same way.

Operation Example

According to the two-slit structure, light emitted from the two-dimensional light-emission element array 101 of the light-emission unit U1′ shown in FIG. 24B is greatly limited in horizontal emission angle by the slit 102. Similarly, light emitted from the two-dimensional light-emission element array 101′ of the light-emission unit U2′ is greatly limited in horizontal emission angle by the slit 102. The rotation section 104 having such a two-slit structure is rotationally scanned with respect to an eyepoint, thereby a cylindrical integral imaging surface may be formed. In the example, light of a stereoscopic image imaged with the axis of rotation 103 as a reference leaks from the inside of the rotation section 104 to the outside through the two slits 102.

In this way, according to the omnidirectional stereoscopic image display device 50 as the fifth embodiment, light from the planar, two two-dimensional light-emission element arrays 101′ are emitted in different directions, enabling integral imaging for two vertical lines restricted by the two slits 102. Therefore, a high-resolution stereoscopic image, which is imaged by light emitted from the two two-dimensional light-emission element arrays 101′, may be viewed in the same way as in the second embodiment.

### Sixth Embodiment

### Configuration Example of Omnidirectional Stereoscopic Image Display Device 60

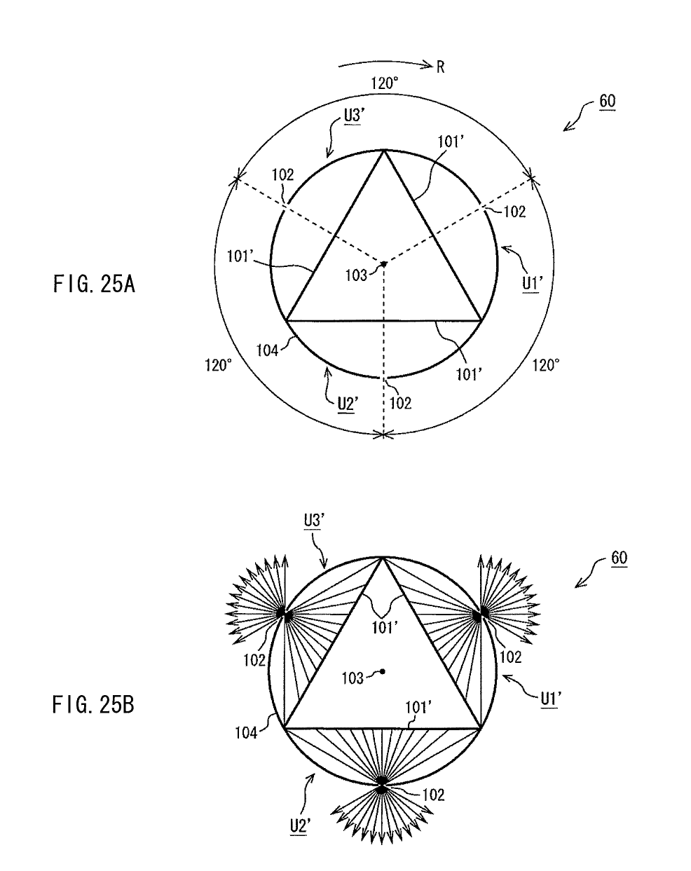

FIGS. 25A and 25B are a section diagram showing a configuration example of an omnidirectional stereoscopic image display device 60 as a sixth embodiment and an explanatory diagram showing an operation example of the device 60, respectively. In the embodiment, a plurality of planar, single-color two-dimensional light-emission element arrays 101′ different in wavelength are mounted, thereby color display may be performed without complicating a structure of each two-dimensional light-emission element array 101′.

The omnidirectional stereoscopic image display device 60 shown in FIG. 25A, which uses an integral imaging method, has three light-emission units U1′, U2′ and U3′ and has a structure where a rotation section 104 rotates in an arrow R direction or in a direction opposite to the arrow direction with an axis of rotation 103 as a rotation center. In the omnidirectional stereoscopic image display device 60, three slits 102 are provided in an outer casing 41 at equal angles (120 degrees) with the axis of rotation 103 of the rotation section 104 as an origin. The light-emission unit U1′ has a first slit 102, the light-emission unit U2′ has a second slit 102, and the light-emission unit U3′ has a third slit 102.

In the example, planar two-dimensional light-emission element arrays 101′ are disposed in an equilateral triangle shape within an outer casing 41. Each two-dimensional light-emission element array 101 is disposed between the axis of rotation 103 of the rotation section 104 and a slit 102 thereof such that a light-emission surface of the array faces the slit 102. For example, a two-dimensional light-emission element array 101′ of the light-emission unit U1′ is disposed between the outer casing 41 and the axis of rotation 103 such that a light-emission surface of the array faces the first slit 102 of the rotation section 104.

A two-dimensional light-emission element array 101′ of the light-emission unit U2′ is disposed between the outer casing 41 and the axis of rotation 103 such that a light-emission surface of the array faces the second slit 102 of the rotation section 104. A two-dimensional light-emission element array 101′ of the light-emission unit U3′ is disposed between the outer casing 41 and the axis of rotation 103 such that a light-emission surface of the array faces the third slit 102 of the rotation section 104. Light-emission elements different in wavelength are mounted for each of the three two-dimensional light-emission element arrays 101′ to perform color display of a stereoscopic image.

In the omnidirectional stereoscopic image display device 60, a slit 102 parallel to the axis of rotation 103 is provided in the outer casing 41 in front of the light-emission surface of the two-dimensional light-emission element array 101′ of the light-emission unit U1′. Even in the example, a structure is used, where light emitted from the two-dimensional light-emission element array 101′ does not leak from any portion other than the slit. The other light-emission units U2′ and U3′ are configured in the same way.

Operation Example

According to the three-slit structure, light emitted from the two-dimensional light-emission element array 101′ of the light-emission unit U1′ shown in FIG. 25B is greatly limited in horizontal emission angle by the slit 102. Light emitted from the two-dimensional light-emission element array 101′ of the light-emission unit U2′ is greatly limited in horizontal emission angle by the slit 102. Similarly, light emitted from the two-dimensional light-emission element array 101′ of the light-emission unit U3′ is greatly limited in horizontal emission angle by the slit 102.

The rotation section 104 having such a three-slit structure is rotationally scanned with respect to an eyepoint, thereby a cylindrical integral imaging surface may be formed. Light of a stereoscopic image imaged with the axis of rotation 103 as a reference leaks from the inside of the rotation section 104 to the outside through the three slits 102.

In this way, according to the omnidirectional stereoscopic image display device 60 as the sixth embodiment, light from the planar, three stereoscopic light-emission element arrays 101′ are emitted in different directions, enabling integral imaging for three vertical lines restricted by the three slits 102. Therefore, a high-resolution color stereoscopic image, which is imaged by, for example, light of colors of R, G and B emitted from the three two-dimensional light-emission element arrays 101′ being different in wavelength, may be viewed in the same way as in the third embodiment.

### Seventh Embodiment

### Optimization of Slit Width

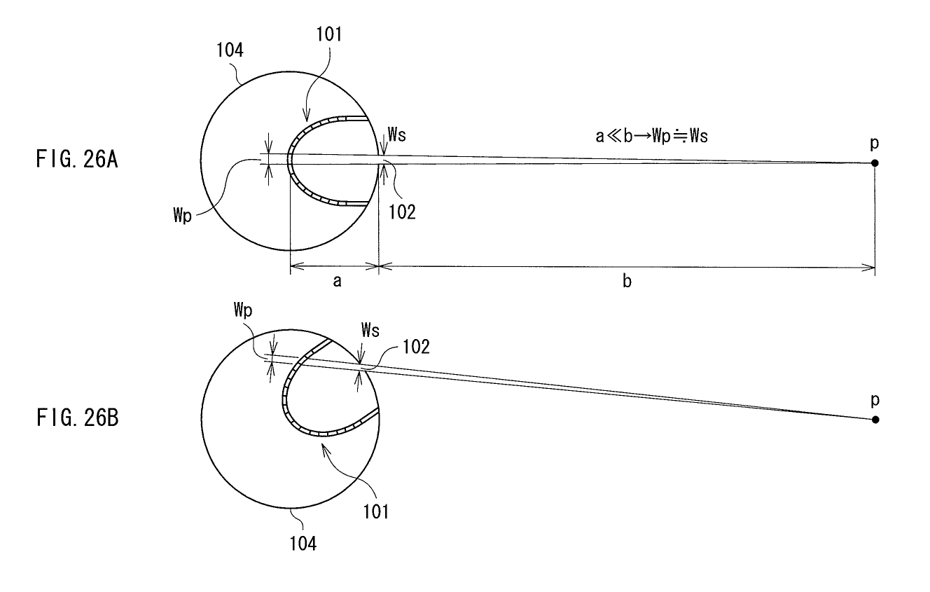

In the embodiment, optimization of width of the slit 102 of the rotation section 104 is described with, as an example, the configuration of the omnidirectional stereoscopic image display device 10 according to the first embodiment with reference to FIGS. 26A and 26B. Similar optimization may be performed for the omnidirectional stereoscopic image display devices according to other embodiments.

For width Ws in a minor axis direction of the slit 102, when the two-dimensional light-emission element array 101 is observed through the slit 102 from an optional eyepoint p at a certain moment, observed width is desirably the same as a lateral mounting pitch Wp of the light-emission elements. When the observed width is the same as the mounting pitch Wp, the following state may be produced: when the two-dimensional light-emission element array 101 is observed in a predetermined direction, a light emitting point from approximately only one light-emission element is observed. As observed width is increasingly wide compared with the mounting pitch Wp, light emitting patterns of adjacent light-emission elements are gradually mixed, leading to image blur. This is because display data are updated such that one light-emission element corresponds to one eyepoint p at a certain moment. Conversely, as the slit width Ws is increasingly narrowed and thus observed width is increasingly narrowed, while image blur is increasingly hard to occur, the quantity of light is reduced, leading to a dark image.

Actually, the slit width Ws or the mounting pitch Wp is differently viewed depending on observation timing or a position of an eyepoint p. Thus, an image observed from a certain viewpoint p is preferably adjusted to be optimum, for example, in a central portion. For example, as shown in FIG. 26A, it is assumed that a distance between the slit 102 and the center of the two-dimensional light-emission element array 101 is a, and a distance between the slit 102 and the eyepoint p is b. The slit width Ws is assumed to be configured with a width being the same as the mounting pitch Wp assuming that the distance b is sufficiently large compared with the distance a. In this case, as shown in FIG. 26A, when the center of the two-dimensional light-emission element array 101 is observed from the eyepoint p through the slit 102, the two-dimensional light-emission element array 101 is observed with a width being approximately the same as the mounting pitch Wp. Consideration is made on a state where an end portion of the two-dimensional light-emission element array 101 is observed from the eyepoint p through the slit 102 in the same configuration as above, as shown in FIG. 26B. In this case, the two-dimensional light-emission element array 101 is observed through the slit 102 in an oblique direction. In this case, since the array is observed in an oblique direction, the slit width Ws is observed apparently small compared with the state of FIG. 26A. In addition, the two-dimensional light-emission element array 101 is observed apparently small in size compared with the state of FIG. 26A. As a result, even if the two-dimensional light-emission element array 101 is observed in an oblique direction as shown in FIG. 26B, the array 101 is observed apparently with a width being approximately the same as the mounting pitch Wp.

### Eighth Embodiment

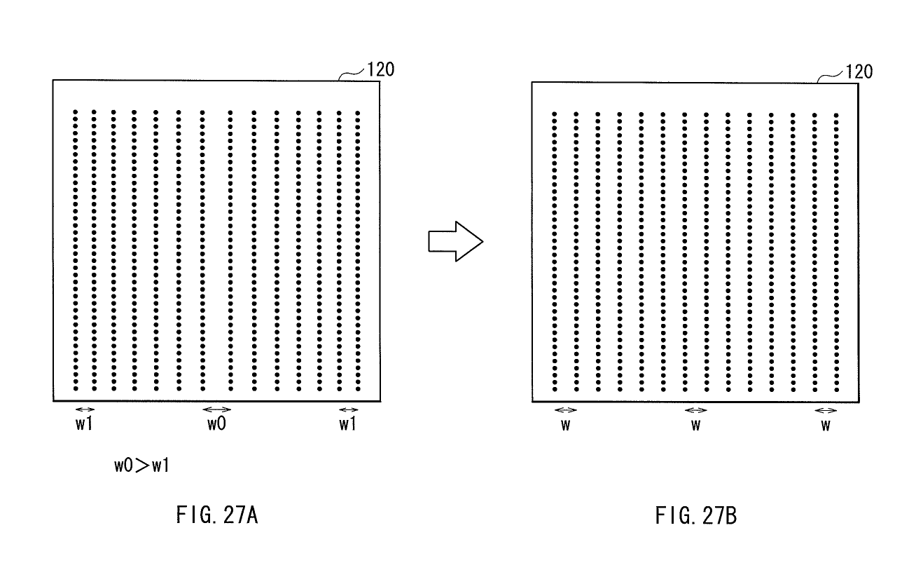

As described in the first embodiment, in the omnidirectional stereoscopic image display device 10, for example, image display is performed such that a trajectory of light emitting points given by the two-dimensional light-emission element array 101, namely, an observed image display surface is a flat surface for each of the 60 eyepoints P=300 to 359. Here, in the two-dimensional light-emission element array 101, it is assumed that a plurality of light-emission elements are arranged at even intervals in a curved surface, and image update (emission control) is performed at the same timing in all the light-emission elements. In this case, a display surface 120 observed from an optional eyepoint p is, for example, as shown in FIG. 27A. In the figure, black points correspond to pixels (a trajectory of light emitting points). In this case, in the observed display surface 120, a pixel interval w1 in either lateral end is inconveniently viewed narrow compared with a pixel interval w0 in the center. However, pixel intervals w are preferably the same between the center and either lateral end (light emitting points have a constant interval) as shown in FIG. 27B.

In the embodiment, a method to achieve ideal image display as shown in FIG. 27B is described based on the configuration of the omnidirectional stereoscopic image display device 10 according to the first embodiment. In addition, for the omnidirectional stereoscopic image display devices according to other embodiments, image display may be performed according to the same method.

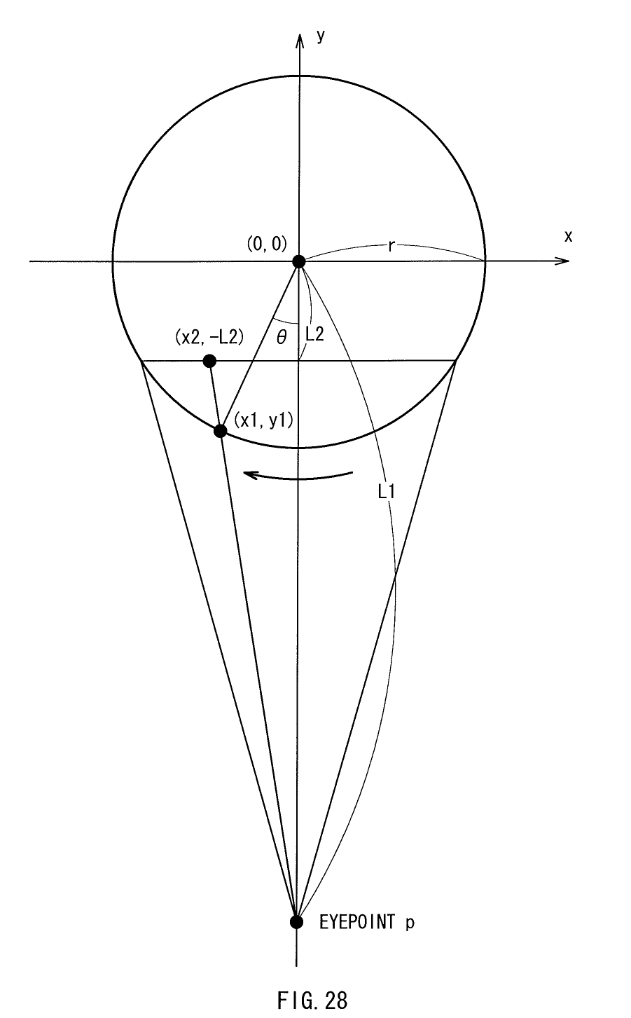

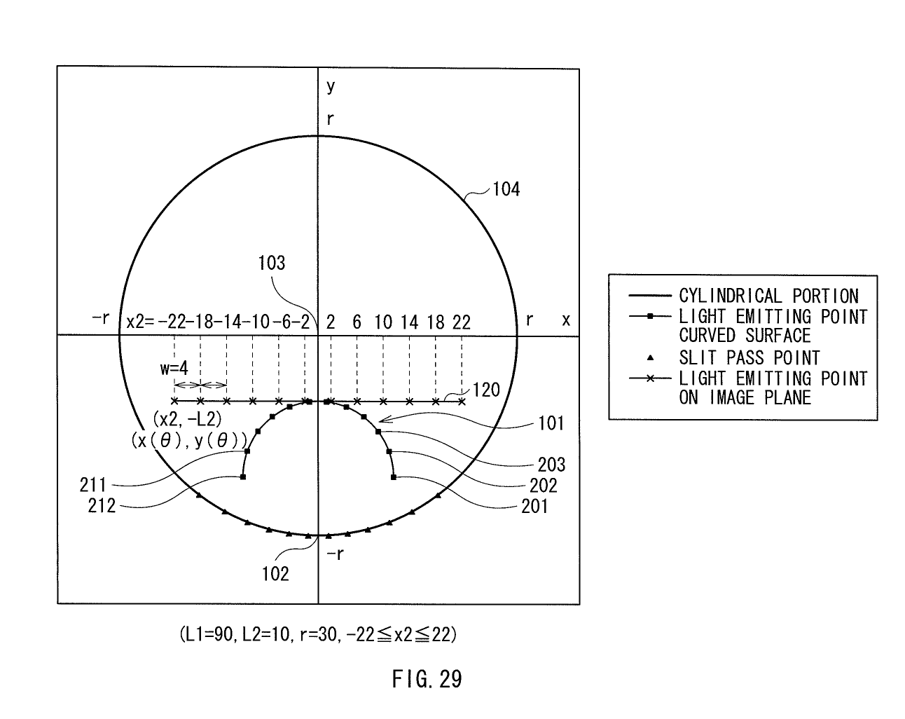

First, with reference to FIGS. 28 and 29, description is made on a calculation example of a curved surface shape of the two-dimensional light-emission element array 101 and positions of light emitting points (light-emission elements) for achieving ideal image display as shown in FIG. 27B. Meaning of each symbol in FIGS. 28 and 29 is basically the same as in FIGS. 3 and 4 described before.

In FIG. 28, a light emitting point (corresponding to a pixel shown in FIG. 27B), which is actually observed from the eyepoint p through a slit 102, is assumed to be a point (x2, −L2) on y=−L2. Assuming that L3=L1−L2 is true, a condition of the slit 102 as a pass point (x1, y1), through which the light emitting point (x2, −L2) may be observed, is as follows.

$$x 1 = \frac{x 2 \{ \begin{matrix}L 1 \cdot L 3 - \\ \sqrt{L {3}^{2} \cdot {r}^{2} + ( {r}^{2} - L {1}^{2} ) x {2}^{2}}\end{matrix} \}}{L {3}^{2} + x {2}^{2}} \\ y 1 = - \sqrt{{r}^{2} - x {1}^{2}} \qquad [ Numerical expression 1 ]$$

When an angle θ indicating a position of the slit 102 increases in a rotation direction of an arrow in FIG. 28, the angle θ is expressed as follows:

θ=−sin⁻¹ θ(x1/r).

Accordingly, position coordinates (x(θ), y(θ)) of a light emitting point (light-emission element) of the curved surface shape (curved shape) of the two-dimensional light-emission element array 101 are expressed as follows:

x(θ)=x2 cos θ+L2 sin θ (1A),

y(θ)=x2 sin θ−L2 cos θ (2A).

When a time point, at which the slit 102 passes through a position of angle θ=0 degrees, is t=0, and time for one round, namely, 360-degree rotation of the slit 102 is Tc, update timing of light emitting points of an image observed from the eyepoint p is expressed as follows:

t=Tc·θ/2π (3).

Specific Example

FIG. 29 shows a specific example of a curved surface shape of the two-dimensional light-emission element array 101 for arranging light emitting points, which are actually observed from the eyepoint p through the slit 102, and positions of light emitting points (light-emission elements) in the curved surface. In FIG. 29, L1=90, L2=10, and r=30 are given, the total number of light emitting points in an x-axis direction is 12, a distance between the light emitting points is 4, and x2 values of light emitting points observed at even intervals are as follows:

−22, −18, −14, −10, −6, −2, 2, 6, 10, 14, 18, 22.

When images for 60 eyepoints of p=300 to 359 are outputted in one round, an update interval T of each of the 12 light-emission elements 210 to 212 is expressed as follows:

T=Tc/60 (4).

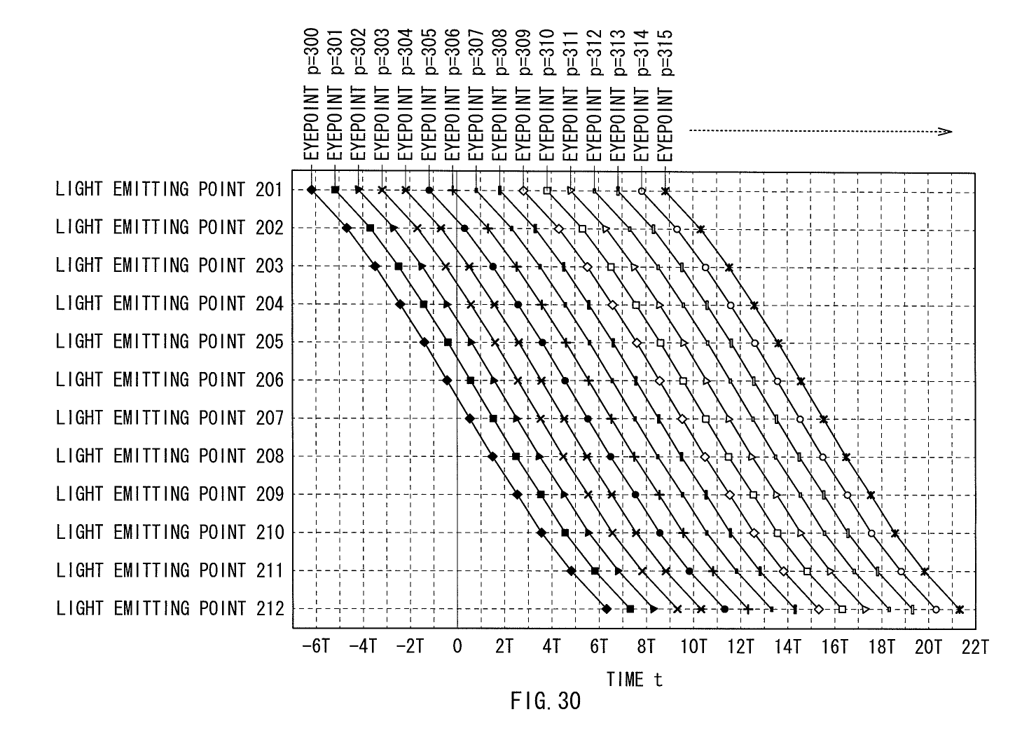

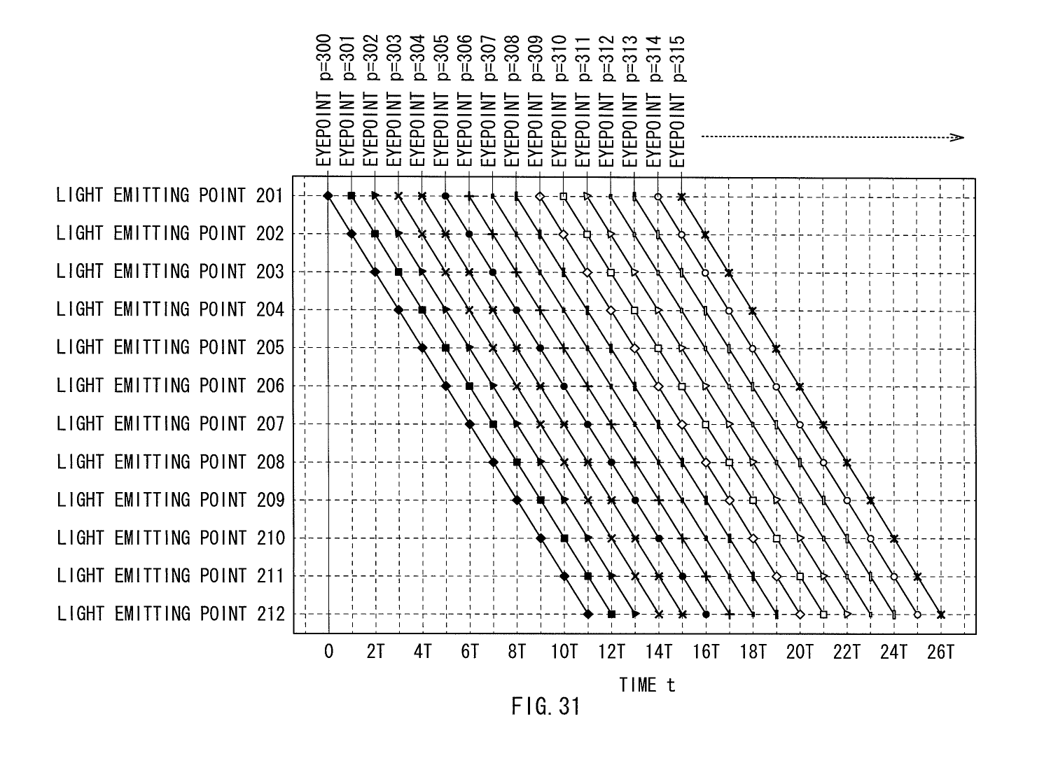

FIG. 30 shows light emitting timing of each light-emission element for achieving ideal image display as shown in FIG. 27B. FIG. 31 shows light emitting timing as a comparative example. The comparative example of FIG. 31 corresponds to beam output timing as shown in FIGS. 10A to 12D and FIGS. 13A to 15B. In FIGS. 30 and 31, a horizontal axis shows time t and a vertical axis shows 12 light emitting points (light-emission elements 201 to 212). In FIG. 30, a solid line curve (straight line in FIG. 31) shows light emitting timing for a certain eyepoint p. For example, in FIG. 30, a curve of a leftmost solid line shows light emitting timing of a light emitting point (light-emission element) observed at an eyepoint 300. Control of the light emitting timing shown in FIGS. 30 and 31 is performed by the display controller 15 (FIG. 18).

In the comparative example of FIG. 31, the 12 light-emission elements 201 to 212 have the same update interval T and the same update timing (time). For example, the light-emission elements 201 to 212 perform image display (light emission) for the eyepoints 311 to 300 at time t=11T, respectively (for example, the light-emission element 201 performs light emission for an eyepoint 311, and a light-emission element 202 performs light emission for an eyepoint 310 at the same time). At next time t=12T, the light-emission elements 201 to 212 are updated at the same time and perform light emission for the eyepoints 312 to 301, respectively. In other words, image update timing (light emission update timing) is the same between the 12 light emission elements 201 to 212.

In the example of FIG. 30, while update intervals T are the same between the 12 light-emission elements 201 to 212, update timing (time) is different. For example, while the light-emission element 201 starts to emit light for the eyepoint 311 shortly before time t=5T, other light-emission elements 202 to 212 do not emit light at the time t=5T. For example, the light-emission element 202 starts to emit light for the eyepoint 310 shortly after time t=5T. In this way, emission start timing is individually controlled for each of the 12 light-emission elements 201 to 212. The light-emission elements 201 to 212 are independently controlled in light emission with such light emitting timing, and therefore ideal image display as shown in FIG. 27B may be achieved.

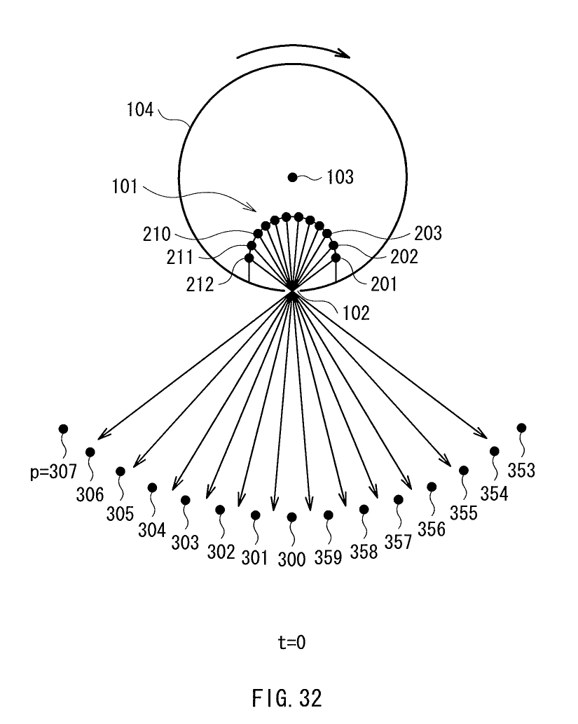

FIG. 32 shows a state of beams (beam vector) emitted via the slit 102 in the case that the 12 light-emission elements 201 to 212 are allowed to emit light simultaneously at time t=0 in the configuration of FIG. 29. As known from FIG. 32, beam vectors from the light-emission elements are different in positional relationship with the visual-point positions. This reveals that the 12 light-emission elements 201 to 212 need to be individually controlled in light emitting timing as shown in FIG. 30 instead of allowing the light-emission elements to emit light simultaneously.

Advantage of Flat Observed Image

In the embodiments described hereinbefore, the curved surface of the two-dimensional light-emission element array 101 is preferably configured such that a display surface observed from the eyepoint p is a flat surface. The reason for this is as follows.
When the observed display surface is a flat surface, an image photographed by a camera or a CG image may be directly used without image processing. When the observed display surface is a curved surface, an image needs to be produced and used while a curvature of a display surface is corrected to prevent distortion in image observed from the eyepoint p.
When the observed display surface is a curved surface, if a display surface is viewed from above or below, an image is distorted in an arched shape, and consequently a good stereoscopic image is hardly obtained.

Particularly, when the device is configured such that a pixel interval on a display surface observed from the eyepoint p is constant as in the embodiment, the following advantage is further obtained.
When the pixel interval is constant, an image photographed by a camera or a CG image may be directly used without image processing. If the pixel interval is not constant, an image needs to be produced and used while distortion of the pixel interval is corrected.

### Ninth Embodiment

### Viewing Example of Stereoscopic Image Using Display Device of Each of First to Eighth Embodiments

FIGS. 33A and 33B are explanatory diagrams showing a viewing example of a stereoscopic image in the omnidirectional stereoscopic image display device 10 as each embodiment. In the viewing example of a stereoscopic image shown in FIG. 33A, four viewers H1 to H4 view a stereoscopicly displayed character (doll of a boy) by the omnidirectional stereoscopic image display device 10 or the like. In this case, since a stereoscopic image over the entire circumference of the character is displayed, a viewer H1 (male) may view a stereoscopic image on a left side of the character. A viewer H2 (male) may view a stereoscopic image on a front side of the character. A viewer H3 (male) may view a stereoscopic image on a right side of the character. A viewer H4 (female) may view a stereoscopic image on a back side of the character.

The viewing example of the stereoscopic image shown in FIG. 33B employs a stereoscopic image display method, where a stereoscopic picture is outputted only to a region where a viewer is determined to exist, while a stereoscopic picture is not outputted to a region where no viewer is determined to exist. For example, in the figure, four viewers H1 to H4 exist around the omnidirectional stereoscopic image display device 10. While three viewers H1 to H3 watches the omnidirectional stereoscopic image display device 10 without turning away their eyes, a viewer H4 turns away its eyes from the device 10. In this case, in the omnidirectional stereoscopic image display device 10 shown in FIG. 18, a viewer detection sensor 81 detects pupils of the three viewers H1 to H3 and generates a viewer detection signal S81.

The omnidirectional stereoscopic image display device 10 sequentially transmits information of viewing regions of the three viewers H1 to H3 to the picture source sender 90 based on the viewer detection signal S81 outputted from the viewer detection sensor 81. The picture source sender 90 sends only pictures corresponding to the viewing regions of the three viewers H1 to H3 to the omnidirectional stereoscopic image display device 10. As a result, display information may be reproduced only in the viewing regions where the three viewers H1 to H3 exist.

In the example, the viewer H1, watching the omnidirectional stereoscopic image display device 10 without turning away its eyes, may view the stereoscopic image on the left side of the character. Similarly, the viewer H2 may view the stereoscopic image on the front side of the character. Similarly, the viewer H3 may view the stereoscopic image on the right side of the character. However, no stereoscopic image is displayed in a viewing region of the viewer H4 turning away its eyes from the device 10.

In FIG. 33B, each dashed line portion shows a state where display light shines on a face of each of the viewers H1 to H3. The reason why display light does not shine on the viewer H4 is because the viewer H4 looks away from the omnidirectional stereoscopic image display device 10, and therefore the viewer H4 is not determined as a viewer. Since a picture corresponding to a viewing region between the viewers H1 and H2 is also not outputted, no stereoscopic image is displayed in the viewing region. Consequently, a unique stereoscopic image display method may be provided.

### Tenth embodiment

### Configuration of Omnidirectional Stereoscopic Image Display Device 70

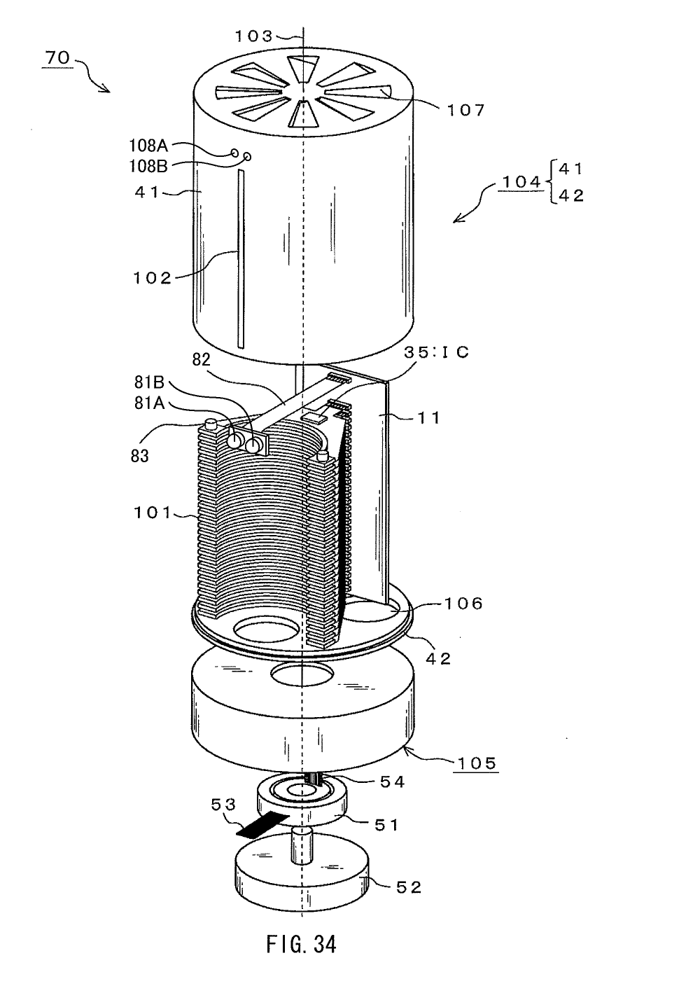

FIG. 34 shows a configuration example of an omnidirectional stereoscopic image display device 70 according to the tenth embodiment. The omnidirectional stereoscopic image display device 70 has an infrared emitter 81A and an infrared receptor 81B in place of the viewer detection sensor 81 of the omnidirectional stereoscopic image display device 10 shown in FIG. 2. The infrared emitter 81A and the infrared receptor 81B are attached to one end of an arm member 82 and connected to a connection board 11 via the arm member 82 in the same way as the viewer detection sensor 81. Moreover, the omnidirectional stereoscopic image display device 70 has an aperture 108A for the emitter and an aperture 108B for the receptor in place of the aperture 108 of the omnidirectional stereoscopic image display device 10 shown in FIG. 2. The aperture 108A for the emitter is provided at a position corresponding to the infrared emitter 81A while an outer casing 41 is attached to a turntable 42. The aperture 108B for the receptor is provided at a position corresponding to the infrared emitter 81B while the outer casing 41 is attached to the turntable 42.

The infrared emitter 81A and the infrared receptor 81B detect a position or motion of an object (for example, a hand 75 of an observer), for example, in the case that the object approaches the periphery of a surface of a rotation section 104 while a stereoscopic display image 76 is displayed, as shown in FIG. 36. The infrared emitter 81A emits infrared light to the outside of the rotation section 104 through the aperture 108A for the emitter. The infrared receptor 81B receives infrared light, which has been emitted from the infrared emitter 81A and then reflected on an external object and thus returned, through the aperture 108B for the receptor.

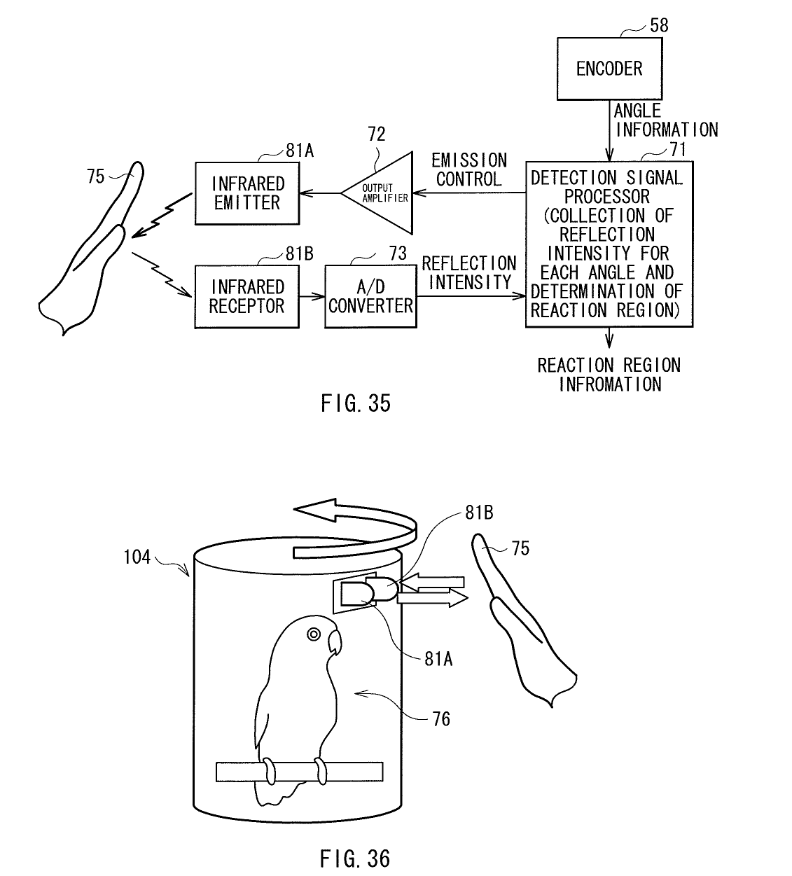

FIG. 35 shows a configuration example of an object detection circuit using the infrared emitter 81A and the infrared receptor 81B. This object detection circuit includes a detection signal processor 71, an output amplifier 72 and an analog-to-digital converter 73. Other circuit configurations of a control system are approximately the same as those of the circuit shown in FIG. 18 except for a circuit portion of the viewer detection sensor 81.

The detection signal processor 71 performs emission control of the infrared emitter 81A via the output amplifier 72. Furthermore, the detection signal processor 71 receives a detection signal from the infrared receptor 81B via the analog-to-digital converter 73 and thus acquires information of reflection intensity of infrared light that has been reflected on an external object and returned. Furthermore, the detection signal processor 71 receives an angle information signal indicating information of a rotation angle of a motor 52 (rotation angle of a rotation section 104) from an encoder 58 (see FIG. 18) attached to the motor 52. Consequently, the detection signal processor 71 acquires the information of reflection intensity of infrared light being reflected and returned every predetermined angle. The detection signal processor 71 determines a region (reaction region) where an object such as the observer hand 75 is estimated to exist based on the information of reflection intensity every predetermined angle. The detection signal processor 71 outputs a signal indicating such obtained reaction region information to a display controller 15 (see FIG. 18). Furthermore, the detection signal processor 71 outputs the signal indicating the reaction region information to a picture source sender 90 (see FIG. 18), for example, via an I/F board 56.

Operation of Omnidirectional Stereoscopic Image Display Device 70

Basic display operation of a stereoscopic image formed by the omnidirectional stereoscopic image display device 70 is the same as that of the omnidirectional stereoscopic image display device 10 (FIG. 1 and the like). In other words, while the rotation section 104 is rotated, the display controller 15 performs emission control of light-emission elements within the rotation section 104, thereby a stereoscopic display image 76 over the entire circumference may be displayed, for example, as shown in FIG. 36. Picture data Din for the stereoscopic display image 76 to be displayed are provided from the picture source sender 90 (see FIG. 18).

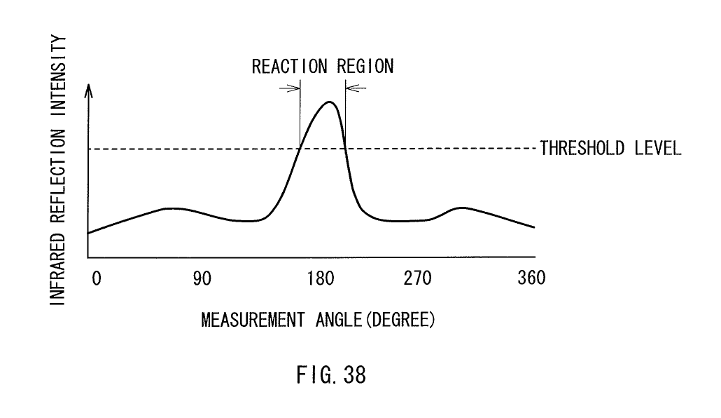

While the stereoscopic display image 76 is displayed in this way, the detection signal processor 71 acquires at any time the information of reflection intensity of infrared light being reflected and returned every predetermined angle from the infrared receptor 81B. The detection signal processor 71 determines a region (reaction region) where an object such as the observer hand 75 is estimated to exist based on the information of reflection intensity every predetermined angle. For example, the processor 71 determines an angular region, where the reflection intensity exceeds a certain threshold level, as a reaction region as shown in FIG. 38. In other words, the processor 71 determines the object such as the observer hand 75 exists in the angular region. The detection signal processor 71 outputs a signal indicating such obtained reaction region information to the display controller 15 and the picture source sender 90. The picture source sender 90 supplies picture data Din corresponding to the reaction region. The display controller 15 performs emission control of light-emission elements depending on the reaction region (position where the object such as the observer hand 75 is detected). For example, the display controller 15 performs emission control of light-emission elements such that a display state of the stereoscopic display image 76 as viewed from an observer is changed depending on the position where the object such as the observer hand 75 is detected.

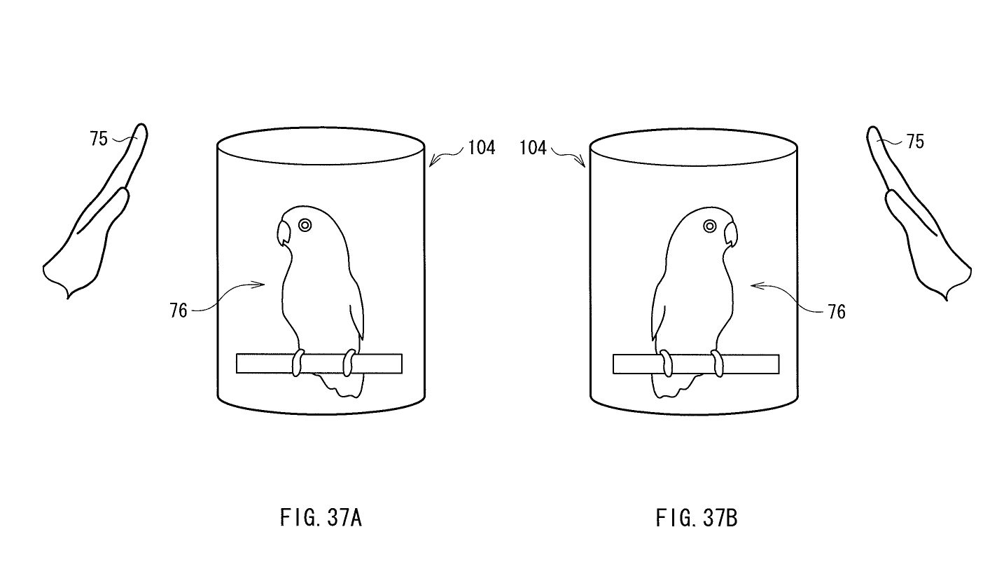

FIGS. 37A and 37B show an example of change in display state of the stereoscopic display image 76 depending on object detection. A visual direction of an observer is a direction from an optional position (for example, front direction). A bird image is displayed as the stereoscopic display image 76. For example, a direction of the bird is changed to a direction, in which the hand 75 is detected, in the periphery of the rotation section 104 as shown in FIGS. 37A and 37B. The observer may get a sense of operating a display state (direction of the bird) of the stereoscopic display image 76 only by holding the hand 75 over the image.

Hysteresis may be provided in a threshold level used for determination of the reaction region shown in FIG. 38. In addition, any display operation may be performed in accordance with change in reflection intensity without setting the threshold level.

### Eleventh Embodiment

### Configuration of Omnidirectional Stereoscopic Image Display Device 80

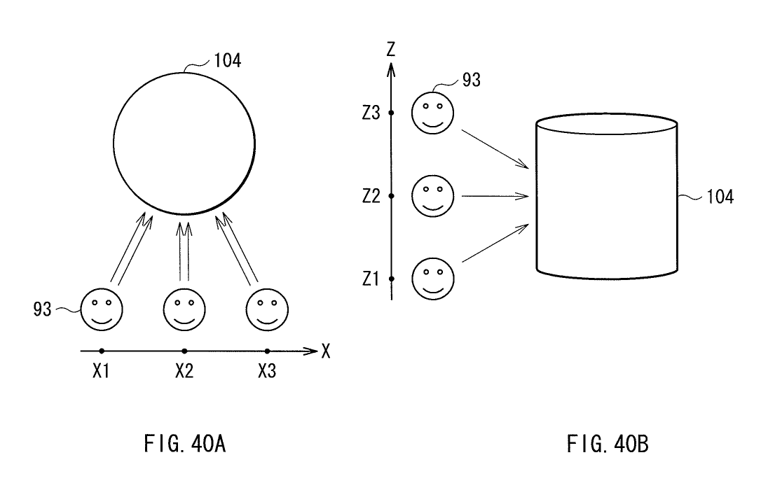

In the omnidirectional stereoscopic image display devices according to the first to tenth embodiments, a stereoscopic image corresponding to horizontal parallax, namely, a stereoscopic image, which causes parallax when the image is viewed from visual-point positions X1, X2 and X3 being different in horizontal (rotational) direction, may be displayed over the entire circumference of the rotation section 104, for example, as shown in FIG. 40A. However, it is difficult to display a stereoscopic image corresponding to vertical parallax, namely, a stereoscopic image, which causes parallax when the image is viewed from visual-point positions Z1, Z2 and Z3 being different in vertical (height) direction, for example, as shown in FIG. 40B. In the embodiment, a stereoscopic image causing vertical parallax may be easily displayed.

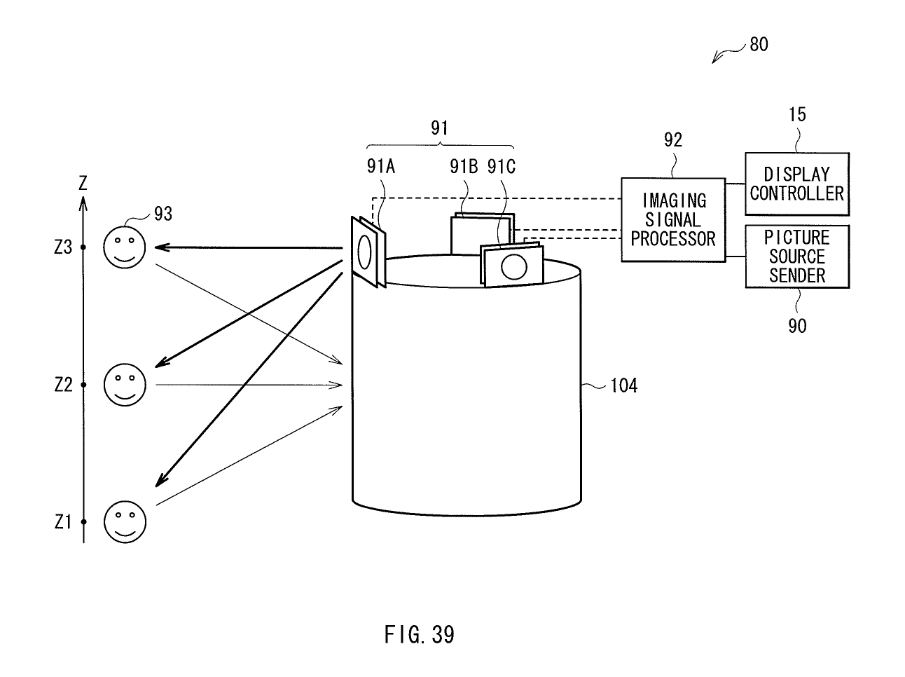

FIG. 39 shows a configuration example of the omnidirectional stereoscopic image display device 80 according to the embodiment. The omnidirectional stereoscopic image display device 80 has the same basic-structure as that of the omnidirectional stereoscopic image display device 10 shown in FIG. 2, but has an omnidirectional camera 91 in place of the viewer detection sensor 81 of the omnidirectional stereoscopic image display device 10. Furthermore, the omnidirectional stereoscopic image display device 80 has an imaging signal processor 92 processing an imaging signal outputted from the omnidirectional camera 91. A circuit configuration of a control system of the omnidirectional stereoscopic image display device 80 is approximately the same as the circuit configuration shown in FIG. 18 except for a circuit portion relating to the imaging signal processor 92. The omnidirectional camera 91 and the imaging signal processor 92 collectively correspond to a specific example of “eyepoint detection section” of the invention. The omnidirectional camera 91 corresponds to a specific example of “photographing unit” of the invention.

The omnidirectional camera 91 and the imaging signal processor 92 collectively detects a visual-point position of each observer 93 around a rotation section 104. The imaging signal processor 92 outputs a signal indicating information of a visual-point position to a display controller 15. Furthermore, the imaging signal processor 92 outputs a signal indicating information of a visual-point position to a picture source sender 90, for example, via an I/F board 56 (see FIG. 18).

The omnidirectional camera 91 may photograph a visual-point position of each observer 93 around the rotation section 104 over all directions including the horizontal (rotational) direction and the vertical (height) direction. As a first method to enable photographing over all directions, for example, the omnidirectional camera 91 is attached to the rotation section 104 and rotated along with the section 104. For example, the following structure may be used: the omnidirectional camera 91 is attached to one end of an arm member 82 (FIG. 2) within the rotation section 104, and electrically connected to a connection board 11 via the arm member 82 in the same way as the viewer detection sensor 81 of the omnidirectional stereoscopic image display device 10 shown in FIG. 2. In such a structure, one or more camera can be mounted as the omnidirectional camera 91. When the omnidirectional camera 91 is configured of only one camera, the camera is preferably set in a central position in a height direction in order to detect a visual-point position vertically accurately. When the camera is hardly set in the center, one or more camera is set in each of a top and a bottom in the height direction, thereby the visual-point position may be detected vertically accurately. The omnidirectional camera 91 may be set on an outer casing 41 rather than within the rotation section 104. FIG. 39 shows an example where a first camera 91A, a second camera 91B and a third camera 91C are set on a top of the rotation section 104 as the omnidirectional camera 91.

The omnidirectional camera 91 may be provided separately from the rotation section 104 instead of being integrated with the section 104 so that photographing is performed while the omnidirectional camera 91 is not rotated and positionally fixed. For example, a non-rotatable fixed-structure (for example, generally cylindrical transparent member) may be provided on an outer side of the rotation section 104 so that the omnidirectional camera 91 is provided on the fixed structure. In this case, for example, a plurality of cameras can be arranged at even intervals in a rotation direction of the rotation section 104 in order to enable photographing over all directions. Alternatively, a configuration may be used, where a single camera is combined with optical members such as lenses and mirrors. In other words, a configuration may be used, where object-light from all directions are optically guided to the single camera by the optical members such as lenses and mirrors. When the omnidirectional camera 91 is provided separately from the rotation section 104, one or more cameras is preferably set in a central position in a height direction in order to detect a visual-point position vertically accurately. When a camera is hardly set in the center, one or more camera is set in each of a top and a bottom in the height direction, thereby the visual-point position may be detected vertically accurately.

Operation of Omnidirectional Stereoscopic Image Display Device 80

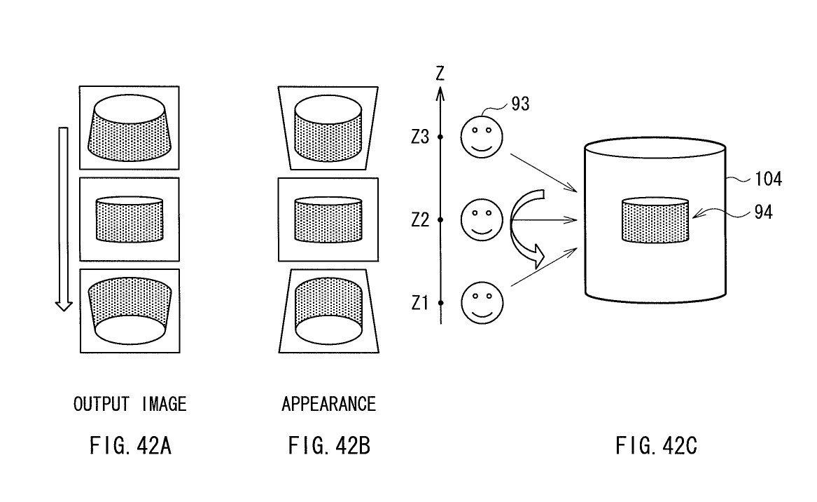

Basic display operation of a stereoscopic image of the omnidirectional stereoscopic image display device 80 is the same as that of the omnidirectional stereoscopic image display device 10 (FIG. 1 and the like). In other words, while the rotation section 104 is rotated, the display controller 15 performs emission control of light-emission elements within the rotation section 104, thereby a stereoscopic display image 94 over the entire circumference is displayed, for example, as shown in FIGS. 42A to 42C described later. Picture data Din for the stereoscopic display image 94 to be displayed are provided from the picture source sender 90 (see FIGS. 18 and 39).

While the stereoscopic display image 94 is displayed in this way, the imaging signal processor 92 acquires an imaging signal from the omnidirectional camera 91 at any time. The imaging signal processor 92 determines presence of the observer 93 and a visual-point position of the detected observer 93 based on the imaging signal from the omnidirectional camera 91. The imaging signal processor 92 outputs a signal indicating information of the obtained visual-point position of the observer 93 to the display controller 15 and the picture source sender 90. The picture source sender 90 supplies picture data Din corresponding to the visual-point position. The display controller 15 performs emission control of light-emission elements within the rotation section 104 such that content of the stereoscopic display image 94 as viewed from the observer 93 is changed depending on the detected visual-point position (see FIGS. 42A to 42C).

FIG. 42A shows an example of the stereoscopic display image 94 displayed depending on a visual-point position of the observer 93. FIG. 42A shows an example of the stereoscopic display image 94 displayed in correspondence to a first visual-point position Z1, a second visual-point position Z2 and a third visual-point position Z3 in FIG. 42C. FIG. 42B shows actual appearances of images recognized by the observer 93 in the case that the stereoscopic display image 94 is displayed as in FIG. 42A. When a visual-point position is vertically moved while two eyes of the observer 93 are kept horizontally, content of the stereoscopic display image 94 is changed in correspondence to height of the visual-point position as shown in FIG. 42A, and therefore natural parallax in a vertical (height) direction may be recognized by the observer 93.

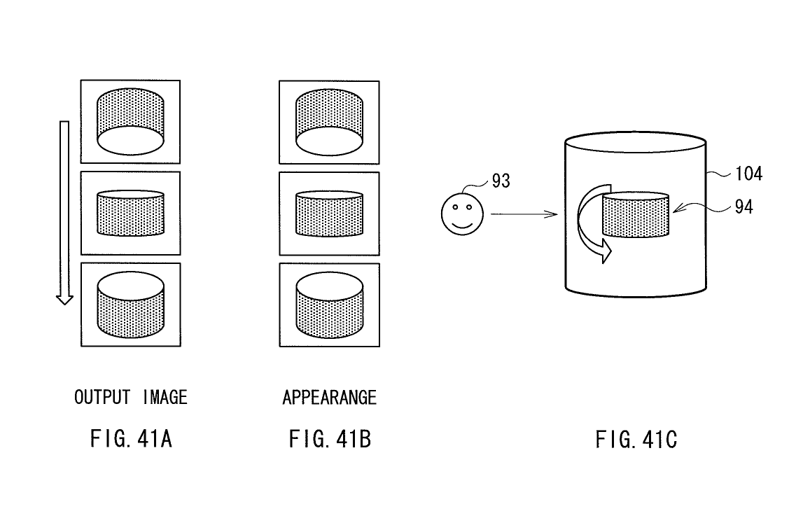

FIG. 41A shows a state where an angle of elevation or depression of an object to be displayed as the stereoscopic display image 94 is changed while a visual-point position is fixed as in FIG. 41C. FIG. 41B shows actual appearances of the image recognized by the observer 93 in the case that the stereoscopic display image 94 is displayed as in FIG. 41A. When a visual-point position is vertically moved as in FIG. 42C, the object to be displayed is likely to be viewed in the same way as in the case that the angle of elevation or depression of the object is changed with a visual-point position being fixed as in FIGS. 41A to 41C. However, when the visual-point position is vertically moved, if images are merely displayed while a direction of the object to be displayed is changed, an appearance of each image is differently recognized by the observer 93 in the light of a device configuration. When the visual-point position is vertically moved, distortion correction is performed to the stereoscopic display image 94 depending on height of an eyepoint, so that an appearance of each image becomes natural. Thus, FIG. 42A shows a stereoscopic display image 94 corrected in distortion depending on height of an eyepoint of the observer 93. The display controller 15 performs emission control of a plurality of light-emission elements within the rotation section 104 such that a stereoscopic image, corrected in distortion depending on height of an eyepoint of the observer 93, is displayed. When a stereoscopic display image 94, which is changed in angle of elevation or depression of an object to be displayed, is corrected in distortion depending on height of an eyepoint, the image 94 may be shown more naturally to the observer 93.

As hereinbefore, according to the embodiment, a natural stereoscopic image, which causes parallax when the image is viewed from visual-point positions Z1, Z2 and Z3 being different in vertical (height) direction, may be displayed over the entire circumference of the rotation section 104.

### Twelfth Embodiment

The omnidirectional stereoscopic image display device according to the twelfth embodiment has the same basic-configuration as that of the omnidirectional stereoscopic image display device 80 (FIG. 39) according to the eleventh embodiment. However, content of detection collectively performed by an omnidirectional camera 91 and an imaging signal processor 92 and content of control performed by a display controller 15 are partially different from those in the device 80. The embodiment relates to image display in the case of a plurality of observers.

In the embodiment, the omnidirectional camera 91 and the imaging signal processor 92 collectively detect visual-point positions in a horizontal (rotational) direction and in a vertical (height) direction of each of a plurality of observers around a rotation section 104. The omnidirectional camera 91 may photograph eyepoints of the observers around the rotation section 104 over all directions including the horizontal (rotational) direction and the vertical (height) direction.

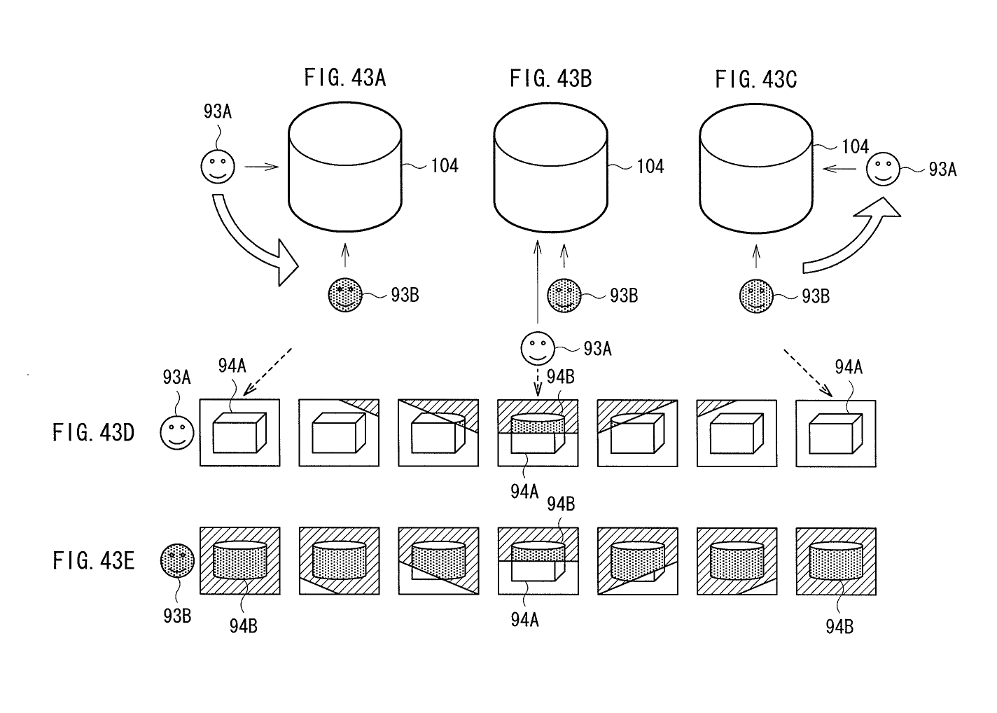

In the embodiment, the display controller 15 performs emission control of a plurality of light-emission elements within the rotation section 104 such that stereoscopic images having different content are displayed to the respective observers depending on difference in horizontal visual-point position between the observers. Hereinafter, a case of two observers, a first observer 93A and a second observer 93B, is described as an example with reference to FIGS. 43A to 43E.

FIG. 43D shows a display state of a stereoscopic image displayed at a visual-point position of the first observer 93A in the omnidirectional stereoscopic image display device according to the embodiment. FIG. 43E shows a display state of a stereoscopic image displayed at a visual-point position of the second observer 93B. A first stereoscopic display image 94A is displayed for the first observer 93A, and a second stereoscopic display image 94B is displayed for the second observer 93B. An eyepoint of each of the first observer 93A and the second observer 93B is changed as shown in FIGS. 43A to 43C. Here, an eyepoint of the first observer 93A is changed counterclockwise in order as shown in FIGS. 43A, 43B and 43C while an eyepoint of the second observer 93B is not changed.

In each of states of FIGS. 43A and 43C, the first observer 93A and the second observer 93B are greatly different in visual-point position in the horizontal (rotational) direction, and therefore view regions of the observers do not overlap with each other (the observers view completely different view regions). In such a case, only the first stereoscopic display image 94A may be displayed to the first observer 93A, and only the second stereoscopic display image 94B may be displayed to the second observer 93B.

On the other hand, as a visual-point position is moved from a position in FIG. 43A to that in FIG. 43B, the visual-point position in the horizontal (rotational) direction of the first observer 93A approaches that of the second observer 93B, and therefore view regions of the observers partially overlap with each other. When view regions of the two observers partially overlap with each other in this way, the first stereoscopic display image 94A and the second stereoscopic display image 94B are space-divisionally displayed in a ratio corresponding to such an overlapped observation range. The display controller 15 performs emission control of a plurality of light-emission elements within a rotation section 104 such that such a divided display state is achieved.

Particularly, in a state of FIG. 43B, the visual-point position in the horizontal (rotational) direction of the first observer 93A is approximately the same as that of the second observer 93B, and view regions of the observers approximately completely overlap with each other (the observers view approximately the same view region). When view regions of the two observers approximately completely overlap with each other in this way, the first stereoscopic display image 94A and the second stereoscopic display image 94B are dividedly displayed with approximately the same ratio. The display controller 15 performs emission control of the plurality of light-emission elements within the rotation section 104 such that such a space-divisional display state with approximately the same ratio is achieved.

When the view regions partially or completely overlap with each other, the images are preferably dividedly displayed at positions corresponding to visual-point positions in the height direction. For example, in the example of FIG. 43B, an observation position in the height direction is in an upper side for the second observer 93B compared with for the first observer 93A. In this case, the images can be dividedly displayed such that the first stereoscopic display image 94A for the first observer 93A is in a lower side, and the second stereoscopic display image 94B for the second observer 93B is in an upper side. Consequently, a divisional ratio is smoothly changed in accordance with movement of an eyepoint, leading to reduction in unpleasantness associated with screen switching.

As hereinbefore, according to the embodiment, different stereoscopic images may be displayed at a time to a plurality of observers over the entire circumference of the rotation section 104 by one stereoscopic display device.

The omnidirectional camera 91 and the imaging signal processor 92 may detect a region, where no observer exists, in addition to visual-point positions of a plurality of observers. In addition, the display controller 15 may perform emission control of a plurality of light-emission elements such that no stereoscopic image is displayed in the region where no observer exists. Image display is not performed in the region where no observer exists, and therefore power consumption may be suppressed compared with a case where images are continuously displayed over the entire circumference.

### Other Embodiments

The invention is not limited to the above embodiments, and various modifications and alterations may be made.

For example, in the omnidirectional stereoscopic image display device 10 shown in FIGS. 1 and 2, a fixed member for protecting the rotation section 104 may be provided on an outer side of the section 104. In this case, for example, a non-rotatable fixed-member is preferably provided so as to cover the periphery of the outer casing 41 having the slit 102 with a gap. The fixed member may be configured of, for example, a generally cylindrical, transparent member. A cylindrical member formed netlike may be used as the fixed member. For example, a member of metal formed netlike such as punching metal may be used.

The invention is extremely preferable for use in an omnidirectional stereoscopic image display device of an integral imaging method, which reproduces a stereoscopic image over the entire circumference of an object based on two-dimensional picture data for stereoscopic image display obtained by taking images of the object over the entire circumference or creating such images by a computer.

The present application contains subject matter related to that disclosed in Japanese Priority Patent Application JP 2010-134179 filed in the Japan Patent Office on Jun. 11, 2010, the entire content of which is hereby incorporated by reference.

It should be understood by those skilled in the art that various modifications, combinations, sub-combinations and alterations may occur depending on design requirements and other factors insofar as they are within the scope of the appended claims or the equivalent thereof.

What is claimed is:

1. A display device comprising:
a cylindrical rotation section having an axis of rotation therein and rotating around the axis of rotation as a rotation center;
a light-emission element array mounted in the rotation section, and including a plurality of light-emission elements arranged to formed a light-emission surface;
a slit provided in a circumferential surface of the rotation section, and allowing light from the light-emission surface to pass therethrough to outside of the rotation section;
a display controller performing emission control on the plurality of light-emission elements to allow an image to be formed by the light emitted through the slit and to be displayed around the rotation section; and
an eyepoint detection section detecting an eyepoint position of each of one or more viewers around the rotation section,
wherein the display controller performs emission control on the plurality of light-emission elements to allow contents of a displayed image to differ depending on the viewer's eyepoint position detected by the eyepoint detection section.

2. The display device according to claim 1,
wherein the eyepoint detection section detects at least a vertical eyepoint position of each of the one or more viewers, and
the display controller performs emission control on the plurality of light-emission elements to allow contents of a displayed image to differ depending on the detected height of the viewer's eyepoint position.

3. The display device according to claim 2,
wherein the display controller performs emission control on the plurality of light-emission elements to allow a corrected image to be displayed, the corrected image being formed through correcting distortion of an image depending on the detected vertical eyepoint position.

4. The display device according to claim 1,
wherein the eyepoint detection section detects a horizontal eyepoint position of each of the plurality of viewers around the rotation section, and
the display controller performs emission control on the plurality of light-emission elements to allow a variety of images each having different contents to be displayed for the plurality of viewers, respectively, depending on difference in the horizontal eyepoint position between the plurality of viewers.

5. The display device according to claim 4, wherein
when view regions of the plurality of viewers overlap with one another, the display controller performs emission control on the plurality of light-emission elements to allow a plurality of images each having different contents to be space-divisionally displayed in a divisional ratio corresponding to the overlapped view region.

6. The display device according to claim 5,
wherein the eyepoint detection section detects both a horizontal eyepoint position and a vertical eyepoint position of each of the plurality of viewers, and
the display controller performs emission control on the plurality of light-emission elements to allow the plurality of images each having different contents to be space-divisionally displayed at vertical positions corresponding to the vertical eyepoint positions of the plurality of viewers, respectively.

7. The display device according to claim 4,
wherein the eyepoint detection section detects a viewer-absent region, as well as the eyepoint positions of the plurality of viewers, and
the display controller performs emission control on the plurality of light-emission elements to allow no images to be displayed in the viewer-absent region.

8. The display device according to claim 1, wherein the eyepoint detection section has an image-shooting device attached to the rotation section to rotate together with the rotation section.

9. The display device according to claim 1, wherein the eyepoint detection section has an image-shooting device provided separately from the rotation section at a fixed position in a rotation-inhibited manner.

10. The display device according to claim 1, wherein the slit is provided to extend in a direction parallel to the axis of rotation.

11. The display device according to claim 1,
wherein the light-emission element array has a curved-surface portion with a concave surface which configures the light-emission surface.

12. A display device comprising:
a rotatable, cylindrical rotation section;
a plurality of light-emission elements mounted in the rotation section;
a display controller performing emission control on the plurality of light-emission elements; and
an eyepoint detection section detecting an eyepoint position of each of one or more viewers,
wherein the display controller performs emission control on the plurality of light-emission elements depending on a detection result of the eyepoint detection section.

13. The display device according to claim 12,
wherein the display controller performs emission control on the plurality of light-emission elements to allow a corrected image to be displayed, the corrected image being formed through correcting distortion of an image depending on the detected vertical eyepoint position.

14. The display device according to claim 12,
wherein the display controller performs emission control on the plurality of light-emission elements to allow a variety of images each having different contents to be displayed for the plurality of viewers, respectively, depending on difference in the horizontal eyepoint position between the plurality of viewers.

15. The display device according to claim 12,
wherein the display controller performs emission control on the plurality of light-emission elements to allow no images to be displayed in a viewer-absent region.

16. The display device according to claim 12,
wherein the eyepoint detection section has an image-shooting device attached to the rotation section to rotate together with the rotation section.

17. A method of displaying an image with use of a display device, comprising:
providing a cylindrical rotation section having an axis of rotation therein and rotating around the axis of rotation as a rotation center;
providing a light-emission element array mounted in the rotation section, and including a plurality of light-emission elements arranged to formed a light-emission surface;
providing a slit in a circumferential surface of the rotation section, and allowing light from the light-emission surface to pass therethrough to outside of the rotation section;
performing emission control on the plurality of light emission-elements to allow an image to be formed by the light emitted through the slit and to be displayed around the rotation section; and
detecting an eyepoint position of each of one or more viewers around the rotation section,
wherein the emission control on the plurality of light-emission elements is performed to allow contents of a displayed image to differ depending on the viewer's eyepoint position detected by the eyepoint detection section.
